(19) United States
(12) Patent Application Publication
(10) Pub. No.: US 2021/0329927 A1
(43) Pub. Date: Oct. 28, 2021

(54) MICROALGAE BASED COMPOSITIONS AND METHODS FOR APPLICATION TO PLANTS

(71) Applicant: Heliae Development LLC, Gilbert, AZ (US)

(72) Inventors: Sandip Shinde, Gilbert, AZ (US); Stephen Ventre, Mesa, AZ (US); Manikandadas Mathilakathu Madathil, Mesa, AZ (US); Laura Carney, Chandler, AZ (US); Jerald Wheeler, Tucson, AZ (US)

(21) Appl. No.: 17/239,434

(22) Filed: Apr. 23, 2021

Related U.S. Application Data
(63) Continuation-in-part of application No. 15/752,428, filed on Feb. 13, 2018.
(60) Provisional application No. 62/217,386, filed on Sep. 11, 2015.
(60) Provisional application No. 62/222,089, filed on Sep. 22, 2015.
(60) Provisional application No. 62/253,265, filed on Nov. 10, 2015.

(51) Int. Cl. A01N 65/03; A01N 63/20

(52) U.S. Cl. CPC A01N 65/03; A01N 63/20

(57) ABSTRACT

Microalgae based compositions and methods of improving emergence and yield of plants by administering an effective amount of a microalgae based liquid composition in combination with other active ingredients including extracts from macroalgae, extracts from microalgae, minerals, humate derivatives, primary nutrients, micronutrients, chelating agents, and anti-biotics are disclosed. A method of applying a microalgae based composition to soil to increase the cation exchange capacity of the soil is also disclosed.

### CROSS REFERENCE TO RELATED APPLICATIONS

This application claims priority to and is a Continuation-In-Part of claims the benefit of U.S. patent application Ser. No. 15/752,428, which claims priority to U.S. Provisional Applications No. 62/217,386, filed Sep. 11, 2015, entitled Microalgae Based Compositions and Methods for Applications to Plants; No. 62/222,089, filed Sep. 22, 2015, entitled Microalgae Based Compositions and Methods for Applications to Plants; and No. 62/253,265, filed Nov. 10, 2015, entitled Microalgae Fertilization Compositions and Methods for Application to Plants. The entire contents of all of the foregoing are hereby incorporated by reference herein.

### BACKGROUND

Seed emergence occurs as an immature plant breaks out of its seed coat, typically followed by the rising of a stem out of the soil. The first leaves that appear on many seedlings are the so-called seed leaves, or cotyledons, which often bear little resemblance to the later leaves. Shortly after the first true leaves, which are more or less typical of the plant, appear, the cotyledons will drop off. Germination of seeds is a complex physiological process triggered by imbibition of water after possible dormancy mechanisms have been released by appropriate triggers. Under favorable conditions rapid expansion growth of the embryo culminates in rupture of the covering layers and emergence of the radicle. A number of agents have been proposed as modulators of seed emergence. Temperature and moisture modulation are common methods of affecting seed emergence. Addition of nutrients to the soil has also been proposed to promote emergence of seeds of certain plants. The effectiveness may be attributable to the ingredients or the method of preparing the product. Increasing the effectiveness of a product may reduce the amount of the product needed and increase efficiency of the agricultural process.

Additionally, whether at a commercial or home garden scale, growers are constantly striving to optimize the yield and quality of a crop to ensure a high return on the investment made in every growth season. As the population increases and the demand for raw plant materials goes up for the food and renewable technologies markets, the importance of efficient agricultural production intensifies. The influence of the environment on a plant's health and production has resulted in a need for strategies during the growth season which allow the plants to compensate for the influence of the environment and maximize production. Addition of nutrients to the soil or application to the foliage has been proposed to promote yield and quality in certain plants. The effectiveness may be attributable to the ingredients or the method of preparing the product. Increasing the effectiveness of a product may reduce the amount of the product needed and increase efficiency of the agricultural process.

### SUMMARY

Microalgae based compositions and methods are described herein for increasing the emergence and yield of plants. The compositions can include microalgae cells in various states, such as but not limited to, whole cells, lysed cells, dried cells, and cells that have been subjected to an extraction process. The composition can include microalgae cells as the primary or sole active ingredient, or in combination with other active ingredients such as, but not limited to, extracts from macroalgae, extracts from microalgae, minerals, humate derivatives, primary nutrients, micronutrients, chelating agents, and anti-biotics. The compositions can be stabilized through the addition of stabilizers suitable for plants, pasteurization, and combinations thereof. The methods can include applying the compositions to plants or seeds in a variety of methods, such as but not limited to, soil application, foliar application, seed treatments, and hydroponic application. The methods can include single or multiple applications of the compositions, and can also include low concentrations of microalgae cells. The methods can also include the application of a microalgae based composition to soil to increase the cation exchange capacity of the soil.

Some embodiments of the invention relate to a method of plant enhancement that can include administering to a plant, seedling, or seed a composition treatment including 0.001-30% by volume of microalgae cells in combination with at least one active ingredient to enhance at least one plant characteristic. The active ingredient can include extracts from macroalgae, extracts from microalgae, minerals, humate derivatives, primary nutrients, micronutrients, chelating agents, antibiotics, and/or the like.

In some embodiments, the solid growth medium can include at least one of soil, potting mix, compost, inert hydroponic material, and/or the like.

Some embodiments of the invention relate to a composition including microalgae cells in combination with at least one active ingredient to enhance at least one plant characteristic. The active ingredient can be extracts from macroalgae, extracts from microalgae, minerals, humate derivatives, primary nutrients, micronutrients, chelating agents and/or antibiotics.

Some embodiments of the invention relate to a method of preparing a composition that can include diluting microalgae cells to a concentration of 0.001-30% solids by weight; and mixing the microalgae cells with one or more active ingredients selected from extracts from macroalgae, extracts from microalgae, minerals, humate derivatives, primary nutrients, micronutrients, chelating agents, and/or antibiotics.

In some embodiments, the method can further include pasteurizing the composition.

Some embodiments of the invention include a method of plant enhancement that can include administering to a plant, seedling, or seed a composition treatment including 0.001-30% by volume of microalgae cells in combination with at least one active ingredient to enhance at least one plant characteristic at a rate of 0.1-150 gallons per acre to the enhance at least one plant characteristic.

In some embodiments, the administrating can be by administering an effective amount to a solid growth medium prior to or after the planting of a seed, seedling, or plant; and/or administering an effective amount to the foliage of a seedling or plant.

In some embodiments, the rate can be 0.1-50 gallons per acre. In some embodiments, the rate can be 0.1-10 gallons per acre.

In some embodiments, the active ingredient can be iron, magnesium, calcium, manganese, nitrogen, phosphorus, potassium sorbate, citric acid, potassium hydroxide, zinc, and/or the like.

In some embodiments, the micro algae cells are Chlorella cells.

In some embodiments, the plant characteristic can be seed germination rate, seed germination time, seedling emergence, seedling emergence time, seedling size, plant fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, sun burn, and/or the like.

Some embodiments of the invention relate to a method of plant enhancement that can include administering to a plant, seedling, or seed a composition treatment including 0.001-30% by volume of microalgae cells in combination with nickel to enhance at least one plant characteristic.

### Microalgae Plus Primary Nutrients Embodiments

In one embodiment, the microalgae based composition can include 5-30% (5-30 g/100 mL) of microalgae cells and 1-50% (1-50 g/100 mL) of at least one selected from the group consisting of nitrogen, phosphorus, and potassium. In some embodiments, the composition may comprise 5-20% solids by weight of microalgae cells. In some embodiments, the composition may comprise 5-15% solids by weight of microalgae cells. In some embodiments, the composition may comprise 5-10% solids by weight of microalgae cells. In some embodiments, the composition may comprise 10-20% solids by weight of microalgae cells. In some embodiments, the composition may comprise 10-20% solids by weight of microalgae cells. In some embodiments, the composition may comprise 20-30% solids by weight of microalgae cells. In some embodiments, further dilution of the microalgae cells percent solids by weight may be occur before application for low concentration applications of the composition. The application rate of inorganic and organic nitrogen to plants in a microalgae based composition comprising nitrogen and microalgae cells can vary depending on the crop. In one non-limiting example, in the application to winter wheat crops Table 1 shows corresponding yield potentials to available nitrogen.

TABLE 1

| Yield Potential | Available Nitrogen |
|---|---|
| (bu/acre) | (lb/acre) |
| 30 | 78 |
| 40 | 104 |
| 50 | 130 |
| 60 | 156 |
| 70 | 182 |
| 80 | 208 |
| 90 | 234 |

In other non-limiting examples, Table 2 shows additional guidelines for applying nitrogen to different crops in California.

TABLE 2

| | Range of Nitrogen |
|---|---|
| Crop | Application Rate (lb/acre) |
| Alfalfa | 1-50 |
| Almond | 100-200 |
| Avocado | 67-100 |
| Bean (dry) | 86-116 |
| Broccoli | 100-200 |
| Carrot | 100-250 |
| Celery | 200-275 |
| Corn | 150-275 |
| Corn (sweet) | 100-200 |
| Cotton | 100-200 |
| Grape, raisin | 20-60 |
| Lawn (heavy soil) | 174-261 |
| Lawn (shade) | 87-130 |
| Lettuce | 170-220 |
| Melon (cantaloupe) | 80-150 |
| Melon (watermelon) | 1-160 |
| Melons (mixed) | 100-150 |
| Nectarine | 100-150 |
| Oats | 50-120 |
| Onion | 100-400 |
| Peach (cling) | 50-100 |
| Peach (free) | 50-100 |
| Pepper (bell) | 180-240 |
| Pepper (chili) | 150-200 |
| Pistachios | 100-225 |
| Plums (dried, prunes) | 1-100 |
| Plums (fresh) | 110-150 |
| Rice | 110-145 |
| Safflower | 100-150 |
| Strawberry | 150-300 |
| Tomatoes (fresh market) | 125-350 |
| Tomatoes (processing) | 100-150 |
| Walnuts | 150-200 |
| Wheat | 100-240 |

In some embodiments, a method can include: providing a composition comprising nitrogen and microalgae cells; and applying the composition to a plant seed, plant, or soil at a rate in the range of 1-400 pounds of nitrogen per acre.

The application rates of phosphorus in a microalgae based composition comprising microalgae cells and phosphorus can vary based on the plant type and soil analysis. Table 3 shows guidelines for phosphorus application rates. In some embodiments, a method can include: providing a composition comprising phosphorus pentoxide and microalgae cells; and applying the composition to a plant seed, plant, or soil at a rate in the range of 5-60 pounds of phosphorus pentoxide per acre.

TABLE 3

| | Olsen Phosphorus Soil Test Level (ppm) | | | | |
|---|---|---|---|---|---|
| | 0 | 4 | 8 | 12 | 16 |
| | Phosphorus Fertilizer Rate (lb P₂O₅/acre) | | | | |
| Alfalfa-grass | 55 | 50 | 40 | 25 | 10 |
| Barley- | 50 | 40 | 30 | 20 | 10 |
| feed/malt | | | | | |
| Winter | 55 | 50 | 45 | 40 | 35 |
| wheat | | | | | |

The application rates of potassium in a microalgae based composition including microalgae cells and potassium can vary based on the plant type and soil analysis. Table 4 shows guidelines for potassium application rates. In some embodiments, a method can include: providing a composition comprising potassium oxide and microalgae cells; and applying the composition to a plant seed, plant, or soil at a rate in the range of 5-150 pounds of potassium oxide per acre. Additional guidelines for use of nitrogen, phosphorus, and potassium fertilizers with different types of plants are published by a variety of sources including the United States Department of Agriculture and Agricultural extensions of US state universities.

TABLE 4

| | Potassium Soil Test Level (ppm) | | | | | |
|---|---|---|---|---|---|---|
| | 0 | 50 | 100 | 150 | 200 | 250 |
| | Potassium Fertilizer Rate (lb K₂O/acre) | | | | | |
| Alfalfa- | 80 | 70 | 60 | 50 | 40 | 25 |
| grass | | | | | | |
| Barley-feed | 75 | 65 | 55 | 45 | 30 | 20 |
| Barley-malt | 90 | 80 | 65 | 50 | 35 | 25 |
| Wheat | 135 | 115 | 90 | 70 | 40 | 10 |

### Microalgae Plus Micronutrients, Mineral Nutrients, and Rare Earth Elements Embodiments

In some embodiments, the microalgae based composition can comprise 5-30% (5-30 g/100 mL) of microalgae cells and 1-50% (1-50 g/100 mL) of at least one mineral selected from the group consisting of calcium, magnesium, silicon, sulfur, iron, manganese, zinc, copper, boron, molybdenum, chlorine, sodium, aluminum, vanadium, nickel, cerium, dysprosium, erbium, europium, gadolinium, holmium, lanthanum, lutetium, neodymium, praseodymium, promethium, samarium, scandium, terbium, thulium, ytterbium, and yttrium. In some embodiments, the microalgae based composition may be applied to a plant seed, plant, or soil without or without dilution, and the diluted microalgae based composition may comprise 0.003-0.080% (0.003-0.080 g/100 mL) of microalgae cells and 0.0006-0.1330% (0.0006-0.1330 g/100 mL) of at least one mineral selected from the group consisting of calcium, magnesium, silicon, sulfur, iron, manganese, zinc, copper, boron, molybdenum, chlorine, sodium, aluminum, vanadium, nickel, cerium, dysprosium, erbium, europium, gadolinium, holmium, lanthanum, lutetium, neodymium, praseodymium, promethium, samarium, scandium, terbium, thulium, ytterbium, and yttrium.

In some embodiments, the application rate of calcium to plants in a microalgae based composition comprising microalgae cells and calcium can be in the range of 1-100 kg calcium/acre. Such an application of calcium can rectify a deficiency in soils with low calcium levels (i.e., less than 600 ppm). In some embodiments, a method can include: providing a composition comprising calcium and microalgae cells, and applying the composition to a plant seed, plant, or soil at a rate in the range of 1-100 kg calcium/acre.

In some embodiments, the application rate of boron to plants in a microalgae based composition comprising microalgae cells and boron can be in the range of 0.1-1 kg boron/acre, due to the narrow range for most plants between boron deficiency and toxicity. In some embodiments, a method can include: providing a composition comprising boron and microalgae cells, and applying the composition to a plant seed, plant, or soil at a rate in the range of 0.1-1 kg boron/acre.

In some embodiments, the application rates of manganese to plants in a microalgae based composition including microalgae cells and manganese can be in the range of 0.1-7.5 kg manganese/acre, and can vary based the level of manganese deficiency of the plants. In some embodiments, a method can include: providing a composition comprising manganese and microalgae cells, and applying the composition to a plant seed, plant, or soil at a rate in the range of 0.1-1 kg manganese/acre.

In some embodiments, the application rate of iron with a microalgae based composition will depend on the iron deficiency of the soil and iron tolerance of the plants. For example, in the northeastern United States most soils contain adequate levels of iron and may not require additional iron application. In some embodiments, the soils can be iron deficient and the application rate of iron in combination with a microalgae based composition including iron and microalgae cells to plants, such as but not limited to turf grass, may be in the range of 0.5-1 kg/acre in chelated form or 0.1-2 kg/acre in an inorganic salt form. In some embodiments, the soils can be iron deficient and the application rate of iron in combination with a microalgae based composition to plants, such as but not limited to corn or other plants with a high pH Chlorosis, can be in the range of 20-50 kg/acre in a ferrous sulphate form or 0-2 kg/acre in a stable iron chelate (e.g., FeEDDHA) form.

In some embodiments, a method can include: providing a composition comprising chelated iron and microalgae cells, and applying the composition to a plant seed, plant, or soil at a rate in the range of 0.1-2 kg iron/acre. In some embodiments, a method can include: providing a composition comprising inorganic salt iron and microalgae cells, and applying the composition to a plant seed, plant, or soil at a rate in the range of 0.1-2 kg iron/acre. In some embodiments, a method can include: providing a composition comprising ferrous sulphate and microalgae cells, and applying the composition to a plant seed, plant, or soil at a rate in the range of 20-50 kg ferrous sulphate/acre.

In some embodiments, the application rate of nickel to plants in a microalgae based composition comprising nickel and microalgae cells can be in the range of 0.05-0.25 kg nickel/acre. In some embodiments, a method can include: providing a composition comprising nickel and microalgae cells, and applying the composition to a plant seed, plant, or soil at a rate in the range of 0.05-0.25 kg nickel/acre.

In some embodiments, the soil can be copper deficient and the application rate of copper to plants in a microalgae based composition comprising copper and microalgae cells may be in the range of 0.1-25 kg of CuSO₄.5H₂O (copper (II) sulfate) per acre. In some embodiments, a foliar application rate of copper in combination with a microalgae based composition comprising copper and microalgae cells can be in the range of 0.5-1 kg of CuSO₄.5H₂O per acre. Similar to boron, the range between copper deficiency and copper toxicity for most plants is narrow and may dictate the level of copper application. In some embodiments, a method can include: providing a composition comprising copper sulfate and microalgae cells; and applying the composition to a plant seed or soil at a rate in the range of 0.1-25 kg copper sulfate/acre. In some embodiments, a method can include: providing a composition comprising copper sulfate and microalgae cells; and applying the composition to plant foliar at a rate in the range of 0.5-1 kg copper sulfate/acre.

In some embodiments, the application rate of zinc to plants in a microalgae based composition comprising zinc and microalgae cells can be in the range of 0.1-4 kg zinc/acre. In some embodiments, the soil or foliar application rate of zinc in a chelated form to plants in a microalgae based composition comprising zinc and microalgae cells may be in the range of 0.1-1 kg zinc/acre. In some embodiments, a method can include: providing a composition comprising zinc and microalgae cells; and applying the composition to a plant seed, plant or soil at a rate in the range of 0.1-4 kg zinc/acre. In some embodiments, a method can include: providing a composition comprising chelated zinc and microalgae cells; and applying the composition to a plant seed, plant or soil at a rate in the range of 0.1-1 kg zinc/acre.

In some embodiments, the application rate of molybdenum to plants, such as but not limited to plants in a soil pH less than 5.5 (e.g., table beets, broccoli), in a microalgae based composition, comprising molybdenum and microalgae cells can be in the range of 0.1-5 mL molybdenum/acre to compensate for the decreased availability of molybdenum in low pH soils. In further embodiments, the 0.1-5 mL molybdenum/acre application rate to plants in a microalgae based can additionally be applied with ammonium or sodium molybdate. In some embodiments, the foliar application rate of molybdenum to plants in a microalgae based composition comprising molybdenum and microalgae cells can be in the range of 0.1-20 mL molybdenum/acre. In some embodiments, a method can include: providing a composition comprising molybdenum and microalgae cells; and applying the composition to a plant seed, plant, or soil at a rate in the range of 0.1-5 mL molybdenum/acre. In some embodiments, a method can include: providing a composition comprising molybdenum and microalgae cells; and applying the composition to plant foliar at a rate in the range of 0.1-20 mL molybdenum/acre.

In some embodiments, the concentration of chlorine in the form of a chloride ion in a microalgae based composition comprising chloride and microalgae cells can be in the range of 0.1-1 g chloride/kg of the formulation. In some embodiments, the composition of chloride and microalgae cells can be applied to a plant seed, plant, or soil. In some embodiments, a method can include: providing a composition comprising 0.1-1 g chloride/kg and microalgae cells; and applying the composition to a plant seed, plant, or soil.

In some embodiments, the application rate of magnesium to a plant in a microalgae based composition comprising magnesium and microalgae cells can be in the range of 0.1-10 kg magnesium/acre. In some embodiments, a method can include: providing a composition comprising magnesium and microalgae cells; and applying the composition to a plant seed, plant, or soil at a rate in the range of 0.1-10 kg magnesium/acre.

In some embodiments, the application rate of sulfur to plants in a microalgae based composition comprising sulfur and microalgae cells can be in the range of 0.1-15 kg sulfur/acre. In some embodiments, a method can include: providing a composition comprising sulfur and microalgae cells; and applying the composition to a plant seed, plant, or soil at a rate in the range of 0.1-15 kg sulfur/acre. Non-limiting examples of application rates of nitrogen, phosphate, potassium and sulfur to crops are shown in Table 5.

TABLE 5

| | | | (lbs/acre) | | | |
|---|---|---|---|---|---|---|
| | | | Nitrogen | Phosphate | Potassium | Sulphur |
| Crop | Yield | Crop Part | N | P₂O₅ | K₂O | S |
| Canola | 35 bu/ac | Seed | 60-75 | 30-35 | 15-20 | 10-12′ |
| | | Seed/straw | 100-115 | 45-50 | 75-85 | 17-20 |
| Wheat | 50 bu/ac | Seed | 60-75 | 24-28 | 70-85 | 10-12′ |
| | | Seed/straw | 85-110 | 32-36 | 15-22 | 5-6′ |
| Pea | 50 bu/ac | Seed | 100-120 | 30-35 | 30-35 | 6-7′ |
| | | Seed/straw | 130-150 | 35-45 | 120-140 | 10-14' |
| Alfalfa | 5 tons/ac | Total | 260-320 | 60-75 | 270-330 | 27-33 |

The rare earth elements can be used in combination with algal products with typical concentration shown in Table 6, to form a microalgae based composition comprising at least one rare earth element and microalgae cells. The range of these REE will vary from 0 to toxicity levels which are different for different plants. See Gonzalez, V., Vignati, D. a L., Leyval, C. & Giamberini, L. Environmental fate and ecotoxicity of lanthanides: Are they a uniform group beyond chemistry? Environ. Int. 71, 148-157 (2014); and arpenter, D., Boutin, C., Allison, J. E., Parsons, J. L. & Ellis, D. M. Uptake and Effects of Six Rare Earth Elements (REEs) on Selected Native and Crop Species Growing in Contaminated Soils. PLoS One 10, e0129936 (2015).

TABLE 6

| | Typical concentation |
|---|---|
| | g kg⁻¹ Ha⁻¹ year⁻¹ |
| Y | 0.023 |
| La | 3.542 |
| Ce | 5.543 |
| Pr | 2.714 |
| Nd | 0.253 |
| Sm | 0.46 |
| Eu | 0.046 |
| Gd | 0.253 |
| | mg kg⁻¹ Ha⁻¹ year⁻¹ |
| Tb | 5.934 |
| Dy | 21.068 |
| Ho | 0.989 |
| Er | 6.187 |
| Tm | 0.322 |
| Yb | 1.219 |
| Lu | 0.115 |
| Total LREs | 14.743 |
| Total HREs | 0.276 |
| Total MREs | 0.782 |

In some embodiments, a method can include: providing a composition comprising yttrium and microalgae cells; and applying the composition to a plant seed, plant, or soil at a rate to produce a concentration in the range of 0.001-0.025 g yttrium kg⁻¹ Ha⁻¹ year⁻¹. In some embodiments, a method can include: providing a composition comprising lanthanum and microalgae cells; and applying the composition to a plant seed, plant, or soil at a rate to produce a concentration in the range of 0.1-3.5 g lanthanum kg⁻¹ Ha⁻¹ year⁻¹. In some embodiments, a method can include: providing a composition comprising cerium and microalgae cells; and applying the composition to a plant seed, plant, or soil at a rate to produce a concentration in the range of 0.1-5.5 g cerium kg⁻¹ Ha⁻¹ year⁻¹. In some embodiments, a method can include: providing a composition comprising praseodymium and microalgae cells; and applying the composition to a plant seed, plant, or soil at a rate to produce a concentration in the range of 0.1-2.7 g praseodymium kg⁻¹ Ha⁻¹ year⁻¹.

In some embodiments, a method can include: providing a composition comprising neobymium and microalgae cells; and applying the composition to a plant seed, plant, or soil at a rate to produce a concentration in the range of 0.01-0.25 g neobymium kg⁻¹ Ha⁻¹ year⁻¹. In some embodiments, a method can include: providing a composition comprising samarium and microalgae cells; and applying the composition to a plant seed, plant, or soil at a rate to produce a concentration in the range of 0.01-0.5 g samarium kg⁻¹ Ha⁻¹ year⁻¹. In some embodiments, a method can include: providing a composition comprising europium and microalgae cells; and applying the composition to a plant seed, plant, or soil at a rate to produce a concentration in the range of 0.01-0.05 g europium kg⁻¹ Ha⁻¹ year⁻¹. In some embodiments, a method can include: providing a composition comprising gadolinium and microalgae cells; and applying the composition to a plant seed, plant, or soil at a rate to produce a concentration in the range of 0.01-0.25 g gadolinium kg⁻¹ Ha⁻¹ year⁻¹.

In some embodiments, a method can include: providing a composition comprising terbium and microalgae cells; and applying the composition to a plant seed, plant, or soil at a rate to produce a concentration in the range of 0.1-6 g terbium kg⁻¹ Ha⁻¹ year⁻¹. In some embodiments, a method can include: providing a composition comprising dysprosium and microalgae cells; and applying the composition to a plant seed, plant, or soil at a rate to produce a concentration in the range of 1-21 g dysprosium kg⁻¹ Ha⁻¹ year⁻¹. In some embodiments, a method can include: providing a composition comprising holmium and microalgae cells; and applying the composition to a plant seed, plant, or soil at a rate to produce a concentration in the range of 0.1-1 g holmium kg⁻¹ Ha⁻¹ year⁻¹. In some embodiments, a method can include: providing a composition comprising erbium and microalgae cells; and applying the composition to a plant seed, plant, or soil at a rate to produce a concentration in the range of 0.1-6.5 g erbium kg⁻¹ Ha⁻¹ year⁻¹.

In some embodiments, a method can include: providing a composition comprising thulium and microalgae cells; and applying the composition to a plant seed, plant, or soil at a rate to produce a concentration in the range of 0.01-0.35 g thulium kg⁻¹ Ha⁻¹ year⁻¹. In some embodiments, a method can include: providing a composition comprising ytterbium and microalgae cells; and applying the composition to a plant seed, plant, or soil at a rate to produce a concentration in the range of 0.1-1.5. g ytterbium kg⁻¹ Ha⁻¹ year⁻¹. In some embodiments, a method can include: providing a composition comprising lutetium and microalgae cells; and applying the composition to a plant seed, plant, or soil at a rate to produce a concentration in the range of 0.01-0.15 g lutetium kg⁻¹ Ha⁻¹ year⁻¹.

In one non-limiting embodiment, a composition for application to plants can include (by weight): 5% microalgae solids, 2% zinc, 2% manganese, and 3% iron. In further non-limiting embodiments, the microalgae solids can include intact whole pasteurized mixotrophic Chlorella cells. In further non-limiting embodiments, the composition can be applied to the soil for row crop plants or directly to row crop plants. In one non-limiting example, an embodiment of the composition can be produced using the following method: a) adding 25 L of suspended microalgae solids (20% by weight) to 17.4 L of water and heating to 65° C. for about 2 hours to form a composition; b) cooling the composition, adding: potassium sorbate (300 g, 0.3% by weight), zinc sulfate monohydrate (7.96 kg, 2% Zn by weight), manganese sulfate tetrahydrate (11.8 kg, 2% Mn by weight), and ferrous sulfate heptahydrate (21.66 kg, 3% Fe by weight), and stirring; c) mixing the composition with a pump for about 10 minutes; d) adding citric acid (33.6 kg), and stirring to lower the pH of the composition to about 1.2-1.8; e) adding potassium hydroxide flakes (about 27.5 kg) to raise the pH of the composition to about 3.5-4.0 while maintaining the temperature below about 65° C.; and f) adding water to adjust the final volume of the composition to 100 L.

In one non-limiting embodiment, a composition for application to plants can include (by weight): 10% microalgae solids, 2% zinc, 2% manganese, and 3% iron. In further non-limiting embodiments, the microalgae solids can include intact whole pasteurized mixotrophic Chlorella cells. In further non-limiting embodiments, the composition can be applied to the soil for row crop plants or directly to row crop plants. In one non-limiting example, an embodiment of the composition can be produced using the following method: a) adding 40 L of suspended microalgae solids (25% by weight) to 2.4 L of water and heating to 65° C. for about 2 hours to form a composition; b) cooling the composition, adding: potassium sorbate (300 g, 0.3% by weight), zinc sulfate monohydrate (7.96 kg, 2% Zn by weight), manganese sulfate tetrahydrate (11.8 kg, 2% Mn by weight), and ferrous sulfate heptahydrate (21.66 kg, 3% Fe by weight), and stirring; c) mixing the composition with a pump for about 10 minutes; d) adding citric acid (33.6 kg), and stirring to lower the pH of the composition to about 1.2-1.8; e) adding potassium hydroxide flakes (about 27.5 kg) to raise the pH of the composition to about 3.5-4.0 while maintaining the temperature below about 65° C.; and f) adding water to adjust the final volume of the composition to 100 L.

In one non-limiting embodiment, a composition for application to plants can include (by weight): 5% microalgae solids, 1% zinc, 1% manganese, and 1.5% iron. In further non-limiting embodiments, the microalgae solids can include intact whole pasteurized mixotrophic Chlorella cells. In further non-limiting embodiments, the composition can be applied to the soil for row crop plants or directly to row crop plants. In one non-limiting example, an embodiment of the composition can be produced using the following method: a) adding 25 L of suspended microalgae solids (20% by weight) to 50.9 L of water and heating to 65° C. for about 2 hours to form a composition; b) cooling the composition, adding: potassium sorbate (300 g, 0.3% by weight), zinc sulfate monohydrate (3.24 kg, 1% Zn by weight), manganese sulfate tetrahydrate (4.79 kg, 1% Mn by weight), and ferrous sulfate heptahydrate (8.81 kg, 1.5% Fe by weight), and stirring; c) mixing the composition with a pump for about 10 minutes; d) adding citric acid (13.7 kg), and stirring to lower the pH of the composition to about 1.2-1.8; e) adding potassium hydroxide flakes (about 11.2 kg) to raise the pH of the composition to about 3.5-4.0 while maintaining the temperature below about 65° C.; and f) adding water to adjust the final volume of the composition to 100 L.

In one non-limiting embodiment, a composition for application to plants can include (by weight): 10% microalgae solids, 1% zinc, 1% manganese, and 1.5% iron. In further non-limiting embodiments, the microalgae solids can include intact whole pasteurized mixotrophic Chlorella cells. In further non-limiting embodiments, the composition can be applied to the soil for row crop plants or directly to row crop plants. In one non-limiting example, an embodiment of the composition can be produced using the following method: a) adding 50 L of suspended microalgae solids (20% by weight) to 26 L of water and heating to 65° C. for about 2 hours to form a composition; b) cooling the composition, adding: potassium sorbate (300 g, 0.3% by weight), zinc sulfate monohydrate (3.24 kg, 1% Zn by weight), manganese sulfate tetrahydrate (4.79 kg, 1% Mn by weight), and ferrous sulfate heptahydrate (8.81 kg, 1.5% Fe by weight), and stirring; c) mixing the composition with a pump for about 10 minutes; d) adding citric acid (13.7 kg), and stirring to lower the pH of the composition to about 1.2-1.8; e) adding potassium hydroxide flakes (about 11.2 kg) to raise the pH of the composition to about 3.5-4.0 while maintaining the temperature below about 65° C.; and f) adding water to adjust the final volume of the composition to 100 L.

In another non-limiting example, an embodiment of the composition can be produced using the following method: a) heating 1.03 L of suspended microalgae solids (about 20% by weight) to 65° C. for about 2 hours to form a composition; b) cooling the composition, adding: potassium sorbate (12 g, 0.3% by weight), 9% zinc EDTA solution (342 mL), 5% manganese DETA solution (684 mL), and 3% ferrous EDDHSA solution (1540 mL), and stirring; c) adding phosphoric acid to adjust the pH of the composition to about 3.5-4.0 while maintaining the temperature below about 65° C.; and d) adding water to adjust the final volume of the composition to 4 L.

In one non-limiting embodiment, a composition for application to plants can include (by weight): 10% microalgae solids, and 3% iron. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) adding 50 L of suspended microalgae solids (20% by weight) to 28.2 L of water and heating to 65° C. for about 2 hours to form a composition; b) cooling the composition, adding: potassium sorbate (300 g, 0.3% by weight), and ferrous sulfate heptahydrate (17.62 kg, 3% Fe by weight), and stirring; c) mixing the composition with a pump for about 10 minutes; d) adding citric acid (12.2 kg), and stirring to lower the pH of the composition to about 1.2-1.8; e) adding potassium hydroxide flakes (about 10 kg) to raise the pH of the composition to about 3.5-4.0 while maintaining the temperature below about 65° C.; and f) adding water to adjust the final volume of the composition to 100 L.

In one non-limiting embodiment, a composition for application to plants can include (by weight): 10% microalgae solids, 1.5% magnesium, and 3% iron. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) adding 40 L of suspended microalgae solids (25% by weight) to 2.77 L of water and heating to 65° C. for about 2 hours to form a composition; b) cooling the composition, adding: potassium sorbate (300 g, 0.3% by weight), magnesium sulfate heptahydrate (22.06 kg, 1.5% Mg by weight), and ferrous sulfate heptahydrate (17.62 kg, 3% Fe by weight), and stirring; c) mixing the composition with a pump for about 10 minutes; d) adding citric acid (32.2 kg), and stirring to lower the pH of the composition to about 1.2-1.8; e) adding potassium hydroxide flakes (about 10 kg) to raise the pH of the composition to about 3.5-4.0 while maintaining the temperature below about 65° C.; and f) adding water to adjust the final volume of the composition to 100 L.

In one non-limiting embodiment, a composition for application to plants can include (by weight) 10% microalgae solids in an organic certified solution by the Organic Materials Review Institute (Eugene, Oreg., USA). In further non-limiting embodiments, the microalgae solids can include intact whole pasteurized mixotrophic Chlorella cells. In one non-limiting example, an embodiment of the composition can be produced using the following method: a) adding 33 L of suspended microalgae solids (24.3% by weight) to 46 L of water and heating to 65° C. for about 2 hours to form a composition; b) adding citric acid (387 kg), and stirring to adjust the pH of the composition to about 3.5-4.0 while maintaining the temperature below about 65° C.; and f) adding water to adjust the final volume of the composition to 80 L.

In one non-limiting embodiment, a composition for application to plants can include (by weight): 10% microalgae solids, 0.2% zinc, 0.5% manganese, 0.5% iron, 0.5% calcium, and 0.5% magnesium. In further non-limiting embodiments, the microalgae solids can include intact whole pasteurized mixotrophic Chlorella cells. In further non-limiting embodiments, the composition can be applied to the soil for specialty crop plants or directly to specialty crop plants. In one non-limiting example, an embodiment of the composition can be produced using the following method: a) adding 45.7 L of suspended microalgae solids (21.9% by weight) to 34.5 L of water to form a composition; b) adding: citric acid (12.2 kg) and potassium hydroxide (9.98 kg) while maintaining the temperature below 40° C.; c) heating the composition at 65° C. for about 2 hours; d) cooling the composition, and adding: potassium sorbate (300 g, 0.3% by weight), zinc sulfate monohydrate (640 g, 0.2% Zn by weight), manganese sulfate tetrahydrate (2.38 kg, 0.5% Mn by weight), ferrous sulfate heptahydrate (2.91 kg, 0.5% Fe by weight), calcium sulfate dehydrate (2.51 kg, 0.5% Ca by weight), and magnesium sulfate heptahydrate (5.93 kg, 0.5% Mg by weight), and stirring; e) mixing the composition with a pump for about 10 minutes; f) adding potassium hydroxide flakes or citric acid to adjust the pH of the composition to about 3.5-4.0 while maintaining the temperature below about 65° C.; and g) adding water to adjust the final volume of the composition to 100 L.

In one non-limiting embodiment, a composition for application to plants can include (by weight): 10% microalgae solids, 0.2% zinc, 0.5% manganese, 0.5% iron, 1% calcium, and 1% magnesium. In further non-limiting embodiments, the microalgae solids may comprise intact whole pasteurized mixotrophic Chlorella cells. In further non-limiting embodiments, the composition can be applied to the soil for specialty crop plants or directly to specialty crop plants. In one non-limiting example, an embodiment of the composition can be produced using the following method: a) adding 45.7 L of suspended microalgae solids (21.9% by weight) to 19 L of water to form a composition; b) adding: citric acid (21.8 kg) and potassium hydroxide (17.8 kg) while maintaining the temperature below 40° C.; c) heating the composition at 65° C. for about 2 hours; d) cooling the composition, and adding: potassium sorbate (300 g, 0.3% by weight), zinc sulfate monohydrate (710 g, 0.2% Zn by weight), manganese sulfate tetrahydrate (2.64 kg, 0.5% Mn by weight), ferrous sulfate heptahydrate (3.24 kg, 0.5% Fe by weight), calcium sulfate dehydrate (5.58 kg, 1% Ca by weight), and magnesium sulfate heptahydrate (13.2 kg, 1% Mg by weight), and stirring; e) mixing the composition with a pump for about 10 minutes; f) adding potassium hydroxide flakes or citric acid to adjust the pH of the composition to about 3.5-4.0 while maintaining the temperature below about 65° C.; and g) adding water to adjust the final volume of the composition to 100 L.

In one non-limiting embodiment, a composition for application to plants can include (by weight): 5% microalgae solids, 0.025% zinc, 0.025% manganese, 0.5% iron, 6% nitrogen, 2% phosphorus, and 4% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (61 g), phosphoric acid (45 mL, 85% solution), urea (135 g), 9% zinc EDTA solution (2.3 mL), 5% Mn EDTA formulation (4.4 mL), and 3% Fe EDDHSA solution (139 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.025% zinc, 0.025% manganese, 0.5% iron, 6% nitrogen, 2% phosphorus, and 4% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (61 g), phosphoric acid (45 mL, 85% solution), urea (135 g), 9% zinc EDTA solution (2.3 mL), 5% Mn EDTA formulation (4.4 mL), and 3% Fe EDDHSA solution (139 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 0.038% zinc, 0.038% manganese, 0.75% iron, 9% nitrogen, 3% phosphorus, and 6% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (90 g), phosphoric acid (66 mL, 85% solution), urea (200 g), 9% zinc EDTA solution (3.8 mL), 5% Mn EDTA formulation (6.8 mL), and 3% Fe EDDHSA solution (197 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.038% zinc, 0.038% manganese, 0.75% iron, 9% nitrogen, 3% phosphorus, and 6% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition may be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (90 g), phosphoric acid (66 mL, 85% solution), urea (200 g), 9% zinc EDTA solution (3.8 mL), 5% Mn EDTA formulation (6.8 mL), and 3% Fe EDDHSA solution (197 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 0.05% zinc, 0.05% manganese, 1% iron, 12% nitrogen, 4% phosphorus, and 8% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (118 g), phosphoric acid (89 mL, 85% solution), urea (265 g), ferrous sulfate heptahydrate (50 g), 9% zinc EDTA solution (4.6 mL), 5% Mn EDTA formulation (9.6 mL), and 3% Fe EDDHSA solution (62 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.05% zinc, 0.05% manganese, 1% iron, 12% nitrogen, 4% phosphorus, and 8% potassium. In further non-limiting embodiments, the microalgae solids can include intact whole pasteurized mixotrophic Chlorella cells. In further non-limiting embodiments, the composition can be applied to the soil for home garden plants or directly to home garden plants. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (118 g), phosphoric acid (89 mL, 85% solution), urea (265 g), ferrous sulfate heptahydrate (50 g), 9% zinc EDTA solution (4.6 mL), 5% Mn EDTA formulation (9.6 mL), and 3% Fe EDDHSA solution (62 mL), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 0.25% iron, 7% nitrogen, and 0.75% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (11 g), urea (80 g), urea-triazone fertilizer solution (99 mL, N-Sure® [Tessendrelo Group, Phoenix, Ariz., USA]), and ferrous sulfate heptahydrate (13 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.25% iron, 7% nitrogen, and 0.75% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (11 g), urea (80 g), urea-triazone fertilizer solution (99 mL, N-Sure® [Tessendrelo Group, Phoenix, Ariz., USA]), and ferrous sulfate heptahydrate (13 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 0.25% iron, 14% nitrogen, and 1.5% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (22 g), urea (150 g), urea-triazone fertilizer solution (205 mL, N-Sure® [Tessendrelo Group, Phoenix, Ariz., USA]), and ferrous sulfate heptahydrate (25 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.5% iron, 14% nitrogen, and 1.5% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (22 g), urea (150 g), urea-triazone fertilizer solution (205 mL, N-Sure® [Tessendrelo Group, Phoenix, Ariz., USA]), and ferrous sulfate heptahydrate (25 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 0.75% iron, 21% nitrogen, and 2.25% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (33 g), urea (240 g), urea-triazone fertilizer solution (296 mL, N-Sure® [Tessendrelo Group, Phoenix, Ariz., USA]), and ferrous sulfate heptahydrate (38 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 0.75% iron, 21% nitrogen, and 2.25% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (33 g), urea (240 g), urea-triazone fertilizer solution (296 mL, N-Sure® [Tessendrelo Group, Phoenix, Ariz., USA]), and ferrous sulfate heptahydrate (38 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 5% microalgae solids, 1% iron, 28% nitrogen, and 3% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.2 L of suspended microalgae solids (25% by weight) at 65° C. for about 2 hours to form a composition; b) cooling the composition, and adding: potassium sorbate (3 g, 0.3% by weight), potassium hydroxide (45 g), urea (300 g), urea-triazone fertilizer solution (398 mL, N-Sure® [Tessendrelo Group, Phoenix, Ariz., USA]), and ferrous sulfate heptahydrate (50 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

In one non-limiting embodiment, a composition for application to plants can include (by weight): 10% microalgae solids, 1% iron, 28% nitrogen, and 3% potassium. In further non-limiting embodiments, the microalgae solids can include intact whole pasteurized mixotrophic Chlorella cells. In further non-limiting embodiments, the composition can be applied to the soil for grass turf or directly to grass turf. In one non-limiting example, an embodiment of the composition can be produced using the following method: a) heating 0.4 L of suspended microalgae solids (25% by weight) at 65° C. for about 2 hours to form a composition; b) cooling the composition, and adding: potassium sorbate (3 g, 0.3% by weight), potassium hydroxide (45 g), urea (300 g), urea-triazone fertilizer solution (398 mL, N-Sure® [Tessendrelo Group, Phoenix, Ariz., USA]), and ferrous sulfate heptahydrate (50 g), and stirring; c) further cooling the composition and stirring for about 30 minutes; d) adding sodium hydroxide pellets or sulfuric acid to adjust the pH of the composition to about 3.5-4.0 while maintaining the temperature below about 65° C.; and d) adding water to adjust the final volume of the composition to 1 L.

### Microalgae Plus Humate Derivative Embodiments

In one embodiment, the microalgae based composition can include 5-30% (5-30 g/100 mL) of microalgae cells and 5-20% (5-20 g/100 mL) of at least one humate derivative selected from the group consisting of fulvic acid, humate, humin, and humic acid. In some embodiments, the microalgae based composition can be applied to a plant seed, plant, or soil without or without dilution, and the diluted microalgae based composition can include 0.003-0.080% (0.003-0.080 g/100 mL) of microalgae cells and 0.003-0.055% (00.003-0.055 g/100 mL) of at least one humate derivative selected from the group consisting of fulvic acid, humate, humin, and humic acid. In some embodiments, a humate derivative can be applied to a plant in a microalgae based composition comprising a humate derivative and microalgae cells at an application rate in the range of 0.1-2 gallons humate derivative per acre and concentration in the range of 1-75 mL humate derivative per gallon of formulation to be applied. In some embodiments, a composition can include microalgae cells 1-75 mL of at least one selected from the group consisting of fulvic acid, humate, humin, and humic acid per gallon of the composition. In some embodiments, providing a composition comprising at least one humate derivative selected from the group consisting of fulvic acid, humate, humin, and humic acid, and microalgae cells; and applying the composition to a plant seed, plant, or soil at a rate in range of 0.1-2 gallons of the at least one humate derivative per acre.

### Microalgae Plus Antibiotic Embodiments

One non-limiting example of an antibiotic product is Proxel™ GXL Antimicrobial (Arch Biocides, Smyrna Ga.), which contains a 20% concentration of dipropylene glycol solution of 1,2-benzisothiazolin-3-one. In one embodiment, the microalgae based composition can include 5-30% (5-30 g/100 mL) of microalgae cells and 0.2-6% (0.2-6 g/100 mL) of dipropylene glycol solution of 1,2-benzisothiazolin-3-one. In some embodiments, the microalgae based composition can be applied to a plant seed, plant, or soil without or without dilution, and the diluted microalgae based composition may comprise 0.003-0.080% (0.003-0.080 g/100 mL) of microalgae cells and 0.0001-0.0160% (0.0001-0.0160 g/100 mL) of dipropylene glycol solution of 1,2-benzisothiazolin-3-one.

### Microalgae Plus Seaweed Extract Embodiments

One non-limiting example of a commercial antibiotic product is Acadian (Acadian Seaplants Limited, Dartmouth, Nova Scotia, Canada), which contains a 100% Ascophyllum nodosum extract concentration. In one embodiment, the microalgae based composition can include 5-30% (5-30 g/100 mL) of microalgae cells and 5-30% (5-30 g/100 mL) of at least one extract of a seaweed selected from the group consisting of Kappaphycus, Gracilaria, and Ascophyllum. In some embodiments, the microalgae based composition can be applied to a plant seed, plant, or soil without or without dilution, and the diluted microalgae based composition can include 0.003-0.080% (0.003-0.080 g/100 mL) of microalgae cells and 0.003-0.080% (0.003-0.080 g/100 mL) of at least one extract of a seaweed selected from the group consisting of Kappaphycus, Gracilaria, and Aschophyllum.

In some embodiments, the microalgae based composition can include 5-30% (5-30 g/100 mL) of microalgae cells and 1-90% (1-90 g/100 mL) of at least one extract of a seaweed selected from the group consisting of Kappaphycus, Ascophyllum, Macroystis, Fucus, Laminaria, Sargassum, Turbinaria, Gracilaria, and Durvilea. In some embodiment, a method can include: applying a. Applying a composition comprising 0.003-0.080 g microalgae cells per 100 mL (0.003-0.080%) and 0.0006-0.024 g per 100 mL (0.0006-0.024%) of at least one extract of a seaweed selected from the group consisting of Kappaphycus, Ascophyllum, Macroystis, Fucus, Laminaria, Sargassum, Turbinaria, Gracilaria, and Durvilea to a plant seed, plant, or soil.

### CEC Increase Embodiments

In some embodiments, a method can include providing a soil with a first cation exchange capacity, and applying a composition comprising 0.003-0.080 g microalgae cells per 100 mL to the soil to produce a second cation exchange capacity greater than the first cation exchange capacity.

### Chelation Agent Embodiments

In one embodiment, a microalgae based composition can be combined with at least one chelation agent for application to plants, with the level of the at least one chelation agent dependent on the micronutrient concentration of the microalgae based composition resulting in a micronutrient:chelation agent concentration ratio of 1:2. Suitable chelation agents can include: ethylenediaminetetraacetic acid (EDTA), diethylene triamine pentaacetic acid (PTDA), N-(hydroxyethyl)-ethylenediaminetriacetic acid (HEDTA), ethylenediamine-N,N′-bis (EDDHA), nitrilotriacetic acid (NTA), ethylenediamine-N,N′-disuccinic acid (EDDS), iminodisuccinic acid (IDS), methylglycinediacetic acid (MGDA), glutamic acid diacetic acid (GLDA), ethylenediamine-N,N′-diglutaric acid (EDDG), ethylenediamine-N,N′-dimalonic acid (EDDM), hydrodesulfurization (HDS), 2-hydroxyethyliminodiacetic acid (HEIDA), and (2,6-pyridine dicarboxylic acid). In some embodiments, a composition can include microalgae cells comprising a micronutrient concentration; and at least one chelation agent selected from the group consisting of EDTA, DTPA, HEDTA, EDDHA, NTA, EDDS, IDS, MGDA, GLDA, EDDG, EDDM, HDS, HEIDA, and PDA, wherein the composition has a micronutrient:chelation agent concentration ratio of 1:2. In some embodiments, a method can include: providing a composition comprising at least one chelation agent selected from the group consisting of EDTA, DTPA, HEDTA, EDDHA, NTA, EDDS, IDS, MGDA, GLDA, EDDG, EDDM, HDS, HEIDA, and PDA, and microalgae cells comprising a micronutrient concentration, wherein the composition has a micronutrient:chelation agent concentration ratio of 1:2; and applying the composition to a plant seed, plant, or soil.

### Additional Combination Embodiments

One non-limiting example of a fungicide product is Tilt (Syngenta, Wilmington, Del.), which contains propiconazole and has a recommended application concentration of 26.1 ppm. In one embodiment, the microalgae based composition can include 5-30% (5-30 g/100 mL) of microalgae cells and a fungicide. In some embodiments, the microalgae based composition can be applied to a plant seed, plant, or soil without or without dilution, and the diluted microalgae based composition may comprise 0.003-0.080% (0.003-0.080 g/100 mL) of microalgae cells and a fungicide. In other embodiments, the microalgae based composition can include 5-30% (5-30 g/100 mL) of microalgae cells and at least one of acetic acid, acetate, vitamin b-1, and natural chelating agents (e.g., proteins, polysaccharides, polynucleic acids, glutamic acid, histidine, malate, phytochelatin, siderophores, enterobactin). In some embodiments, the microalgae based composition can be applied to a plant seed, plant, or soil without or without dilution, and the diluted microalgae based composition may comprise 0.003-0.080% (0.003-0.080 g/100 mL) of microalgae cells and a fungicide.

### Home and Garden Embodiments

In some embodiments, the composition may comprise mixotrophic whole cell Chlorella, nitrogen, phosphorus, potassium, iron, manganese, zinc, EDTA, citric acid, and combinations thereof. In some embodiments, the Chlorella may be pasteurized. In some embodiments, the composition may contain Chlorella in the range of 1-100, 1-10, 10-20, 20-50, or 50-100 g/L. In some embodiments, the composition may comprise a nitrogen concentration in the range of 1-15, 1-3, 3-6, 6-9, 9-12, or 12-15%. In some embodiments, the phosphorous may comprise P₂O₅. In some embodiments, the composition may comprise a phosphorous concentration in the range of 1-6%, 1-2%, 2-3%, 3-4%, 4-5%, or 5-6%. In some embodiments, the potassium may comprise K₂O. In some embodiments, the composition may comprise a potassium concentration in the range of 1-10, 1-2, 2-4, 4-6, 6-8, or 8-10%.

In some embodiments, the composition may comprise an iron concentration in the range of 0.1-2, 0.1-0.25, 0.25-0.5, 0.5-0.75, 0.75-1, 1-1.5, or 1.5-2%. In some embodiments, the composition may comprise a manganese concentration in the range of 0.01-0.1, 0.01-0.0125, 0.0125-0.015, 0.015-0.02, 0.02-0.03, 0.03-0.04, 0.04-0.05, 0.05-0.075, or 0.075-0.1%. In some embodiments, the composition may comprise a zinc concentration in the range of 0.01-0.1, 0.01-0.0125, 0.0125-0.015, 0.015-0.02, 0.02-0.03, 0.03-0.04, 0.04-0.05, 0.05-0.075, or 0.075-0.1%.

The composition may be applied to a seed, seedling, or plant in a garden or plant area. In some embodiments, the composition comprising microalgae may be applied at a rate in the range of 250-2500 mL per 1,000 square feet of a garden or plant area. In some embodiments, the composition comprising microalgae may be applied at a rate in the range of 250-500 mL per 1,000 square feet of a garden or plant area. In some embodiments, the composition comprising microalgae may be applied at a rate in the range of 500-750 mL per 1,000 square feet of a garden or plant area. In some embodiments, the composition comprising microalgae may be applied at a rate in the range of 750-1,000 mL per 1,000 square feet of a garden or plant area. In some embodiments, the composition comprising microalgae may be applied at a rate in the range of 1,000-1,500 mL per 1,000 square feet of a garden or plant area. In some embodiments, the composition comprising microalgae may be applied at a rate in the range of 1,500-2,000 mL per 1,000 square feet of a garden or plant area. In some embodiments, the composition comprising microalgae may be applied at a rate in the range of 2,000-2,500 mL per 1,000 square feet of a garden or plant area.

In some embodiments, the composition comprising microalgae may be first applied after the two leaf stage. In some embodiments, the composition comprising microalgae may be first applied after the six leaf stage. In some embodiments, the composition comprising microalgae may be subsequently applied after the first application every 5-30 days. In some embodiments, the composition comprising microalgae may be subsequently applied after the first application every 5-7 days. In some embodiments, the composition comprising microalgae may be subsequently applied after the first application every 5-10 days. In some embodiments, the composition comprising microalgae may be subsequently applied after the first application every 7-14 days. In some embodiments, the composition comprising microalgae may be subsequently applied after the first application every 10-14 days. In some embodiments, the composition comprising microalgae may be subsequently applied after the first application every 14-21 days. In some embodiments, the composition comprising microalgae may be subsequently applied after the first application every 21-28 days. In some embodiments, the composition comprising microalgae may be subsequently applied after the first application every 25-30 days.

### BRIEF DESCRIPTION OF THE FIGURES

FIG. 1 shows a schematic representation of the physiological effects elicited by seaweed extracts and possible mechanism(s) of bioactivity.

FIG. 2 shows a schematic representation of different forms of soil phosphorus.

FIG. 3 shows a flow chart representing the contribution of potassium in the survival of a plant exposed to various types of biotic stress.

FIG. 4 shows a flow chart representing the role of potassium in the survival of a plant exposed to various types of drought stress.

FIG. 5 shows a flow chart representing the role of potassium in the survival of a plant exposed to salt stress.

FIG. 6 shows a flow chart representing the role of potassium in the survival of a plant exposed to temperature stress.

FIG. 7 shows a flow chart representing the role of zinc in cellular functions.

FIG. 8 shows a flow chart representing the relationship between soil organic matter and humate derivatives.

FIG. 9 shows the molecular structure of various biodegradable chelating agents.

FIG. 10 shows NVDI measurements from fairway turf treated with microalgae compositions.

FIG. 11 shows NVDI measurements from putting green turf treated with microalgae compositions.

FIG. 12 shows percentage of Bermuda grass in tested turf grass plots.

FIG. 13 shows flowering counts for treated petunias.

FIG. 14 shows fresh weight measurements for treated petunias.

FIG. 15 shows plant fresh weight measurements for treated pepper plants.

FIG. 16 shows pepper fresh weight measurements for treated pepper plants.

FIG. 17 shows soybean growth after treatment with PHYCOTERRA® (pasteurized Chlorella) in combination with cytokinin producing bacteria (i.e., Bradyrhizobium japonicum) or the cytokinin producing bacteria alone (“Grower Standard”).

FIG. 18 shows root nodulation in soybeans after treatment with PHYCOTERRA® (pasteurized Chlorella) in combination with cytokinin producing bacteria (i.e., Bradyrhizobium japonicum) or the cytokinin producing bacteria alone (“Grower Standard”).

FIG. 19 shows root nodulation in alfalfa after treatment with PHYCOTERRA® ORGANIC (pasteurized Chlorella) in combination with Sinorhizobium meliloti or the Sinorhizobium meliloti alone (“Untreated”).

FIG. 20 shows the average root nodulation in alfalfa after treatment with PHYCOTERRA® ORGANIC (pasteurized Chlorella) at concentrations of 0.5%, 1%, 2.5%, 5%, or 10% in combination with Sinorhizobium meliloti compared to the Sinorhizobium meliloti alone (“Untreated”).

### DETAILED DESCRIPTION

Many plants may benefit from the application of liquid compositions that provide a bio-stimulatory effect. Non-limiting examples of plant families that may benefit from such compositions may comprise Solanaceae, Fabaceae (Leguminosae), Poaceae, Roasaceae, Vitaceae, Brassicaeae (Cruciferae), Caricaceae, Malvaceae, Sapindaceae, Anacardiaceae, Rutaceae, Moraceae, Convolvulaceae, Lamiaceae, Verbenaceae, Pedaliaceae, Asteraceae (Compositae), Apiaceae (Umbelliferae), Araliaceae, Oleaceae, Ericaceae, Actinidaceae, Cactaceae, Chenopodiaceae, Polygonaceae, Theaceae, Lecythidaceae, Rubiaceae, Papveraceae, Illiciaceae Grossulariaceae, Myrtaceae, Juglandaceae, Bertulaceae, Cucurbitaceae, Asparagaceae (Liliaceae), Alliaceae (Liliceae), Bromeliaceae, Zingieraceae, Muscaceae, Areaceae, Dioscoreaceae, Myristicaceae, Annonaceae, Euphorbiaceae, Lauraceae, Piperaceae, and Proteaceae.

The Solanaceae plant family includes a large number of agricultural crops, medicinal plants, spices, and ornamentals in it's over 2,500 species. Taxonomically classified in the Plantae kingdom, Tracheobionta (subkingdom), Spermatophyta (superdivision), Magnoliophyta (division), Manoliopsida (class), Asteridae (subclass), and Solanales (order), the Solanaceae family includes, but is not limited to, potatoes, tomatoes, eggplants, various peppers, tobacco, and petunias. Plants in the Solanaceae can be found on all the continents, excluding Antarctica, and thus have a widespread importance in agriculture across the globe.

The Fabaceae plant family comprises the third largest plant family with over 18,000 species, including a number of important agricultural and food plants. Taxonomically classified in the Plantae kingdom, Tracheobionta (subkingdom), Spermatophyta (superdivision), Magnoliophyta (division), Manoliopsida (class), Rosidae (subclass), and Fabales (order), the Fabaceae family includes, but is not limited to, soybeans, beans, green beans, peas, chickpeas, alfalfa, peanuts, sweet peas, carob, and liquorice. Plants in the Fabaceae family may range in size and type, including but not limited to, trees, small annual herbs, shrubs, and vines, and typically develop legumes. Plants in the Fabaceae family can be found on all the continents, excluding Antarctica, and thus have a widespread importance in agriculture across the globe. Besides food, plants in the Fabaceae family may be used to produce natural gums, dyes, and ornamentals.

The Poaceae plant family supplies food, building materials, and feedstock for fuel processing. Taxonomically classified in the Plantae kingdom, Tracheobionta (subkingdom), Spermatophyta (superdivision), Magnoliophyta (division), Liliopsida (class), Commelinidae (subclass), and Cyperales (order), the Poaceae family includes, but is not limited to, flowering plants, grasses, and cereal crops such as barely, corn, lemongrass, millet, oat, rye, rice, wheat, sugarcane, and sorghum. Types of turf grass found in Arizona include, but are not limited to, hybrid Bermuda grasses (e.g., 328 tifgrn, 419 tifway, tif sport).

The Rosaceae plant family includes flowering plants, herbs, shrubs, and trees. Taxonomically classified in the Plantae kingdom, Tracheobionta (subkingdom), Spermatophyta (superdivision), Magnoliophyta (division), Magnoliopsida (class), Rosidae (subclass), and Rosales (order), the Rosaceae family includes, but is not limited to, almond, apple, apricot, blackberry, cherry, nectarine, peach, plum, raspberry, strawberry, and quince.

The Vitaceae plant family includes flowering plants and vines. Taxonomically classified in the Plantae kingdom, Tracheobionta (subkingdom), Spermatophyta (superdivision), Magnoliophyta (division), Magnoliopsida (class), Rosidae (subclass), and Rhammales (order), the Vitaceae family includes, but is not limited to, grapes.

Particularly important in the production of fruit from plants is the beginning stage of growth where the plant emerges and matures into establishment. A method of treating a seed, seedling, or plant to directly improve the germination, emergence, and maturation of the plant; or to indirectly enhance the microbial soil community surrounding the seed or seedling is therefore valuable in starting the plant on the path to marketable production. The standard used for assessing emergence is the achievement of the hypocotyl stage, where a stem is visibly protruding from the soil. The standard used for assessing maturation is the achievement of the cotyledon stage, where two leaves visibly form on the emerged stem.

Also important in the production of fruit from plants is the yield and quality of fruit, which may be quantified as the number, weight, color, firmness, ripeness, moisture, degree of insect infestation, degree of disease or rot, and degree of sunburn of the fruit. A method of treating a plant to directly improve the characteristics of the plant, or to indirectly enhance the chlorophyll level of the plant for photosynthetic capabilities and health of the plant's leaves, roots, and shoot to enable robust production of fruit is therefore valuable in increasing the efficiency of marketable production. Marketable and unmarketable designations may apply to both the plant and fruit, and may be defined differently based on the end use of the product, such as but not limited to, fresh market produce and processing for inclusion as an ingredient in a composition. The marketable determination may assess such qualities as, but not limited to, color, insect damage, blossom end rot, softness, and sunburn. The term total production may incorporate both marketable and unmarketable plants and fruit. The ratio of marketable plants or fruit to unmarketable plants or fruit may be referred to as utilization and expressed as a percentage. The utilization may be used as an indicator of the efficiency of the agricultural process as it shows the successful production of marketable plants or fruit, which will be obtain the highest financial return for the grower, whereas total production will not provide such an indication.

To achieve such improvements in emergence, maturation, and yield of plants, the inventors developed a method to treat such seeds and plants with a low concentration liquid microalgae based composition. The microalgae utilized in compositions for the improvement in emergence, maturation, and yield of plants may be cultured in phototrophic, mixotrophic, or heterotrophic culture conditions. In some embodiments, the microalgae based composition comprises a single dominate type of microalgae. In further embodiments, the microalgae based composition comprises a mixture of at least two types of microalgae.

Non-limiting examples of microalgae that can be used in the compositions and methods of the invention are members of one of the following divisions: Chlorophyta, Cyanophyta (Cyanobacteria), and Heterokontophyta. In certain embodiments, the microalgae used in the compositions and methods of the invention are members of one of the following classes: Bacillariophyceae, Eustigmatophyceae, and Chrysophyceae. In certain embodiments, the microalgae used in the compositions and methods of the invention are members of one of the following genera: Nannochloropsis, Chlorella, Dunaliella, Scenedesmus, Spirulina, Chlamydomonas, Galdieria, Isochrysis, Porphyridium, Schizochytrium, Tetraselmis, Botryococcus, and Haematococcus.

Non-limiting examples of microalgae species that can be used in the compositions and methods of the present invention include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium, sp. Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella sauna, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., Isochrysis aff. galbana, Isochrysis galbana, Lepocinclis, Micractinium, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Porphyridium, Platymonas sp., Pleurochrysis camerae, Pleurochrysis dentate, Pleurochrysis sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana.

In some embodiments, the microalgae of the liquid composition may comprise Chlorella sp. cultured in mixotrophic conditions, which comprises a culture medium primary comprised of water with trace nutrients (e.g., nitrates, phosphates, vitamins, metals found in BG-11 recipe [available from UTEX The Culture Collection of Algae at the University of Texas at Austin, Austin, Tex.]), light as an energy source for photosynthesis, organic carbon (e.g., acetate, acetic acid, glucose) as both an energy source and a source of carbon. In some embodiments, the culture media may comprise BG-11 media or a media derived from BG-11 culture media (e.g., in which additional component(s) are added to the media and/or one or more elements of the media is increased by 5%, 10%, 15%, 20%, 25%, 33%, 50%, or more over unmodified BG-11 media). In some embodiments, the Chlorella may be cultured in non-axenic mixotrophic conditions in the presence of contaminating organisms, such as but not limited to bacteria. Methods of culturing such microalgae in non-axenic mixotrophic conditions may be found in WO2014/074769A2 (Ganuza, et al.), hereby incorporated by reference.

By artificially controlling aspects of the Chlorella culturing process such as the organic carbon feed (e.g., acetic acid, acetate, glucose), oxygen levels, pH, and light, the culturing process differs from the culturing process that Chlorella experiences in nature. In addition to controlling various aspects of the culturing process, intervention by human operators or automated systems occurs during the non-axenic mixotrophic culturing of Chlorella through contamination control methods to prevent the Chlorella from being overrun and outcompeted by contaminating organisms (e.g., fungi, bacteria). Contamination control methods for microalgae cultures are known in the art and such suitable contamination control methods for non-axenic mixotrophic microalgae cultures are disclosed in WO2014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus through artificial control of aspects of the culturing process and intervening in the culturing process with contamination control methods, the Chlorella culture produced as a whole and used in the described inventive compositions differs from the culture that results from a Chlorella culturing process that occurs in nature. During the mixotrophic culturing process the Chlorella culture may also comprise cell debris and compounds excreted from the Chlorella cells into the culture medium.

In some embodiments, the microalgae of the liquid composition may comprise species of Haematococcus. In one non-limiting example, Haematococcus pluvialis may be grown in mixotrophic and phototrophic conditions. Culturing Haematococcus in mixotrophic conditions comprises supplying light and organic carbon (e.g., acetic acid, acetate, glucose) to cells in an aqueous culture medium comprising trace metals and nutrients (e.g., nitrogen, phosphorus). Culturing Haematococcus in phototrophic conditions comprises supplying light and inorganic carbon (e.g., carbon dioxide) to cells in an aqueous culture medium comprising trace metals and nutrients (e.g., nitrogen, phosphorus). Haematococcus cells may experience multiple stages during a culture life, such as a motile stage where cell division occurs and Chlorophyll is a dominant pigment, a non-motile stage where the mass of the cells increases, and a non-motile stage where astaxanthin is accumulated. The different culture stages may comprise different culture media, such as a full nutrient media during the growth and motility stage, and a nutrient deplete media in the non-motile and astaxanthin accumulation stage.

In some embodiments, the microalgae cells may be harvested from a culture and used as whole cells in a liquid composition for application to seeds and plants, while in other embodiments the harvested microalgae cells may subjected to downstream processing and the resulting biomass, extract, or other derivative may be used in a liquid composition for application to plants. Non-limiting examples of downstream processing comprise: drying the cells, lysing the cells, and subjecting the harvested cells to a solvent or supercritical carbon dioxide extraction process to isolate a metabolite. In some embodiments, the extracted biomass remaining from an extraction process may be used alone or in combination with other microalgae in a liquid composition for application to plants. By subjecting the microalgae to an extraction process the resulting biomass is transformed from a natural whole state to a lysed condition where the cell is missing a significant amount of the natural components, thus differentiating the extracted microalgal biomass from that which is found in nature. In some embodiments, the microalgae based composition may comprise extracted metabolites (e.g., oil, lipids, proteins, pigments) from microalgae in combination with or in the absence of microalgal biomass. In some embodiments, microalgae cells may also be mixed with extracts from other plants, microalgae, macroalgae, seaweeds, and kelp. Non-limiting examples of seaweeds/macroalgae that may be processed through extraction and combined with microalgae cells, biomass, or extracts, may comprise species of Kappaphycus, Ascophyllum, Macroystis, Fucus, Laminaria, Sargassum, Turbinaria, Gracilaria, and Durvilea. See Wajahatullah Khan, Usha P. Rayirath, Sowmyalakshmi Subramanian, Mundaya N. Jithesh, Prasanth Rayorath, D. Mark Hodges, Alan T. Critchley, James S. Craigie, Jeff Norrie, B. P. Seaweed Extracts as Biostimulants of Plant Growth and Development. J. Plant Growth Regul. 28, 386-399 (2009); Ugarte, R. a., Sharp, G. & Moore, B. Changes in the brown seaweed Ascophyllum nodosum (L.) Le Jol. plant morphology and biomass produced by cutter rake harvests in southern New Brunswick, Canada. J. Appl. Phycol. 18, 351-359 (2006); and Hong, D. D., Hien, H. M. & Son, P. N. Seaweeds from Vietnam used for functional food, medicine and biofertilizer. J. Appl. Phycol. 19, 817-826 (2007).

Seaweed extract applications have a wide range of beneficial effects on plants such as early seed germination and establishment, improved crop performance and yield, elevated resistance to biotic and abiotic stress, and enhanced postharvest shelf-life of perishable products. See Hankins, S. D. & Hockey, H. P. The effect of a liquid seaweed extract from Ascophyllum nodosum (Fucales, Phaeophyta) on the two-spotted red spider mite Tetranychus urticae. Hydrobiologia 204-205, 555-559 (1990). Plants grown in soils treated with seaweed biomass or extracts applied either to the soil or foliage, exhibit a wide range of responses. See Craigie, J. S. Seaweed extract stimuli in plant science and agriculture. J. Appl. Phycol. 23, 371-393 (2011).

Seaweed components such as macro- and microelement nutrients, amino acids, vitamins, cytokinins, auxins, and abscisic acid (ABA)-like growth substances affect cellular metabolism in treated plants leading to enhanced growth and crop yield. Table 7 lists plant growth hormones and regulators that are found in seaweeds that may provide a benefit to plants in a composition comprising seaweed biomass or extracts. See Tarakhovskaya, E. R., Maslov, Y. I. & Shishova, M. F. Phytohormones in algae. Russ. J. Plant Physiol. 54, 163-170 (2007); Boyer, G. L. & Dougherty, S. S. Identification of abscisic acid in the seaweed Ascophyllum nodosum. Phytochemistry 27, 1521-1522 (1988); Overbeek, J. V. Auxin in Marine Algae. Plant Physiol. 15, 291-299 (1940); Stirk, W. a., Novák, O., Strnad, M. & Van Staden, J. Cytokinins in macroalgae. Plant Growth Regul. 41, 13-24 (2003); and Arnold, T. M., Targett, N. M., Tanner, C. E., Hatch, W. I. & Ferrari, K. E. NOTE EVIDENCE FOR METHYL JASMONATE-INDUCED PHLOROTANNIN PRODUCTION IN FUCUS VESICULOSUS (PHAEOPHYCEAE) 1029, 1026-1029 (2001).

TABLE 7

| Plant Growth | | Physiological |
|---|---|---|
| Hormone/ | | function in |
| Regulator | Seaweed Genera | terrestrial plants |
| Abscisic acid | Ascophyllum, Laminaria | |
| Auxins | Ascophyllum, Fucus, | |
| | Laminaria, Macrocystis, | |
| | Undaria | |
| Cytokinins | Ascophyllum, Cystoseira, | |
| | Ecklonia, Fucus, | |
| | Macrocystis, Sargassum | |
| Gibberellins | Cystoseira, Edklonia, | |
| | Fucus, Petalonia, | |
| | Sargassum | |
| Betanines | Ascophyllum, Fucus, | Osmoregulation, drought |
| | Laminaria | and frost resistance, |
| | | disease resistance |
| Jasmonates | Fucus | Induces defense and stress |
| | | response, synthesis of |
| | | proteinase inhibitors, |
| | | promotes tuber |
| | | formation and |
| | | senescence, inhibits |
| | | growth and seed |
| | | germination |
| Polyamines | Dictyota | Influence growth cell |
| | | division, and normal |
| | | development |

Direct benefits from the application of A. nodosum and other seaweed extracts on crop performance include enhanced root vigor, increased leaf chlorophyll content, an increase in the number of leaves, improved fruit yield, heightened flavonoid content, and enhanced vegetation propagation. However, seaweed extracts play a crucial role to improve tolerance toward abiotic stresses, including drought, ion toxicity, freezing, and high temperature. See Rayorath, P. et al. Rapid bioassays to evaluate the plant growth promoting activity of Ascophyllum nodosum (L.) Le Jol. using a model plant, Arabidopsis thaliana (L.) Heynh. J. Appl. Phycol. 20, 423-429 (2008); Arthur, G. D., Stirk, W. a., van Staden, J. & Scott, P. Effect of a seaweed concentrate on the growth and yield of three varieties of Capsicum annuum. South African J. Bot. 69, 207-211 (2003); Kumar, G. & Sahoo, D. Effect of seaweed liquid extract on growth and yield of Triticum aestivum var. Pusa Gold. J. Appl. Phycol. 23, 251-255 (2011); Kumari, R., Kaur, I. & Bhatnagar, a. K. Effect of aqueous extract of Sargassum johnstonii Setchell & Gardner on growth, yield and quality of Lycopersicon esculentum Mill. J. Appl. Phycol. 23, 623-633 (2011); Fan, D. et al. Commercial extract of the brown seaweed Ascophyllum nodosum enhances phenolic antioxidant content of spinach (Spinacia oleracea L.) which protects Caenorhabditis elegans against oxidative and thermal stress. Food Chem. 124, 195-202 (2011); Spann, T. M. & Little, H. a. Applications of a commercial extract of the brown seaweed Ascophyllum nodosum increases drought tolerance in container-grown ‘hamlin’ sweet orange nursery trees. HortScience 46, 577-582 (2011); Mancuso, S., Azzarello, E., Mugnai, S. & Briand, X. Marine bioactive substances (IPA extract) improve foliar ion uptake and water stress tolerance in potted Vitis vinifera plants. Adv. Hortic. Sci. 20, 156-161 (2006); and Rayirath, P. et al. Lipophilic components of the brown seaweed, Ascophyllum nodosum, enhance freezing tolerance in Arabidopsis thaliana. Planta 230, 135-147 (2009).

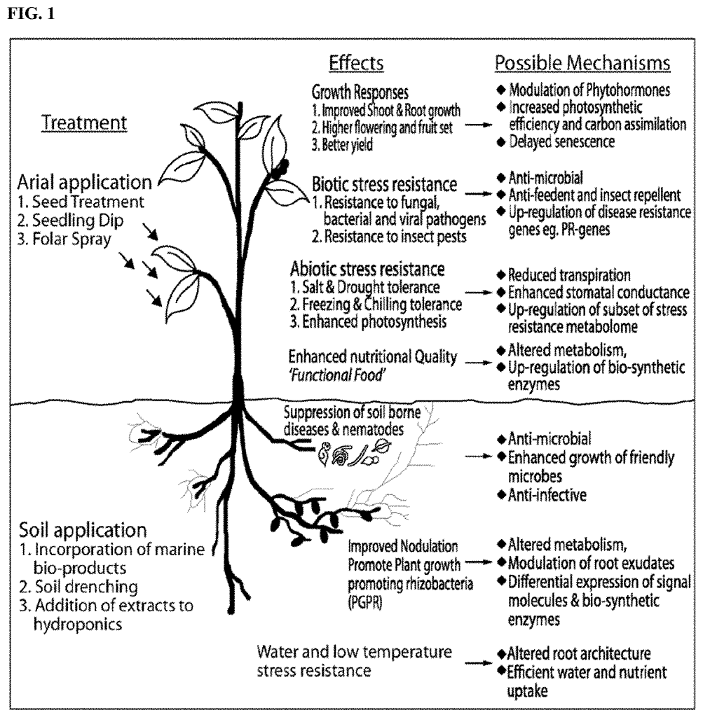

Phytohormone levels present within the extracts of seaweed are insufficient to cause significant effects in plants when extracts are applied at recommended rates, however components within seaweed extracts may modulate innate pathways for the biosynthesis of phytohormones in plants. See Wally, 0. S. D. et al. Regulation of Phytohormone Biosynthesis and Accumulation in Arabidopsis Following Treatment with Commercial Extract from the Marine Macroalga Ascophyllum nodosum. J. Plant Growth Regul. 32, 324-339 (2013). FIG. 1 shows a schematic representation of the physiological effects elicited by seaweed extracts and possible mechanism(s) of bioactivity. See Wajahatullah Khan, Usha P. Rayirath, Sowmyalakshmi Subramanian, Mundaya N. Jithesh, Prasanth Rayorath, D. Mark Hodges, Alan T. Critchley, James S. Craigie, Jeff Norrie, B. P. Seaweed Extracts as Biostimulants of Plant Growth and Development. J. Plant Growth Regul. 28, 386-399 (2009).

Carrageenans are a family of linear, sulphated galactans found in a number of commercially important species of marine red macroalgae. See Sangha, J. S., Ravichandran, S., Prithiviraj, K., Critchley, A. T. & Prithiviraj, B. Sulfated macroalgal polysaccharides-carrageenan and -carrageenan differentially alter Arabidopsis thaliana resistance to Sclerotinia sclerotiorum. Physiol. Mol. Plant Pathol. 75, 38-45 (2010) and Sangha, J. S. et al. Carrageenans, sulphated polysaccharides of red seaweeds, differentially affect Arabidopsis thaliana resistance to Trichoplusia ni (Cabbage Looper). PLoS One 6, (2011). These polysaccharides are known to elicit defense responses in plants and possess anti-viral properties. Table 8 shows the polysaccharide profiles found in different types of macroalgae.

TABLE 8

| Macroalgae | Polysaccharides |
|---|---|
| Chlorophyceae (Green) | amylose, amylopectin, cellulose, complex |
| | hemicellulose, glucomannans, mannans, |
| | inulin, laminaran, pectin, sulfated mucilages |
| | (glucuronoxylorhamnans), xylans |
| Rhodophyceae (Red) | agars, agaroids, carrageenans, cellulose, |
| | complex mucilages, furcellaran, glycogen |
| | (floridean starch), mannans, xylans, |
| | rhodymenan |
| Phaeophyceae (Brown) | alginates, cellulose, complex sulfated |
| | heterogulcans, fucose containing glycans, |
| | fucoidans, glucuronoxylofucans, laminarans, |
| | lichenan-like glucan |

Kappaphycus alvarezii (syn. K cottonii; Eucheuma cottonii), and the Gracilariaceae family are extensively cultivated for kappa-carrageenan. The liquid extract from fresh seaweed can be mechanically expelled and used as a foliar spray. See Kumar, A., Haresh, K. & Pandya, B. Integrated method for production of carrageenan and liquid fertilizer from fresh seaweeds promoting substances. XXIV, (2005). Yield of a variety of crops demonstrated an increase upon application of the liquid seaweed extraction at 2.5-5.0% (v/v, dilution with water). See Prasad, K. et al. Detection and quantification of some plant growth regulators in a seaweed-based foliar spray employing a mass spectrometric technique sans chromatographic separation. J. Agric. Food Chem. 58, 4594-4601 (2010). The liquid extract applied at a concentration of 12.5% (v/v) showed a 46% increase in yield with soybeans under rain-fed conditions. See Rathore, S. S. et al. Effect of seaweed extract on the growth, yield and nutrient uptake of soybean (Glycine max) under rainfed conditions. South African J. Bot. 75, 351-355 (2009). Table 9 shows phytohormones contained in Ascopyllum nodosom, Gracilaria vernucosa, and Gracilaria gigas.

TABLE 9

| | ASA and ABA metabolites | | | Cytokinins | | | | Auxins | | Gibberallins | |
|---|---|---|---|---|---|---|---|---|---|---|---|
| | (ng/g DW) | | | (ng/g DW) | | | | (ng/g DW) | | (ng/g DW) | |
| | ABA | ABAGE | t-ABA | c-Z | C-ZR | tP | tPR | 1AA | 1AA-Ala | GA3 | GA7 |
| Ascopyllum nodosom extract | 1 | n.d. | n.d. | n.d. | <0.1 | 0.5 | 1.1 | 467 | <1.1 | <0.3 | <0.3 |
| Gracilaria Vernucosa | 27 | <4 | 26 | 1 | 6 | <1 | 3 | n.d. | n.d. | <4 | n.d. |
| Gracilaria Gigas | 15 | n.d. | 10 | 3 | 3 | 3 | 1.4 | 37 | n.d. | n.d. | n.d. |

In some embodiments, the liquid microalgae based composition may comprise low concentrations of bacteria contributing to the solids percentage of the composition in addition to the microalgae. Examples of bacteria found in non-axenic mixotrophic conditions of a Chlorella culture may be found in WO2014/074769A2 (Ganuza, et al.), hereby incorporated by reference. A live bacteria count may be determined using methods known in the art such as plate counts, plates counts using Petrifilm available from 3M (St. Paul, Minn.), spectrophotometric (turbidimetric) measurements, visual comparison of turbidity with a known standard, direct cell counts under a microscope, cell mass determination, and measurement of cellular activity. Live bacteria counts in a non-axenic mixotrophic microalgae culture may range from 10⁴ to 10⁹ CFU/mL, and may depend on contamination control measures taken during the culturing of the microalgae. The level of bacteria in the composition may be determined by an aerobic plate count which quantifies aerobic colony forming units (CFU) in a designated volume. In some embodiments, the composition comprises an aerobic plate count of 40,000-400,000 CFU/mL. In some embodiments, the composition comprises an aerobic plate count of 40,000-100,000 CFU/mL. In some embodiments, the composition comprises an aerobic plate count of 100,000-200,000 CFU/mL. In some embodiments, the composition comprises an aerobic plate count of 200,000-300,000 CFU/mL. In some embodiments, the composition comprises an aerobic plate count of 300,000-400,000 CFU/mL.

In some embodiments, the microalgae based composition may comprise a bacterium that produces an antibiotic or a siderophore that inhibits competition among microorganisms. In some embodiments, a certain bacterium or group of bacteria may survive pasteurization or other stabilization process(es) for the microalgae based composition. In some embodiments, the microalgae based composition may comprise free living nitrogen fixing bacteria, cytokinin producing bacteria, or a combination of both. Non-limiting examples of cytokinin producing bacteria comprise Methylotrophs and Methylobacterium species, Xanthobacter sp., Paracoccus sp., Rhizobium sp., Sinorhizobium sp., and Methyloversatilis. Non-limiting examples of indole acetic acid (IAA) and antibiotic producers comprise Pseudomonads and Bacillus species, Rhizobium sp., and Sinorhizobium sp. In some embodiments, bacteria that produce an antibiotic, siderophore, cytokinin, or IAA may be added to a microalgae based composition to supplement the existing population so bacteria or to create a population of functional bacteria.

The liquid microalgae based composition comprising may be stabilized by heating and cooling in a pasteurization process. The inventors found that the active ingredients of a microalgae based composition maintained effectiveness in improving plant germination, emergence, maturation, and yield when applied to plants after being subjected to the heating and cooling of a pasteurization process.

While the mixotrophic Chlorella cells are intact and viable (i.e., physically fit to live, capable of further growth or cell division) after being harvested from the culture, the Chlorella cells resulting from the pasteurization process were confirmed to have intact cell walls but are not viable. Mixotrophic Chlorella cells resulting from the pasteurization process were observed under a microscope to determine the condition of the cell walls after the being subjected to the heating and cooling of the process, and was visually confirmed that the Chlorella cell walls were intact and not broken open. For further investigation of the condition of the cell, a culture of live mixotrophic Chlorella cells and the mixotrophic Chlorella cells resulting from the pasteurization process were subjected to propidium iodide, an exclusion fluorescent dye that labels DNA if the cell membrane is compromised, and visually compared under a microscope. The propidium iodide comparison showed that the Chlorella cells resulting from the pasteurization process contained a high amount of dyed DNA, resulting in the conclusion that the mixotrophic Chlorella cell walls are intact but the cell membranes are compromised. Thus, the permeability of the pasteurized Chlorella cells differs from the permeability of a Chlorella cell with both an intact cell wall and cell membrane.

Additionally, a culture of live mixotrophic Chlorella cells and the mixotrophic Chlorella cells resulting from the pasteurization process were subjected to DAPI (4′,6-diamidino-2-phyenylindole)-DNA binding fluorescent dye and visually compared under a microscope. The DAPI-DNA binding dye comparison showed that the Chlorella cells resulting from the pasteurization process contained a greatly diminished amount of viable DNA in the cells, resulting in the conclusion that the mixotrophic Chlorella cells are not viable after pasteurization. The two DNA dying comparisons demonstrate that the pasteurization process has transformed the structure and function of the Chlorella cells from the natural state by changing: the cells from viable to non-viable, the condition of the cell membrane, and the permeability of the cells.

In other embodiments, liquid microalgae based compositions with whole cells or processed cells (e.g., dried, lysed, extracted) may not need to be stabilized by pasteurization. For example, a phototrophic culture of Haematococcus or microalgae cells that have been processed, such as by drying, lysing, and extraction, may comprise such low levels of bacteria that the liquid composition may remain stable without being subjected to the heating and cooling of a pasteurization process.

In some embodiments, the microalgae based composition may be heated to a temperature in the range of 50-90° C. In some embodiments, the microalgae based composition may be heated to a temperature in the range of 55-65° C. In some embodiments, the microalgae based composition may be heated to a temperature in the range of 58-62° C. In some embodiments, the microalgae based composition may be heated to a temperature in the range of 50-60° C. In some embodiments, the microalgae based composition may be heated to a temperature in the range of 60-70° C. In some embodiments, the microalgae composition may be heated to a temperature in the range of 70-80° C. In some embodiments, the microalgae composition may be heated to a temperature in the range of 80-90° C.

In some embodiments, the microalgae based composition may be heated for a time period in the range of 90-150 minutes. In some embodiments, the microalgae based composition may be heated for a time period in the range of 110-130 minutes. In some embodiments, the microalgae based composition may be heated for a time period in the range of 90-100 minutes. In some embodiments, the microalgae based composition may be heated for a time period in the range of 100-110 minutes. In some embodiments, the microalgae based composition may be heated for a time period in the range of 110-120 minutes. In some embodiments, the microalgae based composition may be heated for a time period in the range of 120-130 minutes. In some embodiments, the microalgae based composition may be heated for a time period in the range of 130-140 minutes. In some embodiments, the microalgae based composition may be heated for a time period in the range of 140-150 minutes.

In some embodiments, the microalgae composition may be heated for a time period in the range of 15-360 minutes. In some embodiments, the microalgae composition may be heated for a time period in the range of 15-30 minutes. In some embodiments, the microalgae composition may be heated for a time period in the range of 30-60 minutes. In some embodiments, the microalgae composition may be heated for a time period in the range of 60-120 minutes. In some embodiments, the microalgae composition may be heated for a time period in the range of 120-180 minutes. In some embodiments, the microalgae composition may be heated for a time period in the range of 180-360 minutes.

After the step of heating or subjecting the liquid microalgae based composition to high temperatures is complete, the composition may be cooled at any rate to a temperature that is safe to work with. In one non-limiting embodiment, the microalgae based composition may be cooled to a temperature in the range of 35-45° C. In some embodiments, the microalgae based composition may be cooled to a temperature in the range of 36-44° C. In some embodiments, the microalgae based composition may be cooled to a temperature in the range of 37-43° C. In some embodiments, the microalgae based composition may be cooled to a temperature in the range of 38-42° C. In some embodiments, the microalgae based composition may be cooled to a temperature in the range of 39-41° C. In further embodiments, the pasteurization process may be part of a continuous production process that also involves packaging, and thus the liquid microalgae based composition may be packaged (e.g., bottled) directly after the heating or high temperature stage without a cooling step.

In some embodiments, stabilizing means that are not active regarding the improvement of plant germination, emergence, maturation, quality, and yield, but instead aid in stabilizing the microalgae based composition may be added to prevent the proliferation of unwanted microorganisms (e.g., yeast, mold) and prolong shelf life. Such inactive but stabilizing means may comprise an acid, such as but not limited to phosphoric acid, and a yeast and mold inhibitor, such as but not limited to potassium sorbate. In some embodiments, the stabilizing means are suitable for plants and do not inhibit the growth or health of the plant. In the alternative, the stabilizing means may contribute to nutritional properties of the liquid composition, such as but not limited to, the levels of nitrogen, phosphorus, or potassium.

In some embodiments, the microalgae based composition may comprise less than 0.3% phosphoric acid. In some embodiments, the microalgae based composition may comprise 0.01-0.3% phosphoric acid. In some embodiments, the microalgae based composition may comprise 0.05-0.25% phosphoric acid. In some embodiments, the microalgae based composition may comprise 0.01-0.1% phosphoric acid. In some embodiments, the microalgae based composition may comprise 0.1-0.2% phosphoric acid. In some embodiments, the microalgae based composition may comprise 0.2-0.3% phosphoric acid.

In some embodiments, the microalgae based composition may comprise less than 0.5% potassium sorbate. In some embodiments, the microalgae based composition may comprise 0.01-0.5% potassium sorbate. In some embodiments, the microalgae based composition may comprise 0.05-0.4% potassium sorbate. In some embodiments, the microalgae based composition may comprise 0.01-0.1% potassium sorbate. In some embodiments, the microalgae based composition may comprise 0.1-0.2% potassium sorbate. In some embodiments, the microalgae based composition may comprise 0.2-0.3% potassium sorbate. In some embodiments, the microalgae based composition may comprise 0.3-0.4% potassium sorbate. In some embodiments, the microalgae based composition may comprise 0.4-0.5% potassium sorbate.

### Alternative Stabilization Agents/Anti-Biotics

In some embodiments, the microalgae based composition may be stabilized with a broad spectrum antimicrobial, such as Proxel™ (Arch Biocides, Smyma, Ga.), to prevent against spoilage from bacteria, yeasts, and fungi. Proxel™ comprises 20% aqueous dipropylene glycol solution of 1,2-benzisothiazolin-3-one. An effective concentration of Proxel™ for stabilization may range from 0.01-0.30% (w/w). In some embodiments, the microalgae based composition may be stabilized with antibiotics which are active against selective bacteria to act as a screen of bad bacteria while maintaining the population of bacteria beneficial to plant growth or that suppress the growth of plant pathogens (e.g., fungi). In some embodiments, the microalgae based composition may be stabilized with potassium hydroxide to inhibit fungal growth.

In some embodiments, the composition may comprise 1-30% solids by weight of microalgae cells (i.e., 1-30 g of microalgae cells/100 mL of the liquid composition). In some embodiments, the composition may comprise 1-20% solids by weight of microalgae cells. In some embodiments, the composition may comprise 1-15% solids by weight of microalgae cells. In some embodiments, the composition may comprise 1-10% solids by weight of microalgae cells. In some embodiments, the composition may comprise 10-20% solids by weight of microalgae cells. In some embodiments, the composition may comprise 10-20% solids by weight of microalgae cells. In some embodiments, the composition may comprise 20-30% solids by weight of microalgae cells. In some embodiments, the composition may comprise 1-8% solids by weight of microalgae cells. In some embodiments, the composition may comprise 1-5% solids by weight of microalgae cells. In some embodiments, the composition may comprise 1-2% solids by weight of microalgae cells. In some embodiments, further dilution of the microalgae cells percent solids by weight may be occur before application for low concentration applications of the composition.

In some embodiments, the composition may comprise less than 1% solids by weight of microalgae cells (i.e., less than 1 g of microalgae cells/100 mL of the liquid composition). In some embodiments, the composition may comprise less than 0.9% solids by weight of microalgae cells. In some embodiments, the composition may comprise less than 0.8% solids by weight of microalgae cells. In some embodiments, the composition may comprise less than 0.7% solids by weight of microalgae cells. In some embodiments, the composition may comprise less than 0.6% solids by weight of microalgae cells. In some embodiments, the composition may comprise less than 0.5% solids by weight of microalgae cells. In some embodiments, the composition may comprise less than 0.4% solids by weight of microalgae cells. In some embodiments, the composition may comprise less than 0.3% solids by weight of microalgae cells. In some embodiments, the composition may comprise less than 0.2% solids by weight of microalgae cells. In some embodiments, the composition may comprise less than 0.1% solids by weight of microalgae cells. In some embodiments, the composition may comprise at least 0.0001% by weight of microalgae cells. In some embodiments, the composition may comprise at least 0.001% by weight of microalgae cells. In some embodiments, the composition may comprise at least 0.01% by weight of microalgae cells. In some embodiments, the composition may comprise at least 0.1% by weight of microalgae cells. In some embodiments, the composition may comprise 0.0001-1% by weight of microalgae cells. In some embodiments, the composition may comprise 0.0001-0.001% by weight of microalgae cells. In some embodiments, the composition may comprise 0.001-0.01% by weight of microalgae cells. In some embodiments, the composition may comprise 0.01-0.1% by weight of microalgae cells. In some embodiments, the composition may comprise 0.1-1% by weight of microalgae cells. In some embodiments, the effective amount in an application of the liquid composition for enhanced germination, emergence, or maturation may comprise a concentration of solids of microalgae cells in the range of 0.000528-0.079252% (i.e., about 0.0005% to about 0.080%, or about 0.0005 g/100 mL to about 0.080 g/100 mL), equivalent to a diluted concentration of 2-10 mL/gallon of a solution with an original percent solids of microalgae cells in the range of 1-30%.

In one non-limiting example of showing the calculation of the amount of microalgae cells applied to plants in a field, greenhouse, or other cultivation setting, an application of 1 gallon of microalgae cells per acre under the assumption of 100 gallons of water are being used to apply the cells, then 3785 mL of microalgae cells is diluted in 100 gallons of water=370 g microalgae cells in 100 gallons of water=3.7 g of microalgae cells in 1 gallon of water; if there are 3.785 g of microalgae cells in 3785 ml of solution that will equal 0.1 g of microalgae biomass or extract in 100 mL of solution=0.1% concentration. If an initial composition at a 10% concentration off the shelf is to be applied at the 0.1% application concentration, then there will be 100 g of microalgae cells applied per acre at 1 gallon/acre. For a 0.01% application concentration then there will be 10 g of microalgae cells applied per acre at 0.1 gallon per acre. For a 0.001% application concentration then there will be 1 g of microalgae cells applied per acre at 0.01 gallon/acre.

Correlating the application of the microalgae cells on a per plant basis (assuming 15,000 plants/acre) the composition application of 1 gallon per acre is equal to 0.25 mL/plant=0.025 g/plant=25 mg of microalgae cells/plant. The water requirement assumption at 100 gallons/acre is equal to 35 mL of water/plant. Therefore, 0.025 g of microalgae cells in 35 mL of water is equal to 0.071 g of microalgae cells/100 mL of solution=0.07% concentration. The microalgae cells based composition may be applied in a range as low as 0.01-10 gallons per acre, or as high as 150 gallons/acre.

The microalgae based composition is a liquid and substantially comprises of water. In some embodiments, the microalgae based composition may comprise 70-95% water. In some embodiments, the microalgae based composition may comprise 85-95% water. In some embodiments, the microalgae based composition may comprise 70-75% water. In some embodiments, the microalgae based composition may comprise 75-80% water. In some embodiments, the microalgae based composition may comprise 80-85% water. In some embodiments, the microalgae based composition may comprise 85-90% water. In some embodiments, the c microalgae based composition may comprise 90-95% water. The liquid nature and high water content of the composition facilitates administration of the microalgae based composition in a variety of manners, such as but not limited to: flowing through an irrigation system, flowing through an above ground drip irrigation system, flowing through a buried drip irrigation system, flowing through a central pivot irrigation system, sprayers, sprinklers, and water cans.

The liquid microalgae based composition may be used immediately after formulation, or may be stored in containers for later use. In some embodiments, the microalgae based composition may be stored out of direct sunlight. In some embodiments, the microalgae based composition may be refrigerated. In some embodiments, the microalgae based composition may be stored at 1-10° C. In some embodiments, the microalgae based composition may be stored at 1-3° C. In some embodiments, the microalgae based composition may be stored at 3-5° C. In some embodiments, the composition may be stored at 5-8° C. In some embodiments, the microalgae based composition may be stored at 8-10° C.

Administration of the liquid microalgae based composition to a seed or plant may be in an amount effective to produce an enhanced characteristic in plants compared to a substantially identical population of untreated seeds or plants. Such enhanced characteristics may comprise accelerated seed germination, accelerated seedling emergence, improved seedling emergence, improved leaf formation, accelerated leaf formation, improved plant maturation, accelerated plant maturation, increased plant yield, increased plant growth, increased plant quality, increased plant health, increased fruit yield, increased fruit growth, increased fruit quality, improved root health, and increased root nodule formation. Non-limiting examples of such enhanced characteristics may comprise accelerated achievement of the hypocotyl stage, accelerated protrusion of a stem from the soil, accelerated achievement of the cotyledon stage, accelerated leaf formation, increased marketable plant weight, increased marketable plant yield, increased marketable fruit weight, increased production plant weight, increased production fruit weight, increased utilization (indicator of efficiency in the agricultural process based on ratio of marketable fruit to unmarketable fruit), increased chlorophyll content (indicator of plant health), increased plant weight (indicator of plant health), increased root weight (indicator of plant health), and increased shoot weight (indicator of plant health). Such enhanced characteristics may occur individually in a plant, or in combinations of multiple enhanced characteristics.

Surprisingly, the inventors found that administration of the described microalgae based composition in low concentration applications was effective in producing enhanced characteristics in plants. In some embodiments, the liquid microalgae based composition is administered before the seed is planted. In some embodiments, the liquid microalgae based composition is administered at the time the seed is planted. In some embodiments, the liquid microalgae based composition is administered after the seed is planted. In some embodiments, the liquid microalgae based composition is administered to plants that have emerged from the ground.

### Seed Soak Application

In one non-limiting embodiment, the administration of the liquid microalgae based composition may comprise soaking the seed in an effective amount of the liquid composition before planting the seed. In some embodiments, the administration of the liquid microalgae based composition further comprises removing the seed from the liquid composition after soaking, and drying the seed before planting. In some embodiments, the seed may be soaked in the liquid microalgae based composition for a time period in the range of 90-150 minutes. In some embodiments, the seed may be soaked in the liquid microalgae based composition for a time period in the range of 110-130 minutes. In some embodiments, the seed may be soaked in the liquid microalgae based composition for a time period in the range of 90-100 minutes. In some embodiments, the seed may be soaked in the liquid microalgae based composition for a time period in the range of 100-110 minutes. In some embodiments, the seed may be soaked in the liquid microalgae based composition for a time period in the range of 110-120 minutes. In some embodiments, the seed may be soaked in the liquid microalgae based composition for a time period in the range of 120-130 minutes. In some embodiments, the seed may be soaked in the liquid microalgae based composition for a time period in the range of 130-140 minutes. In some embodiments, the seed may be soaked in the liquid microalgae based composition for a time period in the range of 140-150 minutes.

The microalgae based composition may be diluted to a lower concentration for an effective amount in a seed soak application by mixing a volume of the composition in a volume of water. The percent solids of microalgae cells resulting in the diluted composition may be calculated by the multiplying the original percent solids in the composition by the ratio of the volume of the composition to the volume of water. Alternatively, the grams of microalgae cells in the diluted composition can be calculated by the multiplying the original grams of microalgae cells per 100 mL by the ratio of the volume of the composition to the volume of water. In some embodiments, the effective amount in a seed soak application of the liquid microalgae based composition may comprise a concentration in the range of 6-10 mL/gallon, resulting in a reduction of the percent solids of microalgae cells from 5-30% to 0.007925-0.079252% (i.e., about 0.008% to about 0.080%, or about 0.008 g/100 mL to about 0.080 g/100 mL). In some embodiments, the effective amount in a seed soak application of the liquid microalgae based composition may comprise a concentration in the range of 7-9 mL/gallon, resulting in a reduction of the percent solids of microalgae cells from 5-30% to 0.009245-0.071327% (i.e., about 0.009% to about 0.070%, or about 0.009 g/100 mL to about 0.070 g/100 mL). In some embodiments, the effective amount in a seed soak application of the liquid microalgae based composition may comprise a concentration in the range of 6-7 mL/gallon, resulting in a reduction of the percent solids of microalgae cells from 5-30% to 0.007925-0.055476% (i.e., about 0.008% to about 0.055%, or about 0.008 g/100 mL to about 0.055 g/100 mL). In some embodiments, the effective amount in a seed soak application of the liquid microalgae based composition may comprise a concentration in the range of 7-8 mL/gallon, resulting in a reduction of the percent solids of microalgae cells from 5-30% to 0.009246-0.063401% (i.e., about 0.009% to about 0.065%, or about 0.009 g/100 mL to about 0.065 g/100 mL). In some embodiments, the effective amount in a seed soak application of the liquid microalgae based composition may comprise a concentration in the range of 8-9 mL/gallon, resulting in a reduction of the percent solids of microalgae cells from 5-30% to 0.010567-0.071327% (i.e., about 0.010% to about 0.070%, or about 0.010 g/100 mL). In some embodiments, the effective amount in a seed soak application of the liquid microalgae based composition may comprise a concentration in the range of 9-10 mL/gallon, resulting in a reduction of the percent solids of microalgae cells from 5-30% to 0.011888-0.079252% (i.e., about 0.012% to about 0.080%, or about 0.012 g/100 mL to about 0.080 g/100 mL).

### Soil Application—Seed

In another non-limiting embodiment, the administration of the liquid microalgae based composition may comprise contacting the soil in the immediate vicinity of the planted seed with an effective amount of the liquid composition. In some embodiments, the liquid microalgae based composition may be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the liquid microalgae based composition may be supplied to the soil by a soil drench method wherein the liquid composition is poured on the soil. In some embodiments, the liquid microalgae based composition may be applied to the soil by sprinklers.

The microalgae based composition may be diluted to a lower concentration for an effective amount in a soil application by mixing a volume of the composition in a volume of water. The percent solids of microalgae cells resulting in the diluted composition may be calculated by the multiplying the original percent solids in the composition by the ratio of the volume of the composition to the volume of water. Alternatively, the grams of microalgae cells in the diluted composition can be calculated by multiplying the original grams of microalgae cells per 100 mL by the ratio of the volume of the composition to the volume of water. In some embodiments, the effective amount in a soil application of the liquid microalgae based composition may comprise a concentration in the range of 3.5-10 mL/gallon, resulting in a reduction of the percent solids of microalgae cells from 5-30% to 0.004623-0.079252% (i.e., about 0.004% to about 0.080%, or about 0.004 g/100 mL to about 0.080 g/100 mL). In some embodiments, the effective amount in a soil application of the liquid microalgae based composition may comprise a concentration in the range of 3.5-4 mL/gallon, resulting in a reduction of the percent solids of microalgae cells from 5-30% to 0.004623-0.031701% (i.e., about 0.004% to about 0.032%, or about 0.004 g/100 mL to about 0.032 g/100 mL). In some embodiments, the effective amount in a soil application of the liquid microalgae based composition may comprise a concentration in the range of 4-5 mL/gallon, resulting in a reduction of the percent solids of microalgae cells from 5-30% to 0.005283-0.039626% (i.e., about 0.005% to about 0.040%, or about 0.005 g/100 mL to about 0.040 g/100 mL). In some embodiments, the effective amount in a soil application of the liquid microalgae based composition may comprise a concentration in the range of 5-6 mL/gallon, resulting in a reduction of the percent solids of microalgae cells from 5-30% to 0.006604-0.047551% (i.e., about 0.006% to about 0.050%, or about 0.006 g/100 ml to about 0.050 g/100 mL). In some embodiments, the effective amount in a soil application of the liquid microalgae based composition may comprise a concentration in the range of 6-7 mL/gallon, resulting in a reduction of the percent solids of microalgae cells from 5-30% to 0.007925-0.055476% (i.e., about 0.008% to about 0.055%, or about 0.008 g/100 mL to about 0.055 g/100 mL). In some embodiments, the effective amount in a soil application of the liquid microalgae based composition may comprise a concentration in the range of 7-8 mL/gallon, resulting in a reduction of the percent solids of microalgae cells from 5-30% to 0.009246-0.063401% (i.e., about 0.009% to about 0.065%, or about 0.009 g/100 mL to about 0.065 g/100 mL). In some embodiments, the effective amount in a soil application of the liquid microalgae based composition may comprise a concentration in the range of 8-9 mL/gallon, resulting in a reduction of the percent solids of microalgae cells from 5-30% to 0.010567-0.071327% (i.e., about 0.010% to about 0.075%, or about 0.010 g/100 mL to about 0.075 g/100 mL). In some embodiments, the effective amount in a soil application of the liquid microalgae based composition may comprise a concentration in the range of 9-10 mL/gallon, resulting in a reduction of the percent solids of microalgae cells from 5-30% to 0.011888-0.079252% (i.e., about 0.012% to about 0.080%, or about 0.012 g/100 mL to about 0.080 g/100 mL).

The rate of application of the microalgae based composition at the desired concentration may be expressed as a volume per area. In some embodiments, the rate of application of the liquid microalgae based composition in a soil application may comprise a rate in the range of 50-150 gallons/acre. In some embodiments, the rate of application of the liquid microalgae based composition in a soil application may comprise a rate in the range of 75-125 gallons/acre. In some embodiments, the rate of application of the liquid microalgae based composition in a soil application may comprise a rate in the range of 50-75 gallons/acre. In some embodiments, the rate of application of the liquid microalgae based composition in a soil application may comprise a rate in the range of 75-100 gallons/acre. In some embodiments, the rate of application of the liquid microalgae based composition in a soil application may comprise a rate in the range of 100-125 gallons/acre. In some embodiments, the rate of application of the liquid microalgae based composition in a soil application may comprise a rate in the range of 125-150 gallons/acre.

In some embodiments, the rate of application of the liquid microalgae based composition in a soil application may comprise a rate in the range of 10-50 gallons/acre. In some embodiments, the rate of application of the liquid microalgae based composition in a soil application may comprise a rate in the range of 10-20 gallons/acre. In some embodiments, the rate of application of the liquid microalgae based composition in a soil application may comprise a rate in the range of 20-30 gallons/acre. In some embodiments, the rate of application of the liquid microalgae based composition in a soil application may comprise a rate in the range of 30-40 gallons/acre. In some embodiments, the rate of application of the liquid microalgae based composition in a soil application may comprise a rate in the range of 40-50 gallons/acre.

In some embodiments, the rate of application of the liquid microalgae based composition in a soil application may comprise a rate in the range of 0.01-10 gallons/acre. In some embodiments, the rate of application of the liquid microalgae based composition in a soil application may comprise a rate in the range of 0.01-0.1 gallons/acre. In some embodiments, the rate of application of the liquid microalgae based composition in a soil application may comprise a rate in the range of 0.1-1.0 gallons/acre. In some embodiments, the rate of application of the liquid microalgae based composition in a soil application may comprise a rate in the range of 1-2 gallons/acre. In some embodiments, the rate of application of the liquid microalgae based composition in a soil application may comprise a rate in the range of 2-3 gallons/acre. In some embodiments, the rate of application of the liquid microalgae based composition in a soil application may comprise a rate in the range of 3-4 gallons/acre. In some embodiments, the rate of application of the liquid microalgae based composition in a soil application may comprise a rate in the range of 4-5 gallons/acre. In some embodiments, the rate of application of the liquid microalgae based composition in a soil application may comprise a rate in the range of 5-10 gallons/acre.

### Capillary Action Application

In another non-limiting embodiment, the administration of the liquid microalgae based composition may comprise first soaking the seed in water, removing the seed from the water, drying the seed, applying an effective amount of the liquid composition below the seed planting level in the soil, and planting the seed, wherein the liquid composition supplied to the seed from below by capillary action. In some embodiments, the seed may be soaked in water for a time period in the range of 90-150 minutes. In some embodiments, the seed may be soaked in water for a time period in the range of 110-130 minutes. In some embodiments, the seed may be soaked in water for a time period in the range of 90-100 minutes. In some embodiments, the seed may be soaked in water for a time period in the range of 100-110 minutes. In some embodiments, the seed may be soaked in water for a time period in the range of 110-120 minutes. In some embodiments, the seed may be soaked in water for a time period in the range of 120-130 minutes. In some embodiments, the seed may be soaked in water for a time period in the range of 130-140 minutes. In some embodiments, the seed may be soaked in water for a time period in the range of 140-150 minutes.

The microalgae based composition may be diluted to a lower concentration for an effective amount in a capillary action application by mixing a volume of the composition in a volume of water. The percent solids of microalgae cells resulting in the diluted composition may be calculated by multiplying the original percent solids in the composition by the ratio of the volume of the composition to the volume of water. Alternatively, the grams of microalgae cells in the diluted composition can be calculated by the multiplying the original grams of microalgae cells per 100 mL by the ratio of the volume of the composition to the volume of water. In some embodiments, the effective amount in a capillary action application of the liquid microalgae based composition may comprise a concentration in the range of 6-10 mL/gallon, resulting in a reduction of the percent solids of microalgae cells from 5-30% to 0.007925-0.079252% (i.e., about 0.008% to about 0.080%, or about 0.008 g/100 mL to about 0.080 g/100 mL). In some embodiments, the effective amount in a capillary action application of the liquid microalgae based composition may comprise a concentration in the range of 7-9 mL/gallon, resulting in a reduction of the percent solids of microalgae cells from 5-30% to 0.009245-0.071327% (i.e., about 0.009% to about 0.075%, or about 0.009 g/100 mL to about 0.075 g/100 mL). In some embodiments, the effective amount in a capillary action application of the liquid microalgae based composition may comprise a concentration in the range of 6-7 mL/gallon, resulting in a reduction of the percent solids of microalgae cells from 5-30% to 0.007925-0.05547% (i.e., about 0.008% to about 0.055%, or about 0.008 g/100 mL to about 0.055 g/100 mL). In some embodiments, the effective amount in a capillary action application of the liquid microalgae based composition may comprise a concentration in the range of 7-8 mL/gallon, resulting in a reduction of the percent solids of microalgae cells from 5-30% to 0.009246-0.063401% (i.e., about 0.009% to about 0.065%, or about 0.009 g/100 mL to about 0.065 g/100 mL). In some embodiments, the effective amount in a capillary action application of the liquid microalgae based composition may comprise a concentration in the range of 8-9 mL/gallon, resulting in a reduction of the percent solids of microalgae cells from 5-30% to 0.010567-0.071327% (i.e., about 0.010% to about 0.075%, or about 0.010 g/100 mL to about 0.075 g/100 mL). In some embodiments, the effective amount in a capillary action application of the liquid microalgae based composition may comprise a concentration in the range of 9-10 mL/gallon, resulting in a reduction of the percent solids of microalgae cells from 5-30% to 0.011888-0.079252% (i.e., about 0.012% to about 0.080%, or about 0.012 g/100 mL to about 0.080 g/100 mL).

### Hydroponic Application

In another non-limiting embodiment, the administration of the liquid microalgae based composition to a seed or plant may comprise applying the microalgae based composition in combination with a nutrient medium to seeds disposed in and plants growing in a hydroponic growth medium or an inert growth medium (e.g., coconut husks). The liquid composition may be applied multiple times per day, per week, or per growing season.

### Foliar Application

In one non-limiting embodiment, the administration of the liquid microalgae based composition may comprise contacting the foliage of the plant with an effective amount of the liquid composition. In some embodiments, the liquid microalgae based composition may be sprayed on the foliage by a hand sprayer, a sprayer on an agriculture implement, or a sprinkler.

The microalgae based composition may be diluted to a lower concentration for an effective amount in a foliar application by mixing a volume of the composition in a volume of water. The percent solids of microalgae cells resulting in the diluted composition may be calculated by multiplying the original percent solids in the composition by the ratio of the volume of the composition to the volume of water. Alternatively, the grams of microalgae cells in the diluted composition can be calculated by the multiplying the original grams of microalgae cells per 100 mL by the ratio of the volume of the composition to the volume of water. In some embodiments, the effective amount in a foliar application of the liquid microalgae based composition may comprise a concentration in the range of 2-10 mL/gallon, resulting in a reduction of the percent solids of microalgae cells from 5-30% to 0.002642-0.079252% (i.e., about 0.003% to about 0.080%, or about 0.003 g/100 mL to about 0.080 g/100 mL). In some embodiments, the effective amount in a foliar application of the liquid microalgae based composition may comprise a concentration in the range of 2-3 mL/gallon, resulting in a reduction of the percent solids of microalgae cells from 5-30% to 0.002642-0.023775% (i.e., about 0.003% to about 0.025%, or about 0.003 g/100 mL to about 0.025 g/100 mL). In some embodiments, the effective amount in a foliar application of the liquid microalgae based composition may comprise a concentration in the range of 3-4 mL/gallon, resulting in a reduction of the percent solids of microalgae cells from 5-30% to 0.003963-0.031701% (i.e., about 0.004% to about 0.035%, or about 0.004 g/100 mL to about 0.035 g/100 mL). In some embodiments, the effective amount in a foliar application of the liquid microalgae based composition may comprise a concentration in the range of 4-5 mL/gallon, resulting in a reduction of the percent solids of microalgae cells from 5-30% to 0.005283-0.039626% (i.e., about 0.005% to about 0.040%, or about 0.005 g/100 mL to about 0.040 g/100 mL). In some embodiments, the effective amount in a foliar application of the liquid microalgae based composition may comprise a concentration in the range of 5-6 mL/gallon, resulting in a reduction of the percent solids of microalgae cells from 5-30% to 0.006604-0.047551% (i.e., about 0.007% to about 0.050%, or about 0.007 g/100 mL to about 0.050 g/100 mL). In some embodiments, the effective amount in a foliar application of the liquid microalgae based composition may comprise a concentration in the range of 6-7 mL/gallon, resulting in a reduction of the percent solids of microalgae cells from 5-30% to 0.007925-0.055476% (i.e., about 0.008% to about 0.055%, or about 0.008 g/100 mL to about 0.055 g/100 mL). In some embodiments, the effective amount in a foliar application of the liquid microalgae based composition may comprise a concentration in the range of 7-8 mL/gallon, resulting in a reduction of the percent solids of microalgae cells from 5-30% to 0.009246-0.063401% (i.e., about 0.009% to about 0.065%, or about 0.009 g/100 mL to about 0.065 g/100 mL). In some embodiments, the effective amount in a foliar application of the liquid microalgae based composition may comprise a concentration in the range of 8-9 mL/gallon, resulting in a reduction of the percent solids of microalgae cells from 5-30% to 0.010567-0.071327% (i.e., about 0.010% to about 0.070%, or about 0.010 g/100 mL to about 0.070 g/100 mL). In some embodiments, the effective amount in a foliar application of the liquid microalgae based composition may comprise a concentration in the range of 9-10 mL/gallon, resulting in a reduction of the percent solids of microalgae cells from 5-30% to 0.011888-0.079252% (i.e., about 0.012% to about 0.080%, or about 0.012 g/100 mL to about 0.080 g/100 mL).

The rate of application of the microalgae based composition at the desired concentration may be expressed as a volume per area. In some embodiments, the rate of application of the liquid microalgae based composition in a foliar application may comprise a rate in the range of 10-50 gallons/acre. In some embodiments, the rate of application of the liquid microalgae based composition in a foliar application may comprise a rate in the range of 10-15 gallons/acre. In some embodiments, the rate of application of the liquid microalgae based composition in a foliar application may comprise a rate in the range of 15-20 gallons/acre. In some embodiments, the rate of application of the liquid microalgae based composition in a foliar application may comprise a rate in the range of 20-25 gallons/acre. In some embodiments, the rate of application of the liquid microalgae based composition in a foliar application may comprise a rate in the range of 25-30 gallons/acre. In some embodiments, the rate of application of the liquid microalgae based composition in a foliar application may comprise a rate in the range of 30-35 gallons/acre. In some embodiments, the rate of application of the liquid microalgae based composition in a foliar application may comprise a rate in the range of 35-40 gallons/acre. In some embodiments, the rate of application of the liquid microalgae based composition in a foliar application may comprise a rate in the range of 40-45 gallons/acre. In some embodiments, the rate of application of the liquid microalgae based composition in a foliar application may comprise a rate in the range of 45-50 gallons/acre.

In some embodiments, the rate of application of the liquid microalgae based composition in a foliar application may comprise a rate in the range of 0.01-10 gallons/acre. In some embodiments, the rate of application of the liquid microalgae based composition in a foliar application may comprise a rate in the range of 0.01-0.1 gallons/acre. In some embodiments, the rate of application of the liquid microalgae based composition in a foliar application may comprise a rate in the range of 0.1-1.0 gallons/acre. In some embodiments, the rate of application of the liquid microalgae based composition in a foliar application may comprise a rate in the range of 1-2 gallons/acre. In some embodiments, the rate of application of the liquid microalgae based composition in a foliar application may comprise a rate in the range of 2-3 gallons/acre. In some embodiments, the rate of application of the liquid microalgae based composition in a foliar application may comprise a rate in the range of 3-4 gallons/acre. In some embodiments, the rate of application of the liquid microalgae based composition in a foliar application may comprise a rate in the range of 4-5 gallons/acre. In some embodiments, the rate of application of the liquid microalgae based composition in a foliar application may comprise a rate in the range of 5-10 gallons/acre.

The frequency of the application of the microalgae based composition may be expressed as the number of applications per period of time (e.g., two applications per month), or by the period of time between applications (e.g., one application every 21 days). In some embodiments, the plant may be contacted by the liquid microalgae based composition in a foliar application every 3-28 days. In some embodiments, the plant may be contacted by the liquid microalgae based composition in a foliar application every 4-10 days. In some embodiments, the plant may be contacted by the liquid microalgae based composition in a foliar application every 18-24 days. In some embodiments, the plant may be contacted by the liquid microalgae based composition in a foliar application every 3-7 days. In some embodiments, the plant may be contacted by the liquid microalgae based composition in a foliar application every 7-14 days. In some embodiments, the plant may be contacted by the liquid microalgae based composition in a foliar application every 14-21 days. In some embodiments, the plant may be contacted by the liquid microalgae based composition in a foliar application every 21-28 days.

Foliar application(s) of the microalgae based composition generally begin after the plant has become established, but may begin before establishment, at defined time period after planting, or at a defined time period after emergence form the soil in some embodiments. In some embodiments, the plant may be first contacted by the liquid microalgae based composition in a foliar application 5-14 days after the plant emerges from the soil. In some embodiments, the plant may be first contacted by the liquid microalgae based composition in a foliar application 5-7 days after the plant emerges from the soil. In some embodiments, the plant may be first contacted by the liquid microalgae based composition in a foliar application 7-10 days after the plant emerges from the soil. In some embodiments, the plant may be first contacted by the liquid microalgae based composition in a foliar application 10-12 days after the plant emerges from the soil. In some embodiments, the plant may be first contacted by the liquid microalgae based composition in a foliar application 12-14 days after the plant emerges from the soil.

### Soil Application—Plant

In another non-limiting embodiment, the administration of the liquid microalgae based composition may comprise contacting the soil in the immediate vicinity of the plant with an effective amount of the liquid composition. In some embodiments, the liquid composition may be supplied to the soil by injection into to a low volume irrigation system, such as but not limited to a drip irrigation system supplying water beneath the soil through perforated conduits or at the soil level by fluid conduits hanging above the ground or protruding from the ground. In some embodiments, the liquid microalgae based composition may be supplied to the soil by a soil drench method wherein the liquid composition is poured on the soil. In some embodiments, the liquid microalgae based composition may be supplied to the soil by sprinklers.

The microalgae based composition may be diluted to a lower concentration for an effective amount in a soil application by mixing a volume of the composition in a volume of water. The percent solids of microalgae cells resulting in the diluted composition may be calculated by multiplying the original percent solids of microalgae cells in the composition by the ratio of the volume of the composition to the volume of water. Alternatively, the grams of microalgae cells in the diluted composition can be calculated by the multiplying the original grams of microalgae cells per 100 mL by the ratio of the volume of the composition to the volume of water. In some embodiments, the effective amount in a soil application of the liquid microalgae based composition may comprise a concentration in the range of 1-50 mL/gallon, resulting in a reduction of the percent solids of microalgae cells from 5-30% to 0.001321-0.396258% (i.e., about 0.001% to about 0.400%, or about 0.001 g/100 mL to about 0.400 g/100 mL). In some embodiments, the effective amount in a soil application of the liquid microalgae based composition may comprise a concentration in the range of 1-10 mL/gallon, resulting in a reduction of the percent solids of microalgae cells from 5-30% to 0.001321-0.079252% (i.e., about 0.001% to about 0.080%, or about 0.001 g/100 mL to about 0.080 g/100 mL). In some embodiments, the effective amount in a soil application of the liquid microalgae based composition may comprise a concentration in the range of 2-7 mL/gallon, resulting in a reduction of the percent solids of microalgae cells from 5-30% to 0.002642-0.055476% (i.e., about 0.003% to about 0.055%, or about 0.003 g/100 mL to about 0.055 g/100 mL). In some embodiments, the effective amount in a soil application of the liquid microalgae based composition may comprise a concentration in the range of 10-20 mL/gallon, resulting in a reduction of the percent solids of microalgae cells from 5-30% to 0.013201-0.158503% (i.e., about 0.013% to about 0.160%, or about 0.013 g/100 mL to about 0.160 g/100 mL). In some embodiments, the effective amount in a soil application of the liquid microalgae based composition may comprise a concentration in the range of 20-30 mL/gallon, resulting in a reduction of the percent solids of microalgae cells from 5-30% to 0.026417-0.237755% (i.e., about 0.025% to about 0.250%, or about 0.025 g/100 mL to about 0.250 g/100 mL). In some embodiments, the effective amount in a soil application of the liquid microalgae based composition may comprise a concentration in the range of 30-45 mL/gallon, resulting in a reduction of the percent solids of microalgae cells from 5-30% to 0.039626-0.356631% (i.e., about 0.040% to about 0.360%, or about 0.040 g/100 mL to about 0.360 g/100 mL). In some embodiments, the effective amount in a soil application of the liquid microalgae based composition may comprise a concentration in the range of 30-40 mL/gallon, resulting in a reduction of the percent solids of microalgae cells from 5-30% to 0.039626-0.317007% (i.e., about 0.040% to about 0.320%, or about 0.040 g/100 mL to about 0.320 g/100 mL). In some embodiments, the effective amount in a soil application of the liquid microalgae based composition may comprise a concentration in the range of 40-50 mL/gallon, resulting in a reduction of the percent solids of microalgae cells from 5-30% to 0.052834-0.396258% (i.e., about 0.055% to about 0.400%, or about 0.055 g/100 mL to about 0.400 g/100 mL).

The rate of application of the microalgae based composition at the desired concentration may be expressed as a volume per area. In some embodiments, the rate of application of the liquid microalgae based composition in a soil application may comprise a rate in the range of 50-150 gallons/acre. In some embodiments, the rate of application of the liquid microalgae based composition in a soil application may comprise a rate in the range of 75-125 gallons/acre. In some embodiments, the rate of application of the liquid microalgae based composition in a soil application may comprise a rate in the range of 50-75 gallons/acre. In some embodiments, the rate of application of the liquid microalgae based composition in a soil application may comprise a rate in the range of 75-100 gallons/acre. In some embodiments, the rate of application of the liquid microalgae based composition in a soil application may comprise a rate in the range of 100-125 gallons/acre. In some embodiments, the rate of application of the liquid microalgae based composition in a soil application may comprise a rate in the range of 125-150 gallons/acre.

In some embodiments, the rate of application of the liquid microalgae based composition in a soil application may comprise a rate in the range of 10-50 gallons/acre. In some embodiments, the rate of application of the liquid microalgae based composition in a soil application may comprise a rate in the range of 10-20 gallons/acre. In some embodiments, the rate of application of the liquid microalgae based composition in a soil application may comprise a rate in the range of 20-30 gallons/acre. In some embodiments, the rate of application of the liquid microalgae based composition in a soil application may comprise a rate in the range of 30-40 gallons/acre. In some embodiments, the rate of application of the liquid microalgae based composition in a soil application may comprise a rate in the range of 40-50 gallons/acre.

In some embodiments, the rate of application of the liquid microalgae based composition in a soil application may comprise a rate in the range of 0.01-10 gallons/acre. In some embodiments, the rate of application of the liquid microalgae based composition in a soil application may comprise a rate in the range of 0.01-0.1 gallons/acre. In some embodiments, the rate of application of the liquid microalgae based composition in a soil application may comprise a rate in the range of 0.1-1.0 gallons/acre. In some embodiments, the rate of application of the liquid microalgae based composition in a soil application may comprise a rate in the range of 1-2 gallons/acre. In some embodiments, the rate of application of the liquid microalgae based composition in a soil application may comprise a rate in the range of 2-3 gallons/acre. In some embodiments, the rate of application of the liquid microalgae based composition in a soil application may comprise a rate in the range of 3-4 gallons/acre. In some embodiments, the rate of application of the liquid microalgae based composition in a soil application may comprise a rate in the range of 4-5 gallons/acre. In some embodiments, the rate of application of the liquid microalgae based composition in a soil application may comprise a rate in the range of 5-10 gallons/acre.

The frequency of the application of the microalgae based composition may be expressed as the number of applications per period of time (e.g., two applications per month), or by the period of time between applications (e.g., one application every 21 days). In some embodiments, the plant may be contacted by the liquid microalgae based composition in a soil application every 3-28 days. In some embodiments, the plant may be contacted by the liquid microalgae based composition in a soil application every 4-10 days. In some embodiments, the plant may be contacted by the liquid microalgae based composition in a soil application every 18-24 days. In some embodiments, the plant may be contacted by the liquid microalgae based composition in a soil application every 3-7 days. In some embodiments, the plant may be contacted by the liquid microalgae based composition in a soil application every 7-14 days. In some embodiments, the plant may be contacted by the liquid microalgae based composition in a soil application every 14-21 days. In some embodiments, the plant may be contacted by the liquid microalgae based composition in a soil application every 21-28 days.

Soil application(s) of the microalgae based composition generally begin after the plant has become established, but may begin before establishment, at a defined time period after planting, or at a defined time period after emergence from the soil in some embodiments. In some embodiments, the plant may be first contacted by the liquid microalgae based composition in a soil application 5-14 days after the plant emerges from the soil. In some embodiments, the plant may be first contacted by the liquid microalgae based composition in a soil application 5-7 days after the plant emerges from the soil. In some embodiments, the plant may be first contacted by the liquid microalgae based composition in a soil application 7-10 days after the plant emerges from the soil. In some embodiments, the plant may be first contacted by the liquid microalgae based composition in a soil application 10-12 days after the plant emerges from the soil. In some embodiments, the plant may be first contacted by the liquid microalgae based composition in a soil application 12-14 days after the plant emerges from the soil.

Whether in a seed soak, soil, capillary action, foliar, or hydroponic application the method of use comprises relatively low concentrations of the liquid microalgae based composition. Even at such low concentrations, the described microalgae based composition has been shown to be effective at producing an enhanced characteristic in plants. The ability to use low concentrations allows for a reduced impact on the environment that may result from over application and an increased efficiency in the method of use of the liquid microalgae based composition by requiring a small amount of material to produce the desired effect. In some embodiments, the use of the liquid microalgae based composition with a low volume irrigation system in soil applications allows the low concentration of the liquid composition to remain effective and not be diluted to a point where the composition is no longer in at a concentration capable of producing the desired effect on the plants while also increasing the grower's water use efficiency.

In conjunction with the low concentrations of microalgae cells in the liquid composition necessary to be effective for enhancing the described characteristics of plants, the liquid composition may does not have be to administered continuously or at a high frequency (e.g., multiple times per day, daily). The ability of the liquid microalgae based composition to be effective at low concentrations and a low frequency of application was an unexpected result, due to the traditional thinking that as the concentration of active ingredients decreases the frequency of application should increase to provide adequate amounts of the active ingredients. Effectiveness at low concentration and application frequency increases the material usage efficiency of the method of using the liquid microalgae based composition while also increasing the yield efficiency of the agricultural process.

### Additional Application Embodiments

In some embodiments, the liquid microalgae based composition may be applied to soil, seeds, and plants in an in-furrow application. An application of the microalgae based composition in-furrow requires a low amount of water and targets the application to a small part of the field. The application in-furrow also concentrates the application of the microalgae based composition at a place where the seedling radicles and roots will pick up the material in the composition or make use of captured nutrients, including phytohormones.

In some embodiments, the liquid microalgae based composition may be applied to soil, seeds, and plants as a side dress application. One of the principals of plant nutrient applications is to concentrate the nutrients in an area close to the root zone so that the plant roots will encounter the nutrients as the plant grows. Side-dress applications use a “knife” that is inserted into the soil and delivers the nutrients around 2 inches along the row and about 2 inches or more deep. Side-dress applications are made when the plants are young and prior to flowering to support yield. Side-dress applications can only be made prior to planting in drilled crops, i.e. wheat and other grains, and alfalfa, but in row crops such as peppers, corn, tomatoes they can be made after the plants have emerged.

In some embodiments, the liquid microalgae based composition may be applied to soil, seeds, and plants through a drip system. Depending on the soil type, the relative concentrations of sand, silt and clay, and the root depth, the volume that is irrigated with a drip system may be about ⅓ of the total soil volume. The soil has an approximate weight of 4,000,000 lbs. per acre one foot deep. Because the roots grow where there is water, the plant nutrients in the microalgae based composition would be delivered to the root system where the nutrients will impact most or all of the roots. Experimental testing of different application rates to develop a rate curve would aid in determining the optimum rate application of a microalgae based composition in a drip system application.

In some embodiments, the liquid microalgae based composition may be applied to soil, seeds, and plants through a pivot irrigation application. The quantity and frequency of water delivered over an area by a pivot irrigation system is dependent on the soil type and crop. Applications may be 0.5 inch or more and the exact demand for water can be quantitatively measured using soil moisture gauges. For crops such as alfalfa that are drilled in (very narrow row spacing), the roots occupy the entire soil area. Penetration of the soil by the microalgae based composition may vary with a pivot irrigation application, but would be effective as long as the application can target the root system of the plants. In some embodiments, the microalgae based composition may be applied in a broadcast application to plants with a high concentration of plants and roots, such as row crops.

### Anti-Fungal

In some embodiments, the microalgae based composition may comprise anti-fungal properties or induce anti-fungal activity against fungal pathogens. In some embodiments, the application of a microalgae based composition may increase the stolon rooting in turf grass, which may aid the root nodes in surviving and resisting attacks from fungi and fungal plant pathogens. In some embodiments, the microalgae based composition may comprise an actinomycete that produces an anti-fungal agent.

### Cellulose/Cellulase

In some embodiments, the microalgae based composition may contain cellulose-degrading fungi, bacteria, or a combination of both. In some embodiments, the microalgae in the composition may produce cellulase. In some embodiments, the microalgae based composition may promote cellulose degradation in the soil.

### Phenotypic Response

In some embodiments, the microalgae based composition may comprise levels of cytokinin and acetate sufficient to cause a phenotypic response in plants. In some embodiments, the microalgae based composition may promote leakage of indole acetic acid (IAA) from plant roots. Leakage of IAA from plant roots of seedlings may be measured by adding Salkowski's reagent to the growth solution and measuring with a spectrophotometer at 530 nm for optical density.

### Major Plant Nutrients

Major plant nutrients comprise nutrients from the atmosphere and water, primary nutrients, secondary nutrients, and micronutrients. In some embodiments, the microalgae based composition optimizes the uptake of such major plant nutrients from the soil by the plants, and may decrease the need to fertilize over time. The nutrients taken up from the atmosphere and water include carbon, hydrogen, and oxygen.

The primary plant nutrients include nitrogen, phosphorus, and potassium. Analysis of the major plant nutrients in a fertilizer may be used to determine a nutrient deficiency or to tailor a composition to achieve a targeted result (e.g., yield). Forms of nitrogen suitable for application to plants as a fertilizer may comprise urea, ammonium (e.g., ammonium sulfate), ammonia, nitrite, and nitrate (e.g., calcium nitrate). The primary function of nitrogen (N) is to provide amino groups in amino acids which are building blocks of peptides/proteins. See Maathuis, F. J. Physiological functions of mineral macronutrients. Curr. Opin. Plant Biol. 12, 250-258 (2009). Nitrogen is also abundant in nucleotides, where it occurs incorporated in the ring structure of purine and pyrimidine bases. Nucleotides form the constituents of nucleic acids but also function as in energy homeostasis, signaling and protein regulation.

Nitrogen is essential in the biochemistry of many non-protein compounds such as co-enzymes, photosynthetic pigments, secondary metabolites and polyamines. Nitrogen nutrition drives plant dry matter production through the control of both the leaf area index (LAI) and the amount of nitrogen per unit of leaf area called specific leaf nitrogen (SLN). Thus there is a tight relationship between nitrogen supply, leaf nitrogen distribution, and leaf photosynthesis. Around 80% of earth's atmosphere consists of nitrogen, however the extremely stable form of atomic nitrogen (N₂) is not available to plants.

Plants can take up and use nitrate (NO₃−) or ammonium (NH₄+) as primary source of nitrogen. See Amtmann, A. & Armengaud, P. Effects of N, P, K and S on metabolism: new knowledge gained from multi-level analysis. Curr. Opin. Plant Biol. 12, 275-283 (2009). Nitrogen is available in many different forms in the soil, but the three most abundant forms are nitrate, ammonium and amino acids. See Miller, a. J. & Cramer, M. D. Root nitrogen acquisition and assimilation. Plant and Soil 274, (2005). In general, plants adapted to low pH and reducing soil conditions tend to take up NH₄+. At higher pH and in more aerobic soils, NO₃− is the predominant form. Both NO₃− and NH₄+ are highly mobile in the soil.

Huss-Danell et. al. showed L-Serine, L-Glutamic acid, Glycine, L-Arginine and L-Alanine are within uptake capacity of barley. See Jämtgård, S., Näsholm, T. & Huss-Danell, K. Characteristics of amino acid uptake in barley. Plant Soil 302, 221-231 (2008). The Haber-Bosch process has made a significant contribution to agriculture because without ammonia there would be no inorganic fertilizers and nearly half the world would go hungry. See Smil, V. Detonator of the population explosion. Nature 400, 1999 (1999).

During vegetative growth, nitrogen is taken up by the roots and assimilated to build up plant cellular structures. After flowering, the nitrogen accumulated in the vegetative parts of the plant is remobilized and translocated to the grain. In most crop species a substantial amount of nitrogen is absorbed after flowering to contribute to grain protein deposition. The relative contribution of the three processes to grain filling is variable from one species to the other and may be influenced under agronomic conditions by soil nitrogen availability at different periods of plant development, by the timing of nitrogen fertilizer application, and by environmental conditions such as light and various biotic and abiotic stresses. The relative contribution (%) of nitrogen remobilization and post-flowering nitrogen uptake differs among crops. Rice utilizes mostly ammonium as a nitrogen source, whereas the other crops preferentially use nitrate. Note that in the case of oilseed rape, a large amount of the nitrogen taken up during the vegetative growth phase is lost due to the falling of the leaves. See Hirel, B., Le Gouis, J., Ney, B. & Gallais, A. The challenge of improving nitrogen use efficiency in crop plants: Towards a more central role for genetic variability and quantitative genetics within integrated approaches. J. Exp. Bot. 58, 2369-2387 (2007).

In Arabidopsis, there are three families of nitrate transporters NRT1, NRT2, and CLC with 53 NRT1, 7 NRT2, and 7 CLC genes identified. The NRT2 are high-affinity nitrate transporters while most of the NRT1 family members characterized so far are low-affinity nitrate transporters, except NRT1.1, which is a dual-affinity nitrate transporter. NRT1.1, NRT1.2, NRT2.1, and NRT2.2 are involved primarily in nitrate uptake from the external environment. See Miller, A. J., Fan, X., Orsel, M., Smith, S. J. & Wells, D. M. Nitrate transport and signalling. J. Exp. Bot. 58, 2297-2306 (2007) and Tsay, Y. F., Chiu, C. C., Tsai, C. B., Ho, C. H. & Hsu, P. K. Nitrate transporters and peptide transporters. FEBS Lett. 581, 2290-2300 (2007).

Forms of phosphorus (P) suitable for application to plants as a fertilizer may comprise phosphorus pentoxide. The availability of phosphorus may vary with the soil composition and the pH of the soil. Plant mechanisms to increase the uptake of phosphorus may comprise: rhizosphere (i.e., areas along the root that exudate nutrients which support microbial growth), root exudation of organic acids, and infection by mycorrhizal fungi. Phosphorus availability may also be increased by changing the soil pH of calcareous soils to acidic in a small zone, use of humates/fulvates to retain availability, addition of mycorrhizae to the soil, increasing the organic matter of the soil, and increasing the cation exchange capacity of the soil. The acidification of soil may be achieved by the addition of liquid phosphorus acids, mixing of degradable sulfur with granular phosphorus, or increasing the level of organic matter.

Phosphorus is a major structural component of nucleic acids and membrane lipids, and takes part in regulatory pathways involving phospholipid-derived signaling molecules (e.g. phosphatidyl-inositol and inositol triphosphate) or phosphorylation reactions (e.g. MAP kinase cascades). See Raghothama, K. G. & Karthikeyan, a. S. Phosphate acquisition. Plant Soil 274, 37-49 (2005). Phospho-groups activate both enzymes and metabolic intermediates, and provide reversible energy storage in ATP. See Amtmann, A. & Armengaud, P. Effects of N, P, K and S on metabolism: new knowledge gained from multi-level analysis. Curr. Opin. Plant Biol. 12, 275-283 (2009). Hydrolysis of phosphate esters is a critical process in the energy metabolism and metabolic regulation of plant cells.

Plaxton et. al. hypothesized APase (plant acid phosphatase) have distinct metabolic functions which include the following: phytase, phosphoglycolate phosphatase, 3-phosphoglycerate phosphatase, phosphoenolpyruvate phosphatase, and phosphotyrosyl-protein phosphatase. See Duff, S. M. G., Sarath, G. & Plaxton, W. C. The role of acid phosphatases in plant phosphorus metabolism. Physiol. Plant. 90, 791-800 (1994). There are excellent reviews on the role of phosphorus in the glycolytic pathway, regulation of RNases, phosphatases, mycorrhizal interactions, root architecture, inorganic phosphorus uptake, modeling of inorganic phosphorus uptake, rhizosphere, and plant nutrition. See Duff, S. M. G., Sarath, G. & Plaxton, W. C. The role of acid phosphatases in plant phosphorus metabolism. Physiol. Plant. 90, 791-800 (1994), Plaxton, W. C. the Organization and Regulation of Plant Glycolysis. Annu. Rev. Plant Physiol. Plant Mol. Biol. 47, 185-214 (1996), Green, P. J. The Ribonucleases of Higher Plants. Annu. Rev. Plant Physiol. Plant Mol. Biol. 45, 421-445 (1994), Harrison, M. J. & Harrison, M. J. Molecular and Cellular Aspects of the Arbuscular Mycorrhizal Symbiosis. Annu. Rev. Plant Physiol. Plant Mol. Biol. 50, 361-389 (1999), Lynch, J. Root Architecture and Plant Productivity. Plant Physiol. 109, 7-13 (1995), and Schachtman, D. P., Reid, R. J., Ayling, S. M., S, D. B. D. P. & a, S. S. S. M. Update on Phosphorus Uptake Phosphorus Uptake by Plants: From Soil to Cell. 447-453 (1998). doi:10.1104/pp. 116.2.447. These reviews provide a comprehensive picture of the complex nature of inorganic phosphorus acquisition and utilization by plants.

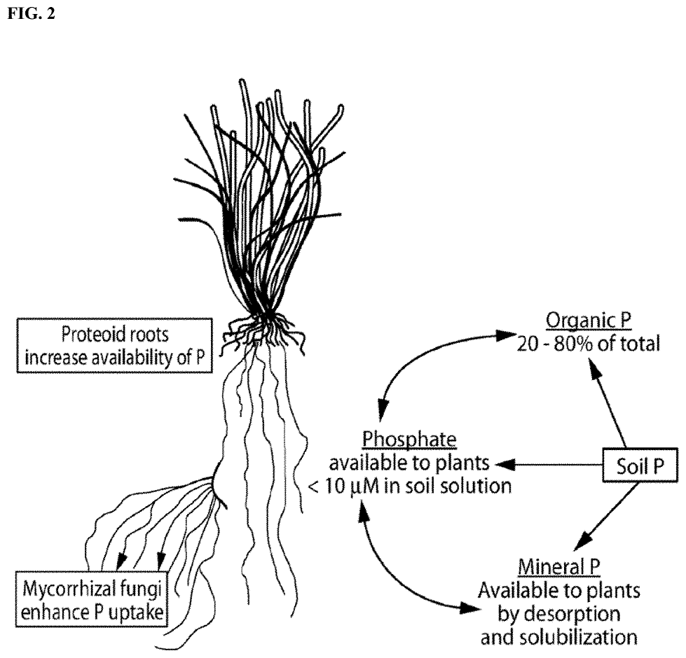

More than 90% of soil phosphorus is normally fixed and cannot be used by plants. Another part of insoluble phosphorus, the ‘labile fraction’, exchanges with the soil solution. The inorganic phosphorus released from the labile compartment can be taken up by plants, however this release is extremely slow and thus phosphorus deficiency is widespread. See Maathuis, F. J. Physiological functions of mineral macronutrients. Curr. Opin. Plant Biol. 12, 250-258 (2009). Plants exhibit numerous morphological, physiological, and metabolic adaptations to (orthophosphate) inorganic phosphorus deprivation. See Theodorou, M. E., Theodorou, M. E., Plaxton, W. C. & Plaxton, W. C. Metabolic Adaptations. 339-344 (1993). Soil phosphorus is found in different forms, such as organic and mineral phosphours as shown in FIG. 2 from Schachtman, D. P., Reid, R. J., Ayling, S. M., S, D. B. D. P. & a, S. S. S. M. Update on Phosphorus Uptake Phosphorus Uptake by Plants: From Soil to Cell. 447-453 (1998). doi:10.1104/pp. 116.2.447. It is important to highlight that 20 to 80% of phosphorus in soils is found in the organic form, the majority of which is phytic acid (inositol hexaphosphate).

Phosphorus deficiency is a major abiotic stress that limits plant growth and crop productivity throughout the world. In most soils, the concentration (approx. 2 μM) of available inorganic phosphorus in soil solution is several orders of magnitude lower than that in plant tissues (5-20 mM). Phosphorus is considered to be the most limiting nutrient for growth of leguminous crops in tropical and subtropical regions. See Ae, N., Arihara, J., Okada, K., Yoshihara, T. & Johansen, C. Phosphorus uptake by pigeon pea and its role in cropping systems of the Indian subcontinent. Science 248, 477-480 (1990).

Plants respond in a variety of ways to phosphate deficiency. See Raghothama, K. G. & Karthikeyan, a. S. Phosphate acquisition. Plant Soil 274, 37-49 (2005). Morphological responses include, but are not limited to: increased root:shoot ratio, changes in root morphology and architecture, increased root hair proliferation, root hair elongation, accumulation of anthocyanin pigments, proteoid root formulation, and increased association with mycorrhizal fungi. Physiological responses include, but are not limited to: enhanced inorganic phosphorus uptake, reduced inorganic phosphorus efflux, increased inorganic phosphorus use efficiency, mobilization of inorganic phosphorus from the vacuole to cytoplasm, increased translocation of phosphorus within plants, retention of more inorganic phosphorus in roots, secretion of organic acids, protons and chelaters, secretion of phosphates and RNases, altered respiration, carbon metabolism, photosynthesis, nitrogen fixation, and aromatic enzyme pathways. Biochemical responses include, but are not limited to: activation of enzymes, enhanced production of phosphates, RNases and organic acids, changes in protein phosphorylation, and activation of glycolytic bypass pathway. Molecular responses include, but are not limited to: activation of genes (RNases, phosphatases, phosphate transporters, Ca-ATPase, vegetative storage proteins, Beta-glucosidase, PEPCase, and novel genes such as TPSII, Mt 4.

Forms of potassium (K) suitable for application to plants as a fertilizer may comprise potassium oxide. Some clay soils are known to release potassium too slowly for utilization by plants. A soil potassium release rate may be determine to assess any deficiency in the supply of potassium. The supply of potassium may be increased by increasing the potassium in the soil (above 3% cation exchange capacity), add humate/fulvates with potassium, apply potassium to the foliage (e.g., 3-4 lb per acre), and increase organic matter in the soil.

The earth's crust contains around 2.6% potassium. In soils, the majority of K⁺ is dehydrated and coordinated to oxygen atoms not available to plants. Typical concentrations in the soil solution vary between 0.1 and 1 mM K⁺ which is high, but most of it is not plant-available. See Maathuis, F. J. Physiological functions of mineral macronutrients. Curr. Opin. Plant Biol. 12, 250-258 (2009). Therefore, crops need to be supplied with soluble potassium fertilizers, the demand of which is expected to increase significantly, particularly in developing regions of the world. See Senbayram, M. & Peiter, E., et al. Potassium in agriculture—Status and perspectives. J. Plant Physiol. 171, 656-669 (2013).

Some soil microorganisms (e.g., Pseudomonas spp., Burkholderia spp., Acidothiobacillicus ferrooxidans, Bacillus mucilaginosus, Bacillus edaphicus, Bacillus megaterium) are able to release potassium from K-bearing minerals by excreting organic acids. See Han, H. S. & Lee, K. D. Phosphate and potassium solubilizing bacteria effect on mineral uptake, soil availability and growth of eggplant. Res. J. Agriculture Biol. Sci. 1, 176-180 (2005) and Wang, H. Y. et al. Plants use alternative strategies to utilize nonexchangeable potassium in minerals. Plant Soil 343, 209-220 (2011). In K-limited areas, the selection of certain species of Ryegrass and Sugarbeets, or varieties that are efficient in solubilizing potassium via exudates (release of citric and oxalic acid) should have a great potential to increase resource use efficiency. See Wang, H. Y. et al. Plants use alternative strategies to utilize nonexchangeable potassium in minerals. Plant Soil 343, 209-220 (2011) and El Dessougi, H., Claassen, N. & Steingrobe, B. Potassium efficiency mechanisms of wheat, barley, and sugar beet grown on a K fixing soil under controlled conditions. J. Plant Nutr. Soil Sci. 165, 732-737 (2002).

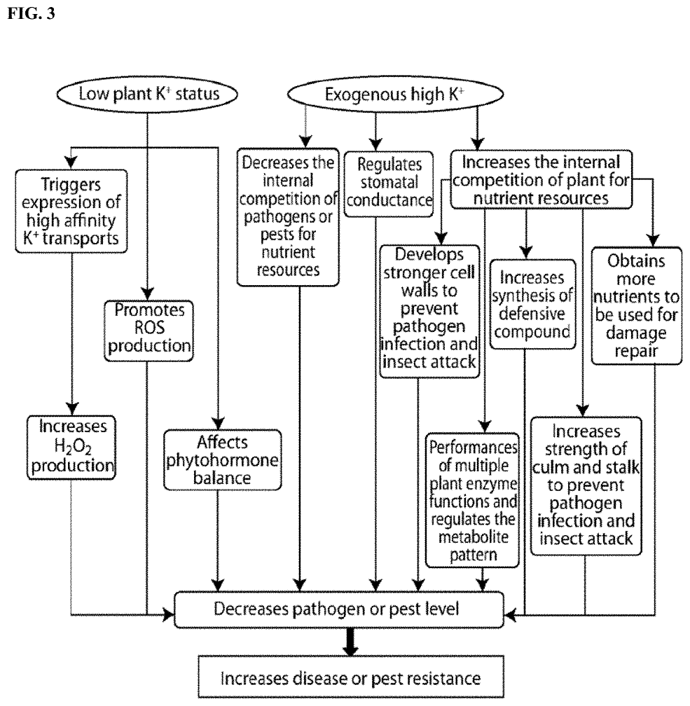

Potassium use in the world is highest for grain crops (37%), followed by fruit and vegetables (22%), oil seeds (16%), sugar and cotton (11%), and other crops (14%). See Senbayram, M. & Peiter, E., et al. Potassium in agriculture—Status and perspectives. J. Plant Physiol. 171, 656-669 (2013). Potassium plays a crucial role in transport (both across membranes and over long distance), translation (ribosomal function) and direct enzyme activation of starch synthase, pyruvate kinase and many others. See Amtmann, A. & Armengaud, P. Effects of N, P, K and S on metabolism: new knowledge gained from multi-level analysis. Curr. Opin. Plant Biol. 12, 275-283 (2009). A shown in FIG. 3, potassium contributes to the survival of plants exposed to various types of biotic stress (e.g., lepidopteron pests—rice, dogwood anthracnose—Cornus florida L) stresses. See Wang, M., Zheng, Q., Shen, Q. & Guo, S. The critical role of potassium in plant stress response. Int. J. Mol. Sci. 14, 7370-7390 (2013); Sarwar, M. Effects of potassium fertilization on population build up of rice stem borers (lepidopteron pests) and rice (Oryza sativa L.) yield. J. Cereal. Oil seeds 3, 6-9 (2012); and Holzmueller, E. J., Jose, S. & Jenkins, M. a. Influence of calcium, potassium, and magnesium on Cornus florida L. density and resistance to dogwood anthracnose. Plant Soil 290, 189-199 (2007).

The use of potassium in fertilizers for plants may decrease the incidence of fungal diseases by up to 70%, bacteria by up to 69%, insects and mites by up to 63%, viruses by up to 41% and nematodes by up to 33%. Meanwhile, the use of potassium in fertilizers may increase the yield of plants infested with fungal diseases by up to 42%, bacteria by up to 57%, insects and mites by up to 36%, viruses by up to 78% and nematodes by up to 19%. See Perrenoud, S. 7DN-Potassium and Plant Health. (1990).

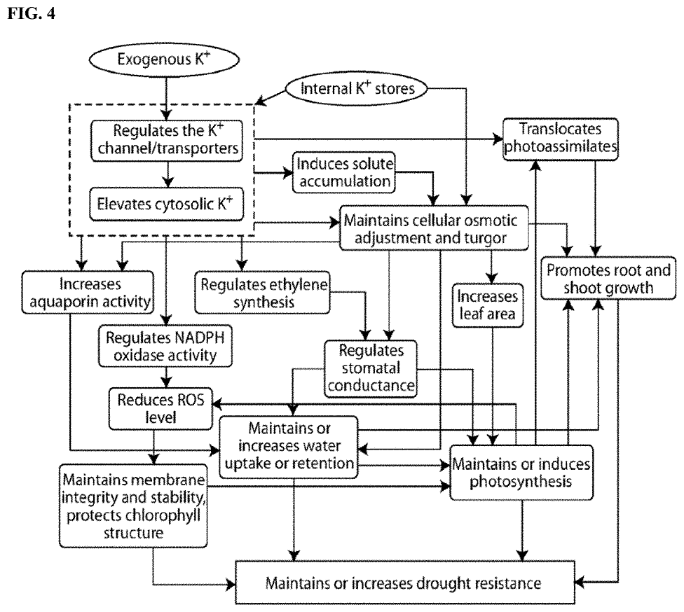

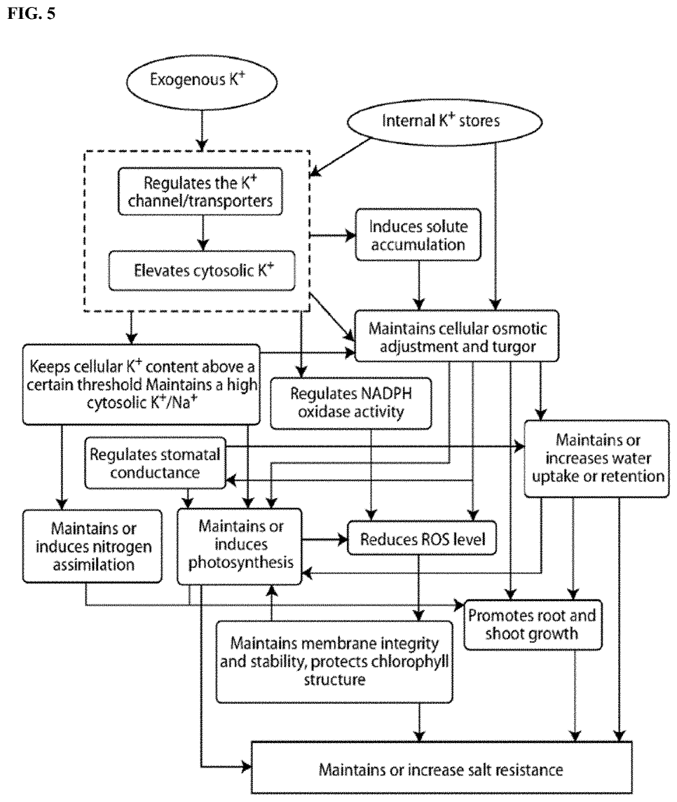

Potassium sufficient conditions increased cell membrane stability, root growth, leaf area and total dry mass for plants living under drought conditions and also improved water uptake and water conservation. Maintaining an adequate potassium nutritional status is critical for plant osmotic adjustment and for mitigating ROS damage as induced by drought stress. See Maurel, C. & Chrispeels, M. J. Aquaporins. A molecular entry into plant water relations. Plant Physiol. 125, 135-138 (2001); Tyerman, S. D., Niemietz, C. M. & Bramley, H. Plant aquaporins: Multifunctional water and solute channels with expanding roles. Plant, Cell Environ. 25, 173-194 (2002); Heinen, R. B., Ye, Q. & Chaumont, F. Role of aquaporins in leaf physiology. J. Exp. Bot. 60, 2971-2985 (2009); and Cakmak, I. The role of potassium in alleviating detrimental effects of abiotic stresses in plants. J. Plant Nutr. Soil Sci. 168, 521-530 (2005). The role of potassium in drought stress is show in FIG. 4.

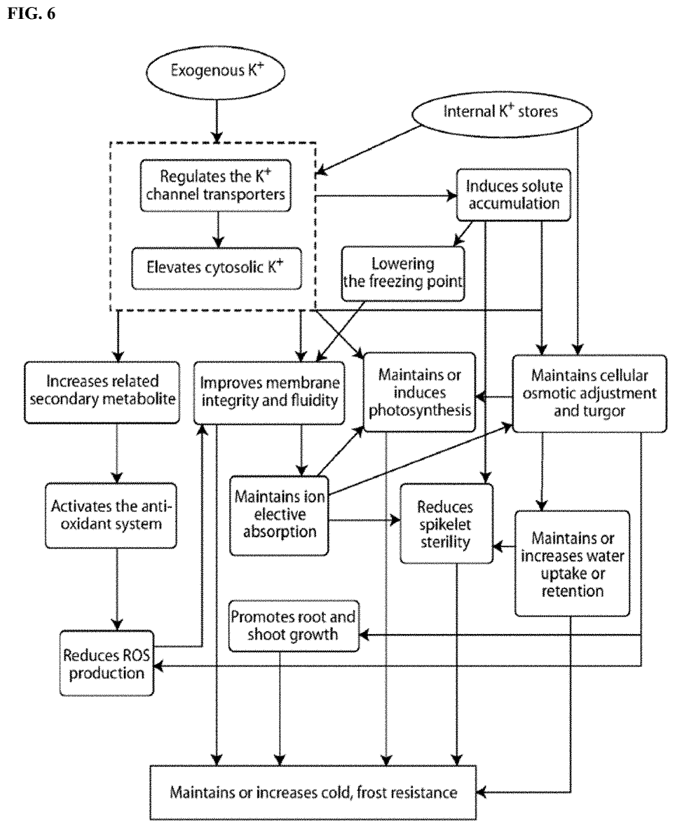

Recent progress in molecular genetics and plant electrophysiology suggests that the ability of a plant to maintain a high cytosolic K+/Na+ ratio appears to be critical to plant salt tolerance. See Shabala, S. & Cuin, T. a. Potassium transport and plant salt tolerance. Physiol. Plant. 133, 651-669 (2008). The role of potassium in salt stress is shown in FIG. 5.

Panax ginseng showed that a high K+ concentration activated the plant's antioxidant system and increased levels of ginsenoside-related secondary metabolite transcripts, which are associated with cold tolerance. See Devi, B. S. R. et al. Influence of potassium nitrate on antioxidant level and secondary metabolite genes under cold stress in Panax ginseng. Russ. J. Plant Physiol. 59, 318-325 (2012). The role of potassium in cold tolerance is shown in FIG. 6.

The secondary nutrients comprise calcium, magnesium, silicon, and sulfur. Secondary nutrients may be supplemented in the soil with dolomitic lime or through a fertilizer formulation.

Calcium (Ca) is required for various structural roles in the cell wall and membranes, is a counter-cation for inorganic and organic anions in the vacuole, and the cytosolic Ca²⁺ concentration ([Ca^{2+]}cyt) is an obligate intracellular messenger coordinating responses to numerous developmental cues and environmental challenges. See White, P. J. & Broadley, M. R. Calcium in plants. Ann. Bot. 92, 487-511 (2003). Movement of calcium via apoplastic and symplastic pathways must be finely balanced to allow root cells to signal using cytosolic Ca′ concentration ([Ca^{2]}cyt), control the rate of calcium delivery to the xylem, and prevent the accumulation of toxic cations in the shoot. See White, P. J. The pathways of calcium movement to the xylem. J. Exp. Bot. 52, 891-899 (2001). Calcium deficiency is rare in nature, but may occur on soils with low base saturation and/or high levels of acidic deposition by contrast several costly Ca-deficiency disorders occur in horticulture. See McLaughlin, S. B. & Wimmer, R. Calcium physiology and terrestrial ecosystem processes. New Phytol. 142, 373-417 (1999).

Calcium disorders in horticulture crops include: a) cracking in tomato fruit, b) tipburn in lettuce, c) calcium deficiency in celery, d) blossom rot in immature tomato fruit, e) bitter pit in apples, and f) gold spot in tomato fruit with calcium oxalate crystals. Ca²⁺ plays a crucial role as an intracellular regulator and functions as a versatile messenger in mediating responses to hormones, biotic/abiotic stress signals and a variety of developmental cues in plants. See Hepler, P. K. Calcium: a central regulator of plant growth and development. Plant Cell 17, 2142-2155 (2005). The Ca²⁺-signaling circuit consists of three major “nodes”—generation of a Ca-signature in response to a signal, recognition of the signature by Ca²⁺ sensors and transduction of the signature message to targets that participate in producing signal-specific responses. See Reddy, V. S. & Reddy, A. S. N. Proteomics of calcium-signaling components in plants. Phytochemistry 65, 1745-1776 (2004). Plants thus possess a myriad of ways in which Ca²⁺ can operate as the intermediary in transducing the stimulus into the appropriate response

Magnesium (Mg) deficiency in plants is a widespread problem, affecting productivity and quality in agriculture. See Hermans, C., Johnson, G. N., Strasser, R. J. & Verbruggen, N. Physiological characterization of magnesium deficiency in sugar beet: Acclimation to low magnesium differentially affects photosystems I and II. Planta 220, 344-355 (2004). Plants require magnesium to harvest solar energy and to drive photochemistry. Beale, S. I. Enzymes of chlorophyll biosynthesis. Photosynth. Res. 60, 43-73 (1999). Magnesium forms octahedral complexes and is able to occupy a central position in chlorophyll, the pigment responsible for light absorption in leaves. All crops require magnesium to capture the sun's energy for growth and production through photosynthesis. Magnesium is also involved in CO₂ assimilation reactions in the chloroplast.

Both photophosphorylation and phosphorylation reactions that occur in the chloroplast are affected by magnesium ions. For example, magnesium is involved in CO₂ fixation by modulating ribulose-1,5-bisphosphate carboxylase/oxygenase (RuBP carboxylase) activity in the stroma of chloroplasts. The energy-rich compounds Mg-ATP and Mg-ADP represent the main complexed magnesium pools in the cytosol, which balance with the free Mg²⁺ pool under the control of adenylate kinase. See Igamberdiev, a U. & Kleczkowski, L. a. Implications of adenylate kinase-governed equilibrium of adenylates on contents of free magnesium in plant cells and compartments. Biochem. J. 360, 225-231 (2001).

A large proportion of the magnesium in plant leaf cells is associated either directly or indirectly with protein synthesis via its roles in ribosomal structure and function. Magnesium is required for the stability of ribosomal particles, especially the polysomes. Functional RNA protein particles require magnesium to perform the sequential reactions needed for protein synthesis from amino acids and other metabolic constituents. Ribosomal subunits are unstable at Mg²⁺ concentrations <10 mM. See Wilkinson, S. R., Welch, Ross M., Mayland, H. F., Grunes, D. L. Magnesium in Plants: Uptake, Distribution, Function, and Utilization by Man and Animals. Met. Ions Biol. Syst. 26, 33-56 (1990).

Magnesium deficiency can develop into an early impairment of sugar metabolism in Phaseolus vulgaris (i.e., common bean), spruce, and spinach. The effects of magnesium deficiency on the photosynthesis and respiration of sugar beets (Beta vulgaris L. cv. F58-554H1) were studied by Ulrich et. al. See Terry, N. & Ulrich, a. Effects of magnesium deficiency on the photosynthesis and respiration of leaves of sugar beet. Plant Physiol. 54, 379-381 (1974). Respiratory CO₂ evolution in the dark increased almost 2-fold in low magnesium leaves. Magnesium deficiency had less effect on leaf (mainly stomatal) diffusion resistance (rl) than on mesophyll resistance (rm) in Mg-deficient plants.

Hermans et. al. showed that a decline in photosynthetic activity might be caused by increased leaf sugar concentrations. See Hermans, C. & Verbruggen, N. Physiological characterization of Mg deficiency in Arabidopsis thaliana. J. Exp. Bot. 56, 2153-2161 (2005). Transcript levels of Cab2 (encoding a chlorophyll a/b protein) were lower in Mg-deficient plants before any obvious decrease in the chlorophyll concentration, which suggests that the reduction of chlorophyll is a response to sugar levels, rather than a lack of magnesium atoms for chelating chlorophyll.

Sulfur (S) represents one of the least abundant essential macronutrients in plants and plays critical roles in the catalytic or electrochemical functions of the biomolecules in cells. Sulfur is found in amino acids (Cys and Met), oligopeptides (glutathione [GSH] and phytochelatins), vitamins and cofactors (biotin, thiamine, CoA, and S-adenosyl-Met), and a variety of secondary products. Secondary sulfur compounds (viz. glucosinolates, γ-glutamyl peptides and alliins), phytoalexins, sulfur-rich proteins (thionins), localized deposition of elemental sulfur and the release of volatile sulfur compounds may provide resistance against pathogens and herbivory. Sulfur deficiency in agricultural areas in the world has been recently observed because emissions of sulfur air pollutants in acid rain have been diminished from industrialized areas. Fertilization of sulfur is required in sulfur deficient agricultural areas in order to prevent low crop quality and productivity.

Sulfur requirements vary greatly among agricultural crops. Brassica crops have a high demand for sulfur (1.5-2.2 kmol ha⁻¹), followed by Allium crops such as leek and onion (1-1.2 kmol ha⁻¹), whereas cereals and legume crops require relatively small quantities of S (0.3-0.6 kmol ha⁻¹). Brassica crops and multiple-cut grass are generally more prone to sulfur deficiency than other crops, because of their high requirements for sulfur. See Saito, K. Sulfur assimilatory metabolism. The long and smelling road. Plant Physiol. 136, 2443-2450 (2004) and Zhao, F., Tausz, M. & Kok, L. J. Role of Sulfur for Plant Production in Agricultural and Natural Ecosystems. Sulfur Metab. Phototrophic Org. 417-435 (2008). doi:10.1007/978-1-4020-6863-8_21.

Micronutrients comprise iron, manganese, zinc, copper, boron, molybdenum, chlorine, sodium, aluminum, vanadium, and nickel. Micronutrients may be supplemented through the application of magnesium, zinc and copper sulfates, oxides, oxy-sulfates, chelates, boric acid, and ammonium molybdate.

The physical, chemical, and biological characteristics of boron suggest that boron (B) likely functions as a critical component of a chemically stable or physically isolated cellular structure. Boron forms a stable cross-link between the apiose residues of 2 RG-II molecules within the cell wall of higher plants. See Brown, P. H. et al. Boron in plant biology. Plant Biol. 4, 205-223 (2002). The mechanism by which boron is acquired by plant roots has been debated. Dordas et. al. demonstrated that channel proteins are involved in boron uptake, with inconclusive evidence showing that boron is transported through “Porin” type channels and uncertainty as to how these channels contribute to boron uptake in vivo. See Dordas, C., Chrispeels, M. J. & Brown, P. H. Permeability and channel-mediated transport of boric acid across membrane vesicles isolated from squash roots. Plant Physiol. 124, 1349-1362 (2000).

During the reproductive growth all plant species have unique sensitivity to boron deficiency, which makes it one of the essential micronutrients. Boron deficiency in crops is more widespread than deficiency of any other micronutrient. The visual symptoms of boron deficiency generally become evident in dicots, maize (e.g., Zea mays), and wheat (e.g., Triticum aestivum) at tissue concentrations of less than 20-30, 10-20 and 10 ppm dry wt, respectively. See Brown, P. H. & Shelp, B. J. Boron mobility in plants. Plant Soil 193, 85-101 (1997). In fruit and nut trees, boron deficiency often results in decreased seed set even when vegetative symptoms are absent. See Nyomora, A. M. S. & Brown, P. H. Fall Foliar-applied Boron Increases Tissue Boron Concentration and Nut Set of Almond. J Amer Soc Hort Sci 122, 405-410 (1997).

Boron deficiency symptoms are related to the main role of boron in plants cell wall expansion and structure. Typical deficiency symptoms include: impaired cell expansion in rapidly growing organs (e.g., leaves, roots, pollen tube), impaired growth of the plant meristems in roots and shoots causing malformation and thick and shorter roots, flower abortion, male and female flowers sterility, and reduced seed set due to inhibition of pollen growth. Boron is unique amongst all essential plant nutrient mineral elements in that plant species differ dramatically in their ability to retranslocate boron within the plant. Boron is important in sugar transport, cell wall synthesis and lignification, cell wall structure, carbohydrate metabolism, RNA metabolism, respiration, indole acetic acid (IAA) metabolism, phenol metabolism, and membrane transport. See Blevins, D. G. & Lukaszewski, K. M. Proposed physiologic functions of boron in plants pertinent to animal and human metabolism. Environ. Health Perspect. 102, 31-33 (1994).

Photosystem II (PSII) uses light energy to split water into protons, electrons and O₂. X-ray crystal structures of cyanobacterial PSII complexes provide information on the structure of the manganese and calcium ions, the redox-active tyrosine called Y_{Z} and the surrounding amino acids that comprise the O₂-evolving complex (OEC). See Brudvig, G. W. Water oxidation chemistry of photosystem II. Philos. Trans. R. Soc. Lond. B. Biol. Sci. 363, 1211-1218; discussion 1218-1219 (2008) and Hakala, M., Rantamaki, S., Puputti, E. M., Tyystjarvi, T. & Tyystjärvi, E. Photoinhibition of manganese enzymes: Insights into the mechanism of photosystem II photoinhibition. J. Exp. Bot. 57, 1809-1816 (2006).

Due to the critical role of manganese (Mn) in photosynthesis it is clear the manganese deficiency substantially impairs photosynthesis. Mn-deficiency can cause about 70% loss in the photon-saturated net photosynthetic rate (PN). The loss of PN was associated with a strong decrease in the activity of oxygen evolution complex (OEC) and the linear electron transport driven by photosystem 2 (PS2) in Mn-deficient leaves. See Jiang, C. D., Gao, H. Y. & Zou, Q. Characteristics of photosynthetic apparatus in Mn-starved maize leaves. Photosynthetica 40, 209-213 (2002). Manganese as a cofactor plays a crucial role as catalyst in biosynthesis of lignins and phytoalexins. Lignin serves as a barrier against pathogenic infection, hence manganese deficiency can impair lignin biosynthesis and in turn increase pathogenic attack from soil-born fungi. See Hofrichter, M. Review: Lignin conversion by manganese peroxidase (MnP). Enzyme Microb. Technol. 30, 454-466 (2002).

Manganese can significantly increase plant peroxidases in the leaf apoplast. The highest peroxidase activity was measured when plants were inoculated with Pseudocercospora fuligena along with increase in defense-related proteins in the leaf apoplast but not when treated with high manganese. It was concluded that manganese above the optimum level for plant growth can contribute to the control of Pseudocercospora fuligena in tomato. See Heine, G. et al. Effect of manganese on the resistance of tomato to Pseudocercospora fuligena. J. Plant Nutr. Soil Sci. 174, 827-836 (2011). Latent manganese deficiency substantially increases transpiration and decreases water use efficiency (WUE) of barley plants which causes marked decrease in the epicuticular wax layer. Thus, drought will put additional stress on Mn-deficient plants that are already suffering from disturbances in key metabolic processes. See Hebbern, C. a. et al. Latent manganese deficiency increases transpiration in barley (Hordeum vulgare). Physiol. Plant. 135, 307-316 (2009).

Iron (Fe) is required for life-sustaining processes from respiration to photosynthesis, where it participates in electron transfer through reversible redox reactions, cycling between Fe²⁺ and Fe³⁺. Insufficient iron uptake leads to Fe-deficiency symptoms such as interveinal chlorosis in leaves and reduction of crop yields. See Kim, S. a. & Guerinot, M. Lou. Mining iron: Iron uptake and transport in plants. FEBS Lett. 581, 2273-2280 (2007). Maintaining iron homeostasis is essential for metabolic activities, such as photosynthesis, which is crucial for plant productivity. Maintaining iron homeostasis is also required for biomass production and iron metabolism is also tightly linked to the nutritional quality of plant products. See Briat, J. F., Curie, C. & Gaymard, F. Iron utilization and metabolism in plants. Curr. Opin. Plant Biol. 10, 276-282 (2007).

Iron is found in nature as insoluble oxyhydroxide polymers of the general composition FeOOH. These Fe (III) oxides (e.g. goethite, hematite) are produced by the weathering of rock and are quite stable and not very soluble at a neutral pH. Thus, free Fe (III) in an aerobic, aqueous environment is limited to an equilibrium concentration of approximately 10⁻¹⁷ M, a value far below that required for the optimal growth of plants or microbes. See Guerinot, M. L. & Yi, Y. Iron: Nutritious, Noxious, and Not Readily Available. Plant Physiol. 104, 815-820 (1994). Superoxide and hydrogen peroxide, that are produced in the cells during the reduction of molecular oxygen, are catalyzed by Fe²⁺ and Fe³⁺ to form highly reactive hydroxyl radicals and thus can cause oxidative damage in vivo. It is crucial to regulate iron uptake in plants to avoid excess accumulation. See Halliwell, B. & Gutteridge, J. M. Biologically relevant metal ion-dependent hydroxyl radical generation. An update. FEBS Lett. 307, 108-112 (1992).

Plants have evolved two strategies to uptake iron from the soil. Non-grass plants activate a reduction-based Strategy I when starved for iron whereas grasses activate a chelation-based strategy. In reduction-based Strategy I plants extrude protons into the rhizosphere, lowering the pH of the soil solution and increasing the solubility of Fe³⁺ (Fe³⁺ becomes a 1000-fold more soluble). See Olsen, R. a, Clark, R. B. & Bennett, J. H. The Enhancement of Soil Fertility by Plant Roots: Some plants, often with the help of microorganisms, can chemically modify the soil close to their roots in ways that increase or decrease the absorption of crucial ions. (2013). As a response to Fe-deficiency, grasses release small molecular weight compounds known as the mugineic acid (MA) family of phytosiderophores (PS). PS have high affinity for Fe³⁺ and efficiently bind Fe³⁺ in the rhizosphere. Fe³⁺-PS complexes are then transported into the plant roots via a specific transport system. See Mori, S. Iron acquisition Satoshi Mori. Curr. Opin. Plant Biol. 2, 250-253 (1999).

The discovery in 1975 that nickel (Ni) is a component of the enzyme urease which is present in a wide range of plant species led to the understanding of nickel as an essential micronutrient to plants. See Dixon, N. E., Gazzola, T. C., Blakeley, R. L. & Zermer, B. Letter: Jack bean urease (EC 3.5.1.5). A metalloenzyme. A simple biological role for nickel? J. Am. Chem. Soc. 97, 4131-4133 (1975). Nickel deficiency has a wide range of effects on plant growth and metabolism which includes effects on (a) plant growth, (b) plant senescence, (c) nitrogen metabolism, and (d) iron uptake. See Brown, P. H., Welch, R. M. & Cary, E. E. Nickel: a micronutrient essential for higher plants. Plant Physiol. 85, 801-803 (1987).

Cary et. al. showed nickel deficient soybean plants accumulated toxic concentrations of urea in necrotic lesions on their leaflet tips and also resulted in delayed nodulation as well as reduction of early growth. See Eskew, D. L., Welch, R. M. & Cary, E. E. Nickel: an essential micronutrient for legumes and possibly all higher plants. Science 222, 621-623 (1983). Addition of 1 ppb of nickel to media prevented urea accumulation, necrosis and growth reductions which showed nickel is essential for higher plants.

Wildung et. al. demonstrated nickel uptake by an intact plant and nickel's transfer from root to shoot tissues which was inhibited by the presence of Cu²⁺, Zn²⁺, Fe²⁺, and Co²⁺. See Cataldo, D. a., Garland, T. R., Wildung, R. E. & Drucker, H. Nickel in Plants. Plant Physiol. 62, 566-570 (1978). Nickel deficiency is especially apparent in ureide-transporting woody perennial crops.

Wood et. al. evaluated the concentrations of ureides, amino acids, and organic acids in photosynthetic foliar tissue from Ni-sufficient versus Ni-deficient pecan (Carya illinoinensis [Wangenh.] K. Koch). See Oa, P. F., Bai, C., Reilly, C. C. & Wood, B. W. Nickel Deficiency Disrupts Metabolism of Ureides, Amino Acids, and Organic Acids of Young. 140, 433-443 (2006). These studies showed that foliage of Ni-deficient pecan seedlings exhibited metabolic disruption of nitrogen metabolism via ureide catabolism, amino acid metabolism, and ornithine cycle intermediates. Nickel deficiency also disrupted the citric acid cycle, the second stage of respiration, where Ni-deficient foliage contained very low levels of citrate compared to Ni-sufficient foliage.

The great number of plant species tend to hyper accumulate more than 1 g nickel per kg of dry shoots which is a characteristic of nickel distribution in plant organs. The specific pattern of nickel toxicity is shown by the inhibition of lateral root development which differs from that of other heavy metals, such as Ag, Cd, Pb, Zn, Cu, Tl, Co, and Hg, which blocked root growth at nonlethal concentration without inhibiting root branching. See Seregin, I. V. & Kozhevnikova, a. D. Physiological role of nickel and its toxic effects on higher plants. Russ. J. Plant Physiol. 53, 257-277 (2006). High pH soils are vulnerable to nickel deficiency, additionally excessive use of zinc and copper may induce nickel deficiency in soil because these three elements share a common uptake system in plants.

Copper (Cu) is an essential metal for plants as it plays key roles in photosynthetic and respiratory electron transport chains, in ethylene sensing, cell wall metabolism, oxidative stress protection and biogenesis of molybdenum cofactor. See Yruela, I. Copper in plants: Acquisition, transport and interactions. Funct. Plant Biol. 36, 409-430 (2009); Yruela, I. Copper in plants. Brazilian J. Plant Physiol. 17, 145-156 (2005); Rodriguez, F. I. et al. A copper cofactor for the ethylene receptor ETR1 from Arabidopsis. Science 283, 996-998 (1999); and Kuper, J., Llamas, A., Hecht, H.-J., Mendel, R. R. & Schwarz, G. Structure of the molybdopterin-bound Cnx1G domain links molybdenum and copper metabolism. Nature 430, 803-806 (2004). Copper deficiency can alter essential functions in plant metabolism. Traditionally copper has been used in agriculture as an antifungal agent, and it is also extensively released into the environment by human activities that often cause environmental pollution. Excess copper inhibits plant growth and impairs important cellular processes (i.e., photosynthetic electron transport). Excess copper can become extremely toxic to plants, causing symptoms such as chlorosis and necrosis, stunting, and inhibition of root and shoot growth.

The application of copper-based fungicides is common in conventional agricultural practice for a long time and the use of copper is able to increase crop yields, but in general excessive copper is an issue, thus application of copper-based foliar fertilizer (CFF) may provide a solution to the controlled use of copper. CFF with added zinc in conjunction with controlled release urea can improve soil chemical properties and increase both the plant growth and fruit yield of tomato. See Zhu, Q., Zhang, M. & Ma, Q. Copper-based foliar fertilizer and controlled release urea improved soil chemical properties, plant growth and yield of tomato. Sci. Hortic. (Amsterdam). 143, 109-114 (2012).

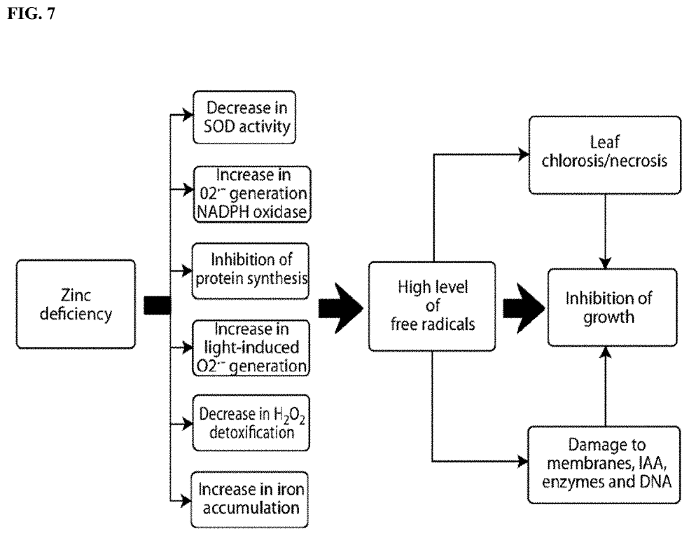

Zinc (Zn) deficiency is a well-documented problem in food crops, causing decreased crop yields and nutritional quality. See Cakmak, I. Enrichment of cereal grains with zinc: Agronomic or genetic biofortification? Plant Soil 302, 1-17 (2008); Cakmak, I. Tansley Review No. 111: Possible roles of zinc in protecting plant cells from damage by reactive oxygen species. New Phytol. 146, 185-205 (2000); and Broadley, M., White, P. & Hammond, J. Zinc in plants. New . . . 677-702 (2007). There are a number of physiological impairments in Zn-deficient cells causing inhibition of the growth, differentiation and development of plants. Increasing evidence indicates that oxidative damage to critical cell compounds resulting from attack by reactive 02 species (ROS) is the basis of disturbances in plant growth caused by zinc deficiency. As shown in FIG. 7, zinc plays a fundamental role in several critical cellular functions such as protein metabolism, gene expression, structural and functional integrity of biomembranes, photosynthetic C metabolism and IAA metabolism.

Zinc is directly or indirectly required for scavenging O2.⁻ and H₂O₂, and thus for blocking generation of the powerful oxidant OH.. Iron accumulation and physiological demand for zinc is substantially high in Zn-deficient cells, particularly at membrane-binding sites for iron. Zinc is particularly needed within the environment of plasma membranes to maintain their structural and functional integrity.

Molybdenum (Mo) is a trace element found in the soil and is required for growth of most biological organisms including plants and animals. See Kaiser, B. N., Gridley, K. L., Brady, J. N., Phillips, T. & Tyerman, S. D. The role of molybdenum in agricultural plant production. Ann. Bot. 96, 745-754 (2005). Plants grown in a nutrient solution without molybdenum developed characteristic phenotypes including mottling lesions on the leaves, and altered leaf morphology where the lamellae became involuted, a phenotype commonly referred to as ‘whiptail’. See Arnon D I, S. P. Molybdenum as an essential element for higher plants. Plant Physiol. 14, 599-602 (1939). The transition element molybdenum is essential for (nearly) all organisms and occurs in more than 40 enzymes catalyzing diverse redox reactions, however, only four of them have been found in plants. Enzymes that require molybdenum for activity include nitrate reductase, xanthine dehydrogenase, aldehyde oxidase and sulfite oxidase. See Mendel, R. R. & Schwarz, G. Molybdoenzymes and molybdenum cofactor in plants. CRC. Crit. Rev. Plant Sci. 18, 33-69 (1999).

Molybdenum deficiencies are primarily associated with poor nitrogen health particularly when nitrate is the predominant nitrogen form available for plant growth. In most plant species, the loss of nitrate reductase (NR) activity is associated with increased tissue nitrate concentrations and a decrease in plant growth and yields. See Unkles, S. E. et al. Nitrate reductase activity is required for nitrate uptake into fungal but not plant cells. J. Biol. Chem. 279, 28182-28186 (2004) and Williams, R. J. P. & Fraústo da Silva, J. J. R. The involvement of molybdenum in life. Biochem. Biophys. Res. Commun. 292, 293-299 (2002). Molybdate which is the predominant form available to plants is required at very low levels where it is known to participate in various redox reactions in plants as part of the pterin complex Moco. Moco is particularly involved in enzymes, which participate directly or indirectly with nitrogen metabolism.

Chlorine in the form of a chloride ion (Cl−) is present and abundant almost everywhere in world and is needed for optimal plant growth, as the micronutrient chloride requirement is up to 1 mg/g of dry matter. See Perry R. Stout, C. M. Johnson, and T. C. B. Chlorine in Plant Nutrition. 1956 (1956) and Perry R. Stout, C. M. Johnson, and T. C. B. Chlorine-A Micronutrient Element For Higher Plants. 526-532 (1954). The dependence of modern agriculture on irrigation and chemical fertilization emphasizes the problem of chloride accumulation in soils and its adverse effect on plants rather than on its deficiency. See Xu, G., Tarchitzky, J. & Kafkafi, U. Advances in chloride nutrition. Advances in Agronomy 68, 97-150 (2000)

Micronutrients mas also comprise rare earth elements such as cerium, dysprosium, erbium, europium, gadolinium, holmium, lanthanum, lutetium, neodymium, praseodymium, promethium, samarium, scandium, terbium, thulium, ytterbium, and yttrium. Lanthanide series of chemical elements (15 elements with Atomic numbers 57-71; i.e., La-Lu) along with scandium (Sc) and Yttrium (Y) are known as rare earth elements. The average abundance of rare earth elements in earth's crust ranges from 66 ppm (Ce) to 0.5 ppm (Tm) and <<0.1 ppm (Pm). The abundance of cerium is comparable to environmentally more studied copper and zinc. See Tyler, G. Rare earth elements in soil and plant systems—A review. 191-206 (2004). Xu et. al studied distribution of rare earth elements in field-grown maize and their application as fertilizer. See Xu, X., Zhu, W., Wang, Z. & Witkamp, G. J. Distributions of rare earths and heavy metals in field-grown maize after application of rare earth-containing fertilizer. Sci. Total Environ. 293, 97-105 (2002). Studies concluded that in China in 2002, 0.23 kg ha⁻¹ y⁻¹ were applied and most mixtures are composed of Lanthanide series elements along with yttrium. In these studies rare earth fertilizer was applied after early stem elongation stage and concentrations of rare earth elements decreased in the order of root, leaf, stem, and grain after application. Concentrations of individual rare earth elements found in fertilizer compositions are listed in Table 10.

TABLE 10

| Element | Concentration |
|---|---|
| | (g kg−1 dry wt.) |
| Y | 0.1 |
| La | 15.4 |
| Ce | 24.1 |
| Pr | 11.8 |
| Nd | 1.1 |
| Sm | 2 |
| Eu | 0.2 |
| Gd | 1.1 |
| | (mg kg−1dry wt.) |
| Tb | 25.8 |
| Dy | 91.6 |
| Ho | 4.3 |
| Er | 26.9 |
| Tm | 1.4 |
| Yb | 5.3 |
| Lu | 0.5 |
| Total LREs | 64.1 |
| Total HREs | 1.2 |
| Total MREs | 3.4 |

Xie et. al. showed that low concentrations of lanthanum (La) could promote rice growth including yield (0.05 mg L⁻¹ to 1.5 mg L⁻¹), dry root weight (0.05 mg L⁻¹ to 0.75 mg L⁻¹) and grain numbers (0.05 mg L⁻¹ to 6 mg L⁻¹). See Xie, Z. B. et al. Effect of Lanthanum on Rice Production, Nutrient Uptake, and Distribution. J. Plant Nutr. 25, 2315-2331 (2002). Lanthanum can regulate plant physiological activities such as enzyme and hormones. Lanthanum can modulate the concentration of various micronutrients, i.e. it increased the concentrations of zinc, phosphorus, manganese, magnesium, iron, copper, and calcium in the root, decreased the concentrations of manganese, magnesium, iron, and calcium in the straw, and iron and calcium in the grain but increased the concentrations of copper in the grain.

Hong et al. showed that Ce³⁺ could obviously stimulate the growth of spinach and increase its chlorophyll contents and photosynthetic rate. See Fashui, H., Ling, W., Xiangxuan, M., Zheng, W. & Guiwen, Z. The effect of cerium (III) on the chlorophyll formation in spinach. Biol. Trace Elem. Res. 89, 263-276 (2002). Ce³⁺ could also improve the PSII formation and enhance its electron transport rate of PSII as well. The Ce³⁺ contents of chloroplast and chlorophyll of the Ce³⁺ treated spinach were higher than that of any other rare earth element and were much higher than that of the control. It was also suggested that Ce³⁺ could enter the chloroplast and bind easily to chlorophyll and might replace magnesium to form Ce-chlorophyll.

Yan et. al. studied effects of spray applications of lanthanum and cerium on yield and quality of Chinese cabbage (Brassica chinensis L) based on different seasons, and showed lanthanum or cerium treatments in spring and autumn increased the growth of Chinese cabbage and the fresh and dry weights of stems and leaves. See Ma, J. J., Ren, Y. J. & Yan, L. Y. Effects of spray application of lanthanum and cerium on yield and quality of Chinese cabbage (Brassica chinensis L) based on different seasons. Biol. Trace Elem. Res. 160, 427-32 (2014). The cerium had more of an effect comparatively than lanthanum. The lanthanum or cerium treatments increased the spring Chinese cabbage's vitamin C content with the lanthanum treatment increasing it, while they decreased the autumn Chinese cabbage's vitamin C content with the cerium treatment decreasing it significantly.

Ayrault et al. studied the effect of europium and calcium on the growth and mineral nutrition of wheat seedlings and found that europium favored the germination and root growth and when combined with calcium it produced more sustained leaf growth. See Shtangeeva, I. & Ayrault, S. Effects of Eu and Ca on yield and mineral nutrition of wheat (Triticum aestivum) seedlings. Environ. Exp. Bot. 59, 49-58 (2007).

### Humate Derivatives

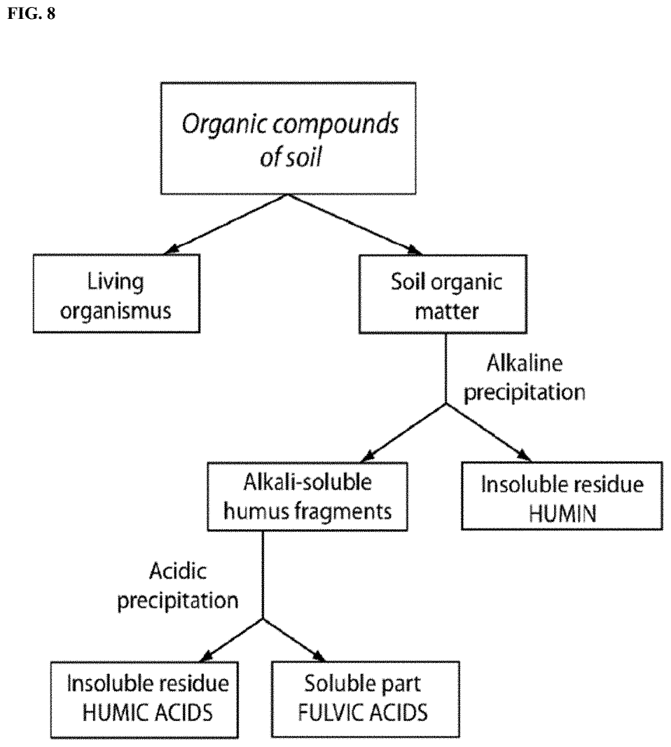

Non-limiting examples of humate derivatives for use with plants comprise fulvic acid, fulvate, humate, humin, humic acids (alkali extracted), and humic acids (nonsynthetic). Fulvic acids are fractions of humates that are soluble at a neutral to acidic pH. FIG. 8 shows the relationship between soil organic matter and humate derivatives. Fulvic acids may be extracted from humates by use of hydrolysis or naturally occurring acids. Humates are derived from leonardite, lignite, or coal. Alkali extracted humic acid are extracted from nonsynthetic humates by hydrolysis suing synthetic or nonsynthetic alkaline materials, including potassium hydroxide and ammonium hydroxide. Nonsynthetic humic acids are naturally occurring deposits of humic acids and water extracted humates.

Humate derivatives play important roles in soil fertility, and are considered to have crucial significance for the stabilization of soil aggregates. Humate derivatives may also be categorized based on solubility as humic acids, fulvic acids, or humin. Humic acids are known to improve productivity and quality of soil, by not only improving the physical properties but also improving the base exchange capacity which is crucial in agriculture. Humate derivatives are commonly used as an additive in fertilizers because they indirectly improve soil quality of soil with low organic matter but also act as chelating agents to make nutrients more bioavailable. See Peña-méndez, M. E., Havel, J. & Patočka, J. Humic substances—compounds of still unknown structure: applications in agriculture, industry, environment, and biomedicine. J. Appl. Biomed. 3, 13-24 (2005) and Mikkelsen, R. L. Humic materials for agriculture. Better Crop. 89, 6-10 (2005).

Physiological effects of humate derivatives on plants are not clearly understood but it is clear that the effect depends on the source, concentration, and molecular weight of the humic fraction. The low molecular size fraction (LMS>3500 Da) easily reaches the plasma lemma of higher plant cells. The humate derivatives positively influenced the uptake of nutrients like nitrate and also may show activity like hormones, but are not clearly understood. See Nardi, S. & Pizzeghello, D. Physiological effects of humic substances on higher plants. Soil Biol. Biochem. 34, 1527-1536 (2002). A presumed humate derivative hormone-like activity is not surprising as it is known that a soil's fertility can be directly correlated with native auxin content. The hormone like activity of humate derivatives was corroborated by results demonstrating the immunological or spectrometric identification of indol acetic acid (IAA) inside several humate derivatives. See Trevisan, S., Francioso, O., Quaggiotti, S. & Nardi, S. Humic substances biological activity at the plant-soil interface: from environmental aspects to molecular factors. Plant Signal. Behav. 5, 635-643 (2010).

In addition, Muscolo et al, demonstrated that a humic fraction caused an increase in carrot cell growth similar to that induced by 2,4 dichlorophenoxyacetic acid (2,4-D) and promoted morphological changes similar to those induced by IAA. See Muscolo, a., Sidari, M., Francioso, O., Tugnoli, V. & Nardi, S. The auxin-like activity of humate derivatives is related to membrane interactions in carrot cell cultures. J. Chem. Ecol. 33, 115-129 (2007). Dobbss et. al. demonstrated that various characterized humic acids need the auxin transduction pathway to be active using Arabidopsis and tomato seedlings. See Dobbss, L. B. et al. Changes in root development of Arabidopsis promoted by organic matter from oxisols. Ann. Appl. Biol. 151, 199-211 (2007). Dobbss et. al. concluded that humic acids may act as a “buffer”, either absorbing or releasing signaling molecules, according to modifications in the rhizosphere. Results of the application of humate derivatives to plants include an increase in yield. See Waqas, M. et al. Evaluation of Humic Acid Application Methods for Yield and Yield Components of Mungbean. 2269-2276 (2014).

### Chelating Agents

Chelating agents, also known as chelants or chelates, complexing, or sequestering agents, are compounds that are able to form stable complexes with metal ions to increase their bioavailability to plants. Chelating agents achieve this by coordinating with metal ions at a minimum of two sites, thus solubilizing and inactivating the metal ions that would otherwise produce adverse effects in the system on which they are used. Chelates find uses in a variety of agricultural crops and their applications vary from fertilizer additives and seed dressing to foliar sprays and hydroponics. See Clemens, D. F., Whitehurst, B. M. & Whitehurst, G. B. Chelates in agriculture. Fertil. Res. 25, 127-131 (1990). Synthetic metal chelates appear as a stop-gap measure for micronutrient problems. See Brown, J. C. Metal chelation in soils—a symposium. 6-8.

Characteristics of acceptable chelates include, but are not limited to: a) the metal (e.g., Fe, Zn, Mn, Cu) is not easily substituted by other metals in the chelate ring; b) stability against hydrolysis; c) inability to be decomposed by soil microorganisms (i.e., balance is required since there is a need for biodegradable chelation agents); d) soluble in water; e) bioavailable to the plant either at the root surface or another location in the plant; f) non-toxic to plants; and g) able to be easily applied through soil or as a foliar application.

Aminopolycarboxylates represent the most widely consumed chelating agents, and the percentage of new readily biodegradable products in this category continues to grow. EDTA (Ethylenediaminetetraacetic acid) is one of the most common synthetic chelating agents and is used for both soil and foliar applied nutrients. DTPA (Diethylene triamine pentaacetic acid) is used mainly for chelates applied to alkaline soils. Iron chelates made with HEDTA (N-(2-Hydroxyethyl)ethylenediamine-N,N′,N′-triacetic acid) and EDDHA (ethylenediamine-N,N′-bis(2-hydroxyphenylacetic acid) are the most effective iron fertilizers on high pH soils. Nitrilotriacetic acid (NTA), ethylenediaminedisuccinic acid (EDDS), and iminodisuccinic acid (IDS) are the most commonly suggested to replace the nonbiodegradable chelating agents. See Pinto, I. S. S., Neto, I. F. F. & Soares, H. M. V. M. Biodegradable chelating agents for industrial, domestic, and agricultural applications—a review. Environ. Sci. Pollut. Res. 1-14 (2014). doi:10.1007/s11356-014-2592-6.

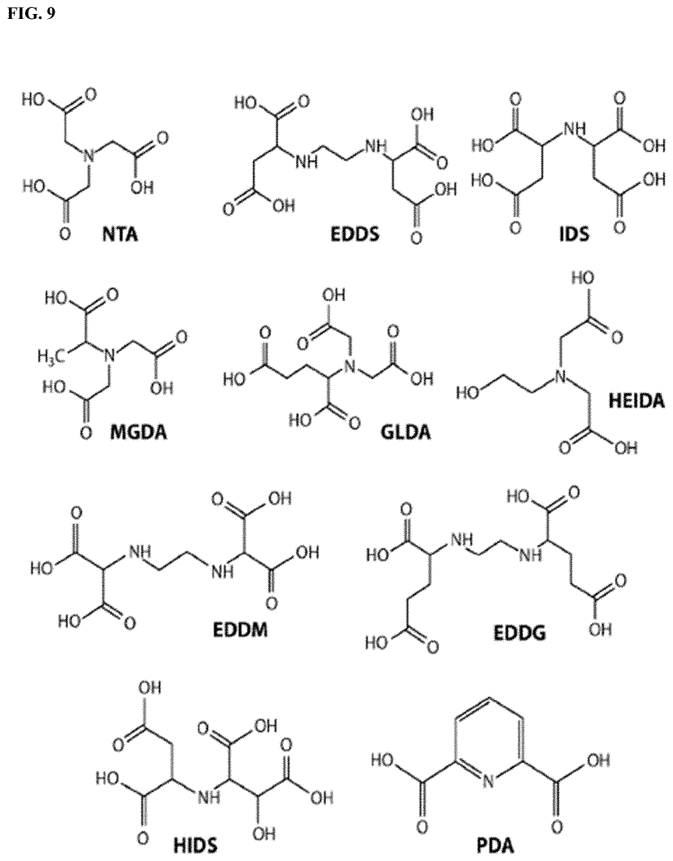

FIG. 9 shows the molecular structure of various biodegradable chelating agents.

Table 11 shows protonation and overall stability constants of a variety of chelation agents. See Pinto, I. S. S., Neto, I. F. F. & Soares, H. M. V. M. Biodegradable chelating agents for industrial, domestic, and agricultural applications—a review. Environ. Sci. Pollut. Res. 1-14 (2014). doi:10.1007/s11356-014-2592-6.

TABLE 11

| | Reaction | EDTA | NTA | EDDS | IDS | MGDA | GLDA | EDDG | EDDM | HIDS | HEIDA | PDA |
|---|---|---|---|---|---|---|---|---|---|---|---|---|
| H⁺ | H + L ↔ HL | 9.5 | 9.5 | 10.1 | 10 | 9.9 | 9.4 | 9.5 | 9.7 | 9.6d | 8.7 | 4.7 |
| | 2H + L ↔ H2L | 15.6 | 12 | 17 | 14.2 | 12.4 | 14.4 | 16.3 | 16.3 | 13.7 | 10.9 | 6.7 |
| | 3H + L ↔ H3L | 18.3 | 13.8 | 20.8 | 17.5 | 13.9 | 17.9 | 20.5 | 19 | 16.8 | 12.5 | |
| | 4H + L ↔ H4L | 20.3 | 15 | 23.9 | 19.4 | | 20.4 | 3.3 | 21.1 | 18.9 | | |
| | 5H + L ↔ H5L | 21.8 | | 25.3 | | | | | | 20.5 | | |
| Fe³⁺ | M + L ↔ ML | 25.1 | 16 | 20.1 | 13.9 | 16.5 | 15.2 | 15.7 | | 15 | 11.6 | 10.9 |
| | M + 2L ↔ ML2 | | 24 | | | | | | | | | 17.1 |
| | M + H + L ↔ MHL | 26.4 | 17 | | 17.8 | | 19.4 | | | 18.4 | 13.9 | |
| | M + L ↔ M (OH)L + H+ | 17.7 | 11.6 | 12.2 | 8.6 | | −3.3 | | | 10 | 9.2 | |
| Mn²⁺ | M + L ↔ ML | 13.9 | 7.3 | 9 | 7.3 | 8.4 | 7.6 | 6.7 | 8.4 | 6.8 | 5.5 | 5 |
| | M + 2L ↔ ML2 | | 10.4 | | | | | | | | 9 | 8.5 |
| | M + H + L ↔ MHL | 17 | | 13.7 | | | | | | | | |
| | M + L ↔ M (OH)L + H+ | | | | −4 | | | | | −3.3 | | |
| Cu²⁺ | M + L ↔ ML | 18.8 | 12.7 | 18.7 | 12.9 | 13.9 | 13 | 15.5 | 15.9 | 12.6 | 11.8 | 9.1 |
| | M + 2L ↔ ML2 | | 17.4 | | | | | | | | 15.8 | 16.4 |
| | M + H+30L ↔ MHL | 21.9 | 14.3 | 25 | 17.3 | | 17.2 | | | 16.2 | | |
| | M + L ↔ M (OH)L + H+ | 7.4 | 3.5 | 7.6 | 2.5 | | 3.1 | | | 3.7 | 3.1 | 1.6 |
| Pb²⁺ | M + L ↔ ML | 18 | 11.5 | 12.7 | 9.8 | 12.1 | 11.6 | 8.5 | 11.1 | 10.2 | 9.4 | 8.7 |
| | M + 2L ↔ ML2 | | | | | | | | | | | 11.6 |
| | M + H + L ↔ MHL | 20.8 | 15 | 16 | | | 16.3 | 14.4 | 15.3 | 14.3 | 12.2 | |
| | M + L ↔ M (OH)L + H+ | | | | | | 1 | | | | 1.2 | |
| Cd²⁺ | M + L ↔ ML | 16.5 | 9.8 | 10.9 | 8.3 | 10.6 | 10.3 | 8.8 | | 7.6 | 7.4 | 6.4 |
| | M + 2L ↔ ML2 | | 14.5 | | | | | | | | 12.4 | 10.9 |
| | M + H + L ↔ MHL | 19.4 | | 14.6 | 13 | | 15 | | | 12.7 | 8.8 | |
| | M + L ↔ M (OH)L + H+ | 3.3 | −1.5 | | | | 0.1 | | | −2.6 | | |
| Zn²⁺ | M + L ↔ ML | 16.5 | 10.4 | 13.6 | 10.2 | 10.9 | 11.5 | 10.2 | 11.1 | 9.8 | 8.4 | 6.4 |
| | M + 2L ↔ ML2 | | 14.2 | | | | | | | | 12 | 10.9 |
| | M + H + L ↔ MHL | 19.5 | | 17.3 | 14.6 | | 16.1 | | | 13.7 | | |
| | M + L ↔ M (OH)L + H+ | 4.9 | 0.3 | 2.3 | −1.1 | | 0.9 | | | 0.8 | −1.1 | |
| Ca²⁺ | M + L ↔ ML | 10.7 | 6.3 | 4.6 | 4.3 | 7 | 5.9 | 2.6 | 5.4 | 4.8 | 4.7 | 4.4 |
| | M + 2L ↔ ML2 | | 8.8 | | | | | | | | | 7.4 |
| | M + H + L ↔ MHL | 12.8 | | 11.5 | | | | 3.6 | 11.7 | | | |
| | M + L ↔ M (OH)L + H+ | | | | | | | | | | | |
| Mg²⁺ | M + L ↔ ML | 8.8 | 5.5 | 6 | 5.5 | 5.8 | 5.2 | 3 | 4.9 | | 3.4 | 2.3 |
| | M + 2L ↔ ML2 | | | | | | | | | | | 3 |
| | M + H + L ↔ MHL | 12.8 | | 11.9 | | | | 4.3 | 11.5 | | | |
| | M + L ↔ M (OH)L + H+ | | | | | | | | | | | |

### Cation Exchange Capacity (CEC)

In some embodiments, the microalgae based composition may increase the CEC of soils and the availability of cations. CEC is based on dry soil, humates, fulvates, and any organic matter with a charge that can be quantitatively related to weight. The increase may be a result of activity by microalgae or the increase of organic matter as the microalgae degrade after application to the soil. The increase in organic matter from the microalgae may provide more nutrients to plant roots (i.e., increase the absorption of plant nutrients). CEC of soils is principally a function of clay colloids and degraded organic matter, with the organic matter supplying more negative CEC sites. The retention of cations on the CEC sites in soil and organic matter may hold cation nutrients including Ca, Mg, and K that become available to plant roots.

### Examples

Embodiments of the invention are exemplified and additional embodiments are disclosed in further detail in the following examples, which are not in any way intended to limit the scope of any aspect of the invention described herein. The strain of Chlorella used in the following examples provides an exemplary embodiment of the invention but is not intended to limit the invention to a particular strain of microalgae. Analysis of the DNA sequence of the exemplary strain of Chlorella in the NCBI 18s rDNA reference database at the Culture Collection of Algae at the University of Cologne (CCAC) showed substantial similarity (i.e., greater than 95%) with multiple known strains of Chlorella and Micractinium. Those of skill in the art will recognize that Chlorella and Micractinium appear closely related in many taxonomic classification trees for microalgae, and strains and species may be re-classified from time to time. While the exemplary microalgae strain is referred to in the instant specification as Chlorella, it is recognized that microalgae strains in related taxonomic classifications with similar characteristics to the exemplary microalgae strain would reasonably be expected to produce similar results.

### Example 1

A recommended addition of fertilizer for soil in Gilbert, Ariz. for growing plants to be supplemented with a microalgae based composition would be calculated based on the Nitrogen, Phosphorus, and Potassium content of the fertilizer, content of the soil, and demand of the plants (e.g., crops). When not using soil to determine plant yields, lower rates of plant nutrients may be used. The low yield target would be 180 cwt/acre=18,000 pounds (lb) per acre. Fertilizer 12-8-16 (% of N-P-K) should be applied at a rate of 1,000 lb/acre.

The Nitrogen target would be 140 lb/acre. The Nitrogen equates to 12% of the 1,000 lb of fertilizer, therefore equating to 120 lb of N/acre. The Nitrate form of Nitrogen equates to about 19 lb/acre. A soil test average would be equal to 78 ppm N, and 4 lb. equals 1 ppm for 1 acre at 1 foot deep; therefore 78 ppm/4 pm equals 19 lb. N per acre-foot. The Nitrogen supplied at 120 lb/acre plus the soil Nitrogen at 19 lb/acre-foot, equals 139 lb/acre of total nitrogen.

Soil pH is typically over 8.0 and Phosphorus is most available to plant roots at a pH of 6.5. The minimum demand of soil Phosphorus is about 14 ppm. The Phosphorus equates to 8% of the 1,000 lb of fertilizer, therefore equating to 80 lb of P/acre. The Phosphorus is in the form of P₂O₅, which is about 43.6% Phosphorus. Therefore 80 lb of P₂O₅ equates to 34.88 lb of Phosphorus supplied by 1,000 lb of fertilizer. This adds 8.7 ppm of Phosphorus to the soil per acre at 1 foot deep. Soil tests typically indicate an average of 8 ppm, and thus the total ppm of Phosphorus supplied to the plant is 17 ppm.

Potassium is tied up on the clay colloids so more Potassium is better for the plants. The minimum crop demand for Potassium is 200 ppm. The Potassium equates to 16% of the 1,000 lb of fertilizer, and therefore equates to 160 lb/acre. The K₂O form of Potassium contains 85% Potassium, and thus equates to 132.8 lb of Potassium/acre at 1 foot deep when 1,000 lb/acre of fertilizer is applied. Potassium is supplied at 33 ppm/acre plus the average of 240 pm of Potassium in the soil, for a total of 273 ppm Potassium per acre.

The calculation of the application of 1,000 lb/acre into ounces per cubic yard would entail the following: 1 acre=43,560 sq ft and at a 1 foot depth contains 43,560 cubic feet of soil; 1 acre-1 foot deep weights about 4,000,000 lb; 1,000 lb of 12-8-16 fertilizer applied to 1 acre=16,000 weight ounces per 43,560 cubic feet or 0.37 weight ounces per cubic ft that weights 92 lb (4,000,000 lb/43,560 cubic feet). The fertilizer may be applied at 1,500 lb or even 2,000 lb per acre, so rounding up to 0.4 weight ounces of 12-8-16 fertilizer per 92 lb of soil equates to 10.85 oz of fertilizer per cubic yard. The recommendation is to apply 1 lb of 12-8-16 fertilizer per cubic yard.

### Example 2

Microalgae based composition optimum and phytotoxic concentrations when applied to plants growing in a defined agricultural soil can be determined. Planting seeds and seedlings of selected crops in an agricultural soil treated with a microalgae based composition at various concentrations can be a rapid method of estimating the optimum and phytotoxic rates, or if the microalgae based composition is phytotoxic at all. The microalgae based composition can have an optimum rate for plant growth when applied at rates in agricultural soil in containers that approximate the rates applied in the field as an in-furrow application, and that the microalgae base compositions may be toxic or reduce growth of plants when applied at high rates.

An Arizona soil that has a history of crop production can be collected in quantities that can be used as a growing medium in greenhouse studies. The soil can be tested using standard soil test procedures and amended, if necessary, to reflect common practices used to improve soils. The soil can then be placed in plastic pots with square tops (e.g., tops measuring about 3.5 inches and 5.25 inches deep). The total volume of each container can be approximately 64.3 cubic inches. The pots can be filled with soil up to within 1 inch of the top to equal an approximate volume of 52 cubic inches (approximately 3.4 lbs).

Pepper seeds can be tested, then small holes about ⅕th to ¼th inch deep can be made in the soil in the center of the container, then seeded and covered with soil. Seeding depth can be dependent on the crop seed. Seedling can also be used as test plants.

Assuming that in-furrow applications to the seed row would be at row centers of 30 inches, the total row length is 17,424 feet. If the band of application is approximately 1 inch then the total area treated is 1,452 sq. ft. The treated area can be double or more, but 1,452 sq. ft provides a base starting point. The water moves the microalgae based composition into the soil and the roots ultimately encounters treated soil. The base target rate is about 1 gallon of microalgae based composition per 1,452 sq. ft. The area of the soil surface in the containers is about 12.25 sq. inches. One square foot equals 144 sq. inches. Therefore the treatment rate is about 12.25 sq. inches divided by 144 sq. inches=0.085.

One gallon=128 fl. oz. So, 128 fl. oz. per acre divided by 1452 sq. ft.=0.088 fl. oz. per square foot, and 0.088 fl. oz.=2.6 mL. 2.6 mL×0.085 (conversion from 1 sq. ft. to 12.25 sq. inches)=0.22 mL. per container to =1 gallon per acre (GPA). Table 12 displays the equivalent amount of the microalgae based composition per container treatments for the given application rates. Tap water or any other form of water (e.g., reverse osmosis water) can be used as the diluent.

TABLE 12

| Treat- | | Calculation of |
|---|---|---|
| ment | Application | microalgae based composition |
| No. | Rate | in container for application |
| 1. | 1 GPA | Dilute 2.2 mL in 500 mL, and deliver |
| | | 50 mL per pot surface after |
| | | seeding = 0.22 mL/container |
| 2. | 2 quarts/ | Dilute 1.1 mL in 500 mL water and |
| | acre | deliver 50 mL per container |
| 3. | 2 GPA | 1452 sq. ft. requires 4.4 mL per 500 mL- |
| | (in-furrow) | deliver 50 mL per container |
| 4. | 4 GPA | dilute 8.8 mL per 500 mL and deliver |
| | | 50 mL per container |
| 5. | 8 GPA | dilute 17.6 mL per 500 mL and deliver |
| | | 50 mL per container |
| 6. | 16 GPA | dilute 35.2 mL per 500 mL and deliver |
| | | 50 mL per container |

A pot with no microalgae based composition treatment (i.e., 0 GPA) can serve as the control. The treatments can be replicated as needed to build a statistically significant sample set (e.g., 8 replicates, 10 replicates). Treatments of 4, 8, and 16 GPA may not be economical for application to plants, but can aid in measuring the potential phytotoxicity of the microalgae based composition. The total pounds of soil needed is approximately 3.4 lbs multiplied by the number of total treatment replicates. Each container can contain a rate marker and the containers can be randomized on a surface. Water can be applied as needed to reflect an irrigation system (e.g., pivot, flood, drip).

### Example 3

The effects of a microalgae based composition comprised with organic acids (e.g., acetic acid), acetates, or a combination of both, and the optimal concentration of acetate in a microalgae based composition that result in plant growth and ultimate yield responses can be determined. Acetic acid and acetates can be found in many plant nutrient formulations. Zinc, potassium, ammonium, and other acetates can also be applied to plants to increase yield, nutrient uptake, or both.

Particularly, field trials with zinc ammonium acetate and potassium can increase crop yield and uptake of plant nutrients. Applications can be made with very low concentrations of acetate. Such rates can be in the range of 350 mL/m². Rates that give positive results can be up to 100 times less (e.g., in the range of 3.5 mL/m²). When only a few roots receive acetic acid or acetate there was an increase in root growth, and that when all roots received the acetic acid root growth was inhibited.

Physiological studies show that organic acids applied to cells demonstrated disruption of cytoplasmic membranes and increased cell leakage. Acetic acid was shown to be less damaging to cytoplasmic membranes than longer chained organic acids. Again, the rates were very high compared to rates applied to plants.

A microalgae based composition can comprise acetate, at least when the pH is above 5.5. Many soils in the desert and temperate regions have pH values greater than 5.5. Also, ammonium acetate can be used in soil testing to extract plant nutrients and determine the available concentration in soils.

Pepper plants can be used for bioassay of various rates of the microalgae based composition containing acetates when compared to equal concentrations of acetates applied alone. For instance, at a given rate of the microalgae based composition the acetate content can be compared to an equal concentration of acetate. These experiments can be performed in a greenhouse with rate curve studies and phytotoxicity determinations.

Additionally, pepper plants can also be used the bioassay for the concentration of acetic acid in a microalgae based composition by increasing or decreasing the acetic acid concentration accordingly. Verification of the optimum activity of the microalgae based composition can be compared to equal quantities of acetic acid and/or acetates.

Cell leakage (i.e., cytoplasmic membrane stability) can be determined by growing plants in test tubes, subjecting the plants to a series of concentrations of the microalgae based composition and acetates, and measuring the electrical conductivity and leakage of indole acetic acid (IAA) using Salkowski's solution

### Example 4

Optimal rates of applying a microalgae based composition to seeds in an in-furrow application can be determined. Optimum rates of application can be estimated by seeding trays with various crop seeds and measuring the radicle growth and germination. Cafeteria trays can be used for the assay. Various concentrations of a microalgae based composition can be seeded over saturated paper towels and radicle growth can be determined after 7 to 14 days (depending on the type of seed tested).

Many crops are seeded or transplanted in rows on 30 inch centers. One acre is 43,560 sq. ft. and rows on 2.5 ft. centers (30 inches) would be equal to 17,424 linear feet of row. If the applications are approximated at covering about one inch of the bottom of the seed furrow then the total area covered by the application is 1,452 sq. ft. This can be achieved through the practice of diluting the microalgae based composition in a total of 10 gallons of solution of which a portion can be a humate/fulvate product plus micronutrients such as zinc and boron or a pound of a soluble starter fertilizer such as 9-45-15 (N-P-K). For instance, one gallon of a microalgae based composition can be mixed with 5 gallons of liquid humate/fulvate and water to achieve an application rate of 10 gallons per acre. The procedure can vary based on the available farm equipment.

Paper towels can be placed on a tray such that 100 mL of solution supersaturates the towels. The towels can be distributed evenly over the tray. The number of towels can be adjusted to obtain super saturation when 100 mL of solution is added. At least 20 crop seeds can be evenly distributed on the saturated towels. A tray can be placed over the top and weights (e.g., a bottle of water) can be placed on each corner and in the middle to obtain a good seal. Towels can be adjusted so that no portions are exposed to the outside environment. Towels placed over the outside of the tray seams can cause wicking and loss of solution. Table 13 outlines the treatments that can be applied.

TABLE 13

| Microalgae based | Tap | Approx. In- |
|---|---|---|
| composition, mL | Water, mL | Furrow Rate |
| 0 | 100 | 0 |
| 5 | 95 | 2 quarts |
| 7.5 | 92.5 | 3 quarts |
| 10 | 90 | 4 quarts |
| 20 | 80 | 8 quarts |
| Neat, 100 mL | 0 | Neat |

Each seed can be considered a replication such that each tray is a treatment, based on the idea that the seeds are variable and that the treatment system is not be a variable. Metrics used to determine the outcome of the experiment can include the percent germination, radicle length, and average radicle length. Radicles can also be weighed.

### Example 5

The rates of a microalgae based composition that will consistently increase plant yield when applied in agricultural applications can be determined. Such trials can begin with small scale trials in the laboratory and greenhouse to determine the range of rates that increase plant growth. The trials can progress through the locations of a laboratory, greenhouse, small plot trials, strip trials, and commercial field trials. A focus of the trials can be to determine cation exchange capacity, chelation, complexation, plant hormone bioassays, activity against insects and plant pathogens, and induction of the systemic diseases resistance.

A microalgae based composition can be delivered for soil applications by in-furrow treatments, side-dress delivery two inches deep by two inches to the side along rows, drip irrigation, pivot irrigation, or flood irrigation. Foliar applications can also be applied by similar pivot irrigation, or spray systems.

For greenhouse trials, the microalgae base composition can be used to treat seeds and plants in field soil at different rates. Transplants and seeds of a variety of plants can be used as test plants. The greenhouse trials can determine the rate curves for treated plants (growth and nutrient uptake), phytotoxicity effects on treated plants (growth and symptoms), microbial activity, and the effect of pasteurization. Microbial activity can be determined by comparing the application of autoclaved microalgae based composition to non-autoclaved microalgae based compositions. In the alternative, filter sterilization (e.g., 0.45 micron filter) can be used in place of autoclaving to reduce the potential effect on plant hormones and other organic molecules. Also, if the microalgae based composition has a high concentration of solids the solution can be pre-filtered or centrifuged to reduce the quantity of large particles. The effect of pasteurization can be determined by comparing pasteurized compositions to unpasteurized compositions. Compatibility trials of the microalgae based composition with fertilizers, pesticides (e.g., insecticides, fungicides), and other additives that a grower can use would also be tested as part of the seed/seedling germination and small plant trials in a greenhouse.

Field trails can be conducted using rates guided by the results of the greenhouse trials. Examples of rates to be tested include 1, 2, 4, and 8 quarts of the microalgae based composition per acre as applied in-furrow, side-dressed, and via drip irrigation.

In vitro determination of direct activity against soil-borne pathogens can also be performed. Examples of pathogens for such trials include Oomycete pathogens (e.g., Phytophthora capsici, Phythium aphanidermatum), and Bacidiomycetes and Ascomycetes (e.g., Rhizoctonia solani, Fusarium oxysporum). Oomycetes can be controlled by fungicides such as mefenoxam and phosphoric acid, however, such fungicides do not have activity against basidiomycetes (basidiomycota) and ascomycetes (ascomycota). Other examples of fungicide specificity include triazoles or azoles which are not active against Oomycetes. Some fungicides, such as mancozeb, chlorothalonil (2 contact fungicides), and some strobilurins, have activity against multiple groups of pathogens.

Small lab trials and analytical tests can include analysis of the microalgae based compositions, analysis of the plant changes from the application of the compositions, seed germination assays, and determination of surface tension reduction. Analysis of the compositions can include determination of selected plant growth promoting bacteria, indole acetic acid (IAA), and other actives. Bioassays (e.g., bioassays for cytokinins) can be used in addition to concentrations in the composition in order to comprehensively reflect activity in the composition. Examples of plant changes from the application of the microalgae based compositions can include nutrient acquisition, induction of resistance, phytoalexin production, and root excretion of IAA (test tube assay). Acetate sheets can be used to compare the microalgae based compositions with water and standard non-ionic surfactants. The surfactants can also be monitored to determine any effect on control or suppression of pathogens.

Non-limiting examples of microalgae based compositions to test can include microalgae combined with: potassium hydroxide (KOH) with and without pasteurization; folic acid; acetic acid; rare earth elements (e.g., Hydromax); vitamin B-1; and natural chelating agents. The ability for a microalgae based composition to chelate nutrients, complex nutrients, or a combination of both can be tested by determining the stability or association constants with the fourteen essential nutrients. Additionally, cation exchange capacity can also elucidate chelation and complexation characteristics.

When conducting the described trials, a variety of soils can be used including soils with high clay and sand content, low clay and sand content, and soils including gypsum. A complete nutrient analysis of the microalgae based composition including aluminum, silicon, sodium, chlorine, nickel, cobalt, vanadium, molybdenum, cerium, and lanthanum, can be used to determine application rates and analyze the effects on plants.

Determination of anti-microbial activity from the application of the microalgae based composition to plants can be determined. The microalgae based composition may contain surfactants that destroy zoospores and other fungal structures. It is known that most nonionic surfactants have activity against zoospores of Oomycetes (e.g., Phythium, Phytophthora), and downy mildews (e.g., Peronosporaceae). Zoospores do not have cell walls and the outer membranes are subject to destruction by nonionic surfactants including those that are naturally produced and synthetic surfactants. Rhamnolipids produced by the bacterium Pseudomonas aeruginosa have been shown to destroy zoospores.

The microalgae based composition is a complexing and chelating agent which may increase the availability of plant nutrients when applied to the soil. The microalgae based composition produces chelating agents that may tie up iron and other metals that are needed by plant pathogenic fungi and bacteria. Some antibiotics are known to have strong chelation activity as part of the mode of action. A reduction of attack or infection by the bacterium causing fire blight can be decreased by chelation of iron on plant surfaces. Chelation of iron and other essential elements needed by fungi and bacteria may also reduce ice nucleation and decrease the temperature at which crop plants freeze.

### Example 6

Plant trials can be run where a microalgae based composition is applied to plants in combination with a fungicide to determine the effect of a combination application to plants, and compared to the application of the fungicide be itself and the microalgae based composition by itself. One example of a fungicide to use is Tilt, a commercially available fungicide from Syngenta (3411 Silverside Road, Suite 100, Shipley Building, Concord Plaza, Wilmington, Del. 19810). Tilt comprises 3.6 lb of propiconazole per gallon, and one gallon weighs 8.6 lb, resulting in a concentration of 41.8% propiconazole (or 418 cc [grams] of propiconazole per liter). One non-limiting example of a dilution for the application of Tilt would comprise 1 mL of Tilt per liter of water, equal to 0.418 grams/L or 418 mg/L or 418 ppm. A dilution of 0.25 mL of Tilt per liter of water equate to 104.5 mg/L or 104.5 ppm. 250 ml of the 104.5 ppm dilution would be poured into 750 mL of agar medium, resulting in 26.1 ppm concentration of propiconazole.

### Example 7

A microalgae based composition (i.e., PhycoTerra™) obtained from Heliae Development, LLC (Gilbert Ariz.) comprising water, whole Chlorella cells, potassium sorbate, and phosphoric acid was applied to bermuda grass on a golf course located Buckeye, Ariz. The Chlorella was grown in non-axenic mixotrophic conditions and the harvested Chlorella cells were subjected to a pasteurization process for stabilization, but not a drying process. The microalgae based composition was applied in combination with humate derivate products. Results showed that root development on newly sprigged bermuda grass was double in the areas that were treated with the microalgae based composition over the non-microalgae treated areas after only eight days. Water use in the treated areas was also reduced approximately 20% compared to the non-microalgae treated areas. The treated areas were also being double cut by the golf course staff after 8 days, which normally is instituted at a later time.

### Example 8

A microalgae based composition (i.e., PhycoTerra™) obtained from Heliae Development, LLC (Gilbert Ariz.) comprising water, whole Chlorella cells, potassium sorbate, and phosphoric acid was applied to bell peppers in Yuma, Ariz. during the summer. The Chlorella was grown in non-axenic mixotrophic conditions and the harvested Chlorella cells were subjected to a pasteurization process for stabilization, but not a drying process. The bell peppers also received high than normal rates of nitrogen, potassium, zinc, and boron. The microalgae based composition was applied in a single application at a rate of 1 gallon per acre through a drip irrigation line over 20 acres. Results showed an average of 0.75 more fruit per plant and more foliar growth on the treated plants as compared to the untreated plants.

### Example 9

The effects of a microalgae based composition on turf grass can be determined by timing the application of the microalgae based composition with the watering regime. On the first day of a turf trial (i.e., after new turf is installed) the fertilizer can be applied before the water is turned on. The water schedule can be 5 minutes per station every 30 minutes for the first five days. The microalgae based composition can also be applied at this time. Once the turf grass is established (about 5 days), the amount of watering can decrease to a schedule of once per day or a few times a week.

### Example 10

A microalgae base composition can be tested to determine if the composition comprises methylotrophs or Methylobacterium. The test includes spreading the microalgae base composition evenly on water agar. Enough of the composition is spread to obtain good coverage of the surface, but not so much that it masks the growth of Methylobacterium CFU's, and can be achieved by spreading 100 micro-liters per 9 cm diameter petri dish. Next 0.5% methanol can be added to the surface at about the same rate and incubated at room temperature. After 1 to 2 weeks, the sample can be inspected for pink, orange, and yellow symmetrical mucoid CFUs to demonstrate the presence of methylotrophs or Methylobacterium.

### Example 11

Experiments were conducted to determine the effect of a microalgae based composition on the growth and quality of putting green and fairway turf at a golf course located in Trilogy, Ariz. The treatments included an untreated control, the Chlorella based commercial product PhycoTerra™ (Heliae Development, LLC, Gilbert, Ariz. USA), a combination of PhycoTerra and 6% iron, a chemical treatment mimicking the profile of PhycoTerra (“Mock”), a combination of Mock and 6% iron, and a commercially available seaweed extract product. The PhycoTerra product included 10% solids of whole pasteurized Chlorella cells, potassium sorbate, and phosphoric acid. The Chlorella was grown mixotrophically in non-axenic conditions utilizing a supply of acetic acid as the organic carbon feedstock. The Mock treatment comprised 1.5% Chlorella lipids, 8.5% of protein and carbohydrates, 128 ppb of Abscisic acid (ABA), 3.3 ppb of trans-ABA, 2.8 ppb of trans-zeatin-O-glucoside (ZOG), 8.6 ppb of trans zeatin (Z), 16.4 ppb of cis-Z, 1.6 ppb of trans-zeatin riboside (ZR), 42.5 ppb of cix-ZR, 9.8 ppb of isopentenyladenine (iP), 4.1 ppb of isopentenyladenine riboside (iPR), and 86.3 ppb of indole acetic acid (IAA).

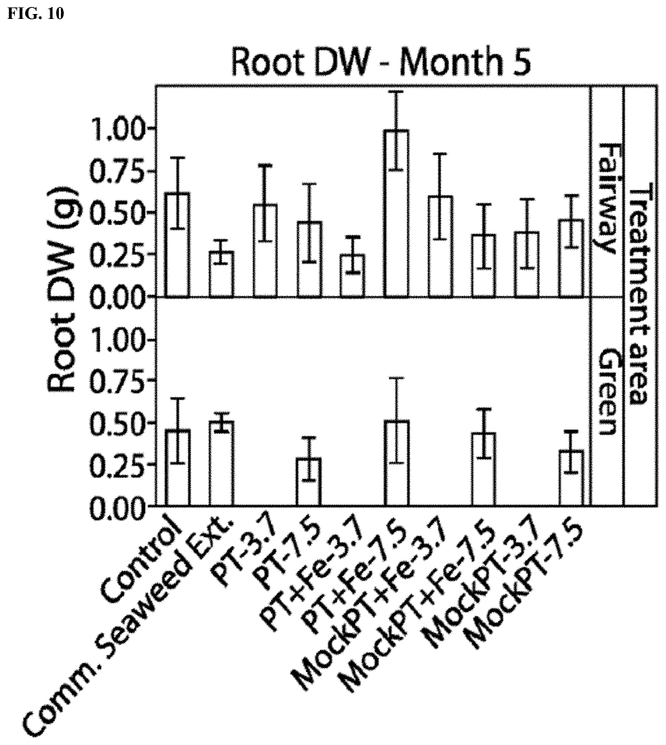

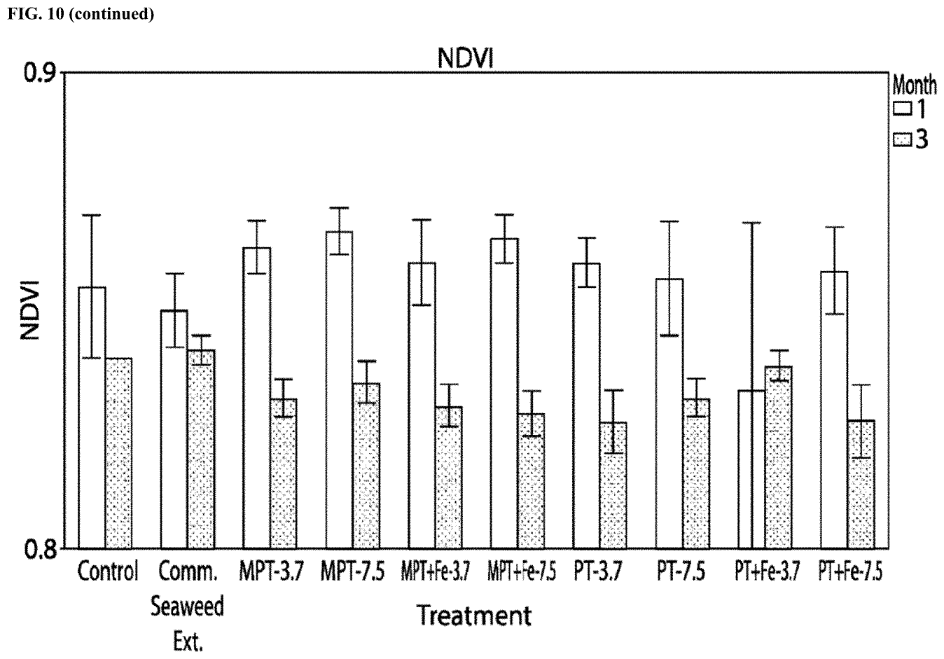

On the putting green, 10 foot by 10 foot areas of Bermuda grass was sectioned in a grid for the application of the treatments. In the fairway, a grid of 4 foot by 4 foot areas of Bermuda grass was sectioned in a grid for the application of the treatments. The treatments were applied using a backpack sprayer. The treatments can be applied in addition to standard practice for fertilization, pest control, insect control, etc., at rates of 3.7 and 7.5 Liters/acre. Results are shown in FIG. 10.

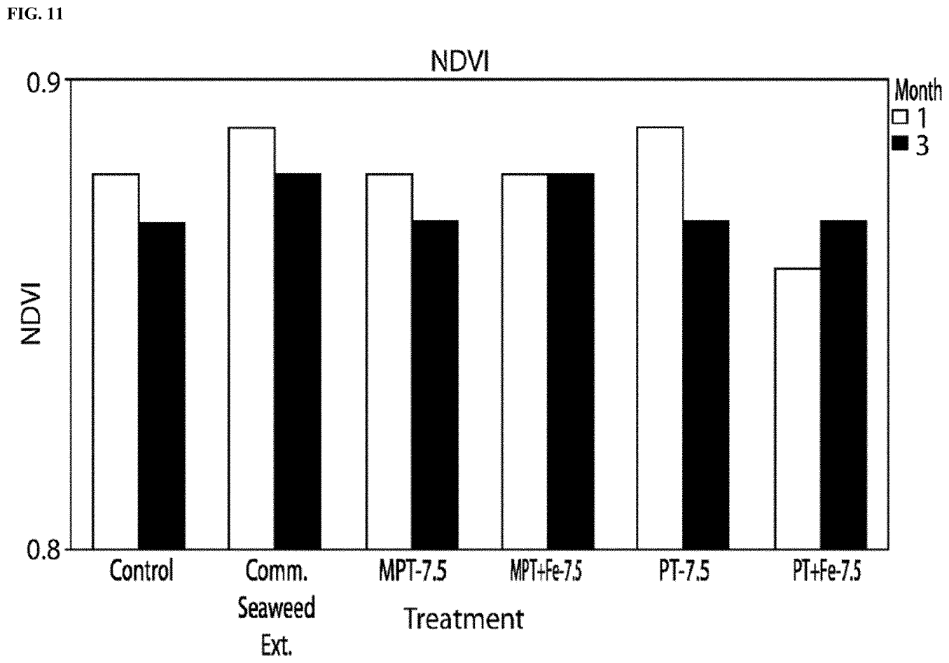

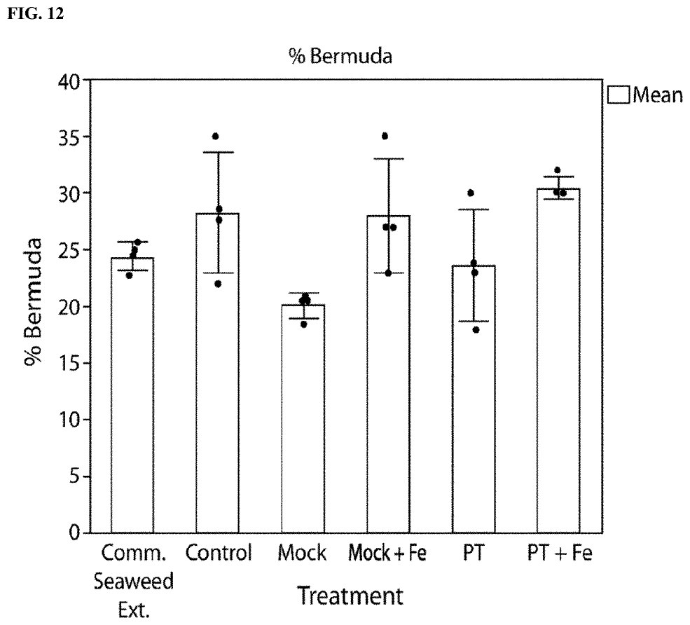

Normalized Difference Vegetation Index (NDVI) measurements were taken to quantify the green density of an area of turf. Results are shown in FIG. 10-11. The percentage of Bermuda grass in treated plots was analyzed using Image-J. The results are shown in FIG. 12.

### Example 12

Experiments were conducted to determine the effects of a microalgae based composition on the growth and quality of fairway turf at a golf course located in Hockley, Tex. The treatments included an untreated control; a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. The treatments were applied in addition to standard practice for fertilization, pest control, insect control, etc., at rates of 1.8, 3.7, and 7.5 Liters/acre in six applications (i.e., approximately every three weeks). Application was via broadcast sprayer or irrigation at trial initiation and by broadcast sprayer thereafter. In the fairway, 50 square foot areas of Bermuda grass (Tifton Variety) were sectioned in a grid for the application of the treatments. Four replicates were conducted for each treatment.

Normalized Difference Vegetation Index (NDVI) measurements were taken to quantify the green density of an area of turf monthly. Quality, density, and color National Turfgrass Evaluation Program (NTEP) rating were taken monthly.

### Example 13

Experiments were conducted to determine the effect of a microalgae based composition on the growth and quality of turf at a research farm located in Fresno, Calif. The treatments include an untreated control; a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. The treatments were applied in addition to standard practice for fertilization, pest control, insect control, etc., at rates of 1.8, 3.7, and 7.5 Liters/acre in six applications (i.e., approximately every three weeks). Application was via broadcast sprayer or irrigation at trial initiation and by broadcast sprayer thereafter. In the fairway, 50 square foot areas of a mix of fescue and Bermuda grass were sectioned in a grid for the application of the treatments. Four replicates were conducted for each treatment.

Normalized Difference Vegetation Index (NDVI) measurements were taken to quantify the green density of an area of turf monthly. Quality, density, and color National Turfgrass Evaluation Program (NTEP) rating were taken monthly.

### Example 14

Experiments were conducted to determine the effect of a microalgae based composition on the growth and yield of bell peppers in a field located in Camarillo, Calif. The treatments tested comprised an untreated control, the Chlorella based commercial product PhycoTerra™ (Heliae Development, LLC, Gilbert, Ariz. USA); a composition with 10% solids by weight of intact whole pasteurized mixotrophic Chlorella, potassium sorbate, and citric acid; a composition with 10% solids by weight of intact whole pasteurized mixotrophic Chlorella, citric acid, potassium hydroxide, potassium sorbate, 0.2% zinc, 0.5% manganese, 0.5% iron, 0.5% calcium, and 0.5% manganese; and a composition with 10% solids by weight of intact whole pasteurized mixotrophic Chlorella, citric acid, potassium hydroxide, potassium sorbate, 0.2% zinc, 0.5% manganese, 0.5% iron, 1% calcium, and 1% manganese. The treatments were applied in addition to standard practice for fertilization, pest control, insect control, etc., at rates of 1.8, 3.7, and 7.5 Liters/acre every at the time of transplanting to the field and then every 3 weeks afterwards until harvest. Four replicates were conducted for each treatment. The treatments were applied to the soil via drip irrigation

Plant vigor, chlorophyll content, total fruit yield, total plant fresh weight, total marketable yield, % utilization (equal to the ratio of marketable yield to total yield), ratio of red to green peppers, disease incidence and % of peppers with rot were measured.

### Example 15

Experiments were conducted to determine the effect of a microalgae based composition on the growth and quality of turf at a research farm located in New Mexico. The treatments included an untreated control, a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. The treatments were applied in addition to standard practice for urea fertilization, pest control, insect control, etc., at rates of 3.7, and 7.5 Liters/acre at the time of planting and every 4 weeks thereafter.

The treatments were tested within a linear gradient irrigation system (LGIS) where irrigation were applied twice weekly to replace 100% ET at 5 ft from LGIS. If evaporative demand was excessive, a third irrigation event occurred during the week. This provides a gradient of irrigation from 0 to 125% of ET0. Estimated ET loss from the previous week were determined based on a weather station located 100 ft from the experimental area. The irrigation loss from the previous week were replaced the subsequent week, until the end of the trial. Irrigation collection cups (rain gauges) will be placed on 4-5 rows, running against the gradient, with cups placed on 1 foot centers. These collections allowed for back calculation of applied irrigation along the LGIS. Plots were 3 ft wide by 20 feet long. The external 6″ edges of each plot area were used for observation or collection. Plots were maintained as Princess-77 bermudagrass fairways and mowed three times a week during the growing season. Standard fertilizer (urea) application were 0.8 lb N/1000 ft² (roughly 1.6 lb fertilizer/1000 ft²), applied once a month via broadcast. Applications of treatments were made every 4 weeks with a CO₂ backpack sprayer with tapwater as a carrier. Same amount of carrier water were sprayed onto each control plot at the same time as treatment applications. Applications were made at 80 gallons/acre spray volume. Four replicates were conducted for each treatment.

Normalized Difference Vegetation Index (NDVI) measurements were taken to quantify the green density of an area of turf monthly. Qualitative measurements of turf quality, turf texture, and plant health (i.e., disease resistance), as well as total dry weight per plot were also taken.

### Example 16

Experiments were conducted to determine the effect of a microalgae based composition on the growth and quality of putting green and fairway turf at a research golf course located in Ft. Lauderdale, Fla. The treatments included an untreated control; a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. Half of the treatments were applied in addition to standard practice for urea fertilization, pest control, insect control, etc., and half in addition to 50% of standard practice for urea fertilization, pest control, insect control, etc., at rates of 1.8, 3.7, and 7.5 Liters/acre in applications very 4 weeks for fairways and every 2 weeks for putting greens. Application were via broadcast sprayer or irrigation at trial initiation and by broadcast sprayer thereafter at a rate of 40-80 gallons/acre. On the putting green, 50 square foot areas of Bermuda grass were sectioned in a grid for the application of the treatments. In the fairway, 50 square foot areas of Bermuda grass were sectioned in a grid for the application of the treatments. Four replicates were conducted for each treatment.

Normalized Difference Vegetation Index (NDVI) measurements were taken to quantify the green density of an area of turf monthly. Quality, density, texture, and color National Turfgrass Evaluation Program (NTEP) rating were taken monthly. Shoot dry weight, root dry weight, and qualitative plant health (i.e., disease resistance) measurements were also taken.

### Example 17

Experiments were conducted to determine the effect of a microalgae based composition on the growth and quality of turf at a research farm located in Texas. The treatments included an untreated control; a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. The treatments were applied in addition to standard practice for fertilization, pest control, insect control, etc., at rates of 1.8, 3.7, and 7.5 Liters/acre at the time of planting, and every 4 weeks for the fairways and every 2 weeks for the putting greens. Application were via broadcast sprayer or irrigation at trial initiation and by broadcast sprayer thereafter at a rate of 40-80 gallons/acre. On the putting green, 50 square foot areas of Bermuda grass can be sectioned in a grid for the application of the treatments. In the fairway, 50 square foot areas of Bermuda grass were sectioned in a grid for the application of the treatments. Four replicates were conducted for each treatment.

Normalized Difference Vegetation Index (NDVI) measurements were taken to quantify the green density of an area of turf monthly. Qualitative measurements of turf quality, turf texture, and plant health (i.e., disease resistance), shoot dry weight and root dry weight measurements were also taken.

### Example 18

Experiments were conducted to determine the effect of a microalgae based composition on the growth and quality of turf at a research farm located in Reading, Pa. The treatments included an untreated control; a first treatment comprising 10% (wt) whole pasteurized Chlorella cells, 3% (wt) iron, 1.5% (wt) magnesium, 0.3% (wt) potassium sorbate, citric acid, and potassium hydroxide; and a second treatment comprising 10% (wt) whole pasteurized Chlorella cells, 3% (wt) iron, 0.3% (wt) potassium sorbate, citric acid, and potassium hydroxide. The Chlorella was grown mixotrophically in non-axenic conditions utilizing a supply of acetic acid as the organic carbon feedstock. The treatments were applied in addition to standard practice for fertilization, pest control, insect control, etc., at rates of 1.8, 3.7, and 7.5 Liters/acre at the time of planting and once per month. Application were via broadcast sprayer or irrigation at trial initiation and by broadcast sprayer. In the fairway, 25 square foot areas of creeping bentgrass were sectioned in a grid for the application of the treatments. Four replicates were conducted for each treatment.

Normalized Difference Vegetation Index (NDVI) measurements were taken to quantify the green density of an area of turf monthly. Qualitative measurements of turf quality, turf texture, and plant health (i.e., disease resistance), shoot density (dry weight) measurements were also taken.

### Example 19

Experiments were conducted to determine the effect of a microalgae based composition on the growth and yield of corn in a field located in Gila Bend, Ariz. The treatments tested included two untreated control; a formulation comprising (by wt.) 5% Chlorella, 3% Iron, 2% Manganese, and 2% Zinc (the “5% Formulation”); and a formulation comprising (by wt.) 10% Chlorella, 3% Iron, 2% Manganese, and 2% Zinc (the “10% Formulation). The Chlorella was culturing mixotrophically in non-axenic conditions and pasteurized. The treatments were applied in addition to standard practice for fertilization, pest control, insect control, etc., at rate of 2 quarts/acre at planting. The field consisted of a seeding rate of 38,000 of a Mycogen Variety, 40 inch row spacing, and regular watering.

Germination was observed to have been initiated by day 5 for the 5% Formulation treatment, which also showed more emerged radicals than the first control. On day 9 the stand count for the 5% Formulation treatment was about 86%, which was greater than the 78% observed with the first control. The root hairs and radical root strength were also more prominent for the 5% Formulation treatment on day 9 than for the first control.

On day 33, the 5% Formulation treatment showed a 1.5% increase in emergence over the first control, which equates to 550 additional plants per acre and 0.5 tons of silage per acre. On day 32, the 10% Formulation Treatment showed a 4.5% increase in emergence over the second control, which equates to 1,500 additional plants per acre and 1.5 tons of silage per acre.

On day 116, the 5% Formulation treatment produced a yield of 23.01 tons upon harvest and the first control product a yield of 27.34 tons. On day 115, the 10% Formulation treatment produced a yield of 31.06 tons upon harvest and the second control produced a yield of 26.99 tons, an increase of 15% over the control.

### Example 20

The mixotrophic Chlorella resulting from the culturing stage consists of whole cells with the proximate analysis shown in Table 14, fatty acid profile shown in Table 15, and the phytohormones profile shown in Table 16. The nutrient profile (i.e. proximate analysis) of the mixotrophic Chlorella cells before and after pasteurization, as wells a during subsequent storage, was found to have little variance.

TABLE 14

| | Range |
|---|---|
| Moisture & Volatiles | 1-2% |
| Ash Content | 3-4.5% |
| Carbohydrates | 30-36% |
| (calculated) | |
| % Protein (Leco) | 15-45% |
| % Lipids (AOAC) | 5-20% |

TABLE 15

| Analyte | Range (%) |
|---|---|
| C16 Palmitic Acid | 0.1-4 |
| C18:1n9c Oleic acid (Omega-9) | 0.1-2 |
| C18:2n6c Linoleic acid (Omega-6) | 0.1-5 |
| C18:3n3 Alpha-Linoleic acid (Omega-3) | 0.1-2 |
| Other | 0.1-4 |
| Total | 0.5-17 |

TABLE 16

| | Range |
|---|---|
| Metabolite | (ng/g DW) |
| cis-Abscisic acid | 0.1-13 |
| Abscisic acid glucose | 0.1-5 |
| ester | |
| Phaseic acid | 0.1-9 |
| Neo-Phaseic acid | 0.1-5 |
| trans-Abscisic acid | 0.1-8 |
| (trans) Zeatin | 0.1-5 |
| (cis) Zeatin | 0.1-16 |
| (trans) Zeatin | 4-20 |
| riboside | |
| (cis) Zeatin riboside | 30-250 |
| Dihydrozeatin | 0.1-2 |
| riboside | |
| Isopentenyladenine | 0.1-8 |
| Isopentenyladenosine | 1-15 |
| Indole-3-acetic acid | 400-815 |
| N-(Indole-3-yl- | 0.1-5 |
| acetyl)-alanine | |
| gibberellin 3 | 0.1-5 |
| gibberellin 34 | 0.1-5 |
| gibberellin 44 | 0.1-5 |

### Example 21

Samples of mixotrophically cultured Chlorella whole cells were analyzed for content. The results of the sample analysis and extrapolated ranges based on standard deviations are shown in Table 17, with NA indicating levels that were too low for detection. The results of the protein analysis are presented on a dry weight basis, while the remaining results are presented on a wet basis.

TABLE 17

| | Sample No. | | | | |
|---|---|---|---|---|---|
| | 1 | 2 | 3 | 4 | Range |
| % Protein (Leco) | 34.89 | 35.04 | 29.4 | 24.5 | 15-45 |
| % Lipids (AOAC) | 14.6 | 15.3 | 10.75 | 12.9 | 5-20 |
| Phosphorus (ppm) | 2000 | 2300 | 2700 | 2800 | 1,600-3,200 |
| Potassium (ppm) | 6208 | 6651 | 7088 | 8008 | 5,400-9,000 |
| Calcium (ppm) | 2100 | 2000 | 1500 | 1200 | 750-2,600 |
| Iron (ppm) | 130 | 160 | 140 | 110 | 80-200 |
| Magnesium (ppm) | 1500 | 1500 | 1200 | 970 | 700-1,800 |
| Manganese (ppm) | 31 | 32 | 25 | 21 | 10-40 |
| Zinc (ppm) | <25 | 29 | <25 | <25 | 0.1-40 |
| Arsenic (ppm) | <2.5 | <2.5 | <2.5 | <2.5 | 0.1-2.5 |
| Cadmium (ppm) | <0.5 | 1.8 | <0.5 | <0.5 | 0.1-2.0 |
| Cobalt (ppm) | 2.2 | 1.6 | 1.4 | 1.3 | 0.1-5.0 |
| Chromium (ppm) | NA | <1.0 | <1.0 | <1.0 | 0.1-1.0 |
| Copper (ppm) | NA | 180 | 18 | 14 | 1-300 |
| Mercury (ppm) | NA | <2.0 | <2.0 | <2.0 | 0.1-2.0 |
| Molybdenum (ppm) | NA | <2.5 | <2.5 | <2.5 | 0.1-2.5 |
| Sodium (ppm) | 2500 | 5400 | 3300 | 2400 | 1,000-6,800 |
| Nickel (ppm) | NA | <2.5 | <2.5 | <2.5 | 0.1-2.5 |
| Lead (ppm) | <5.0 | <5.0 | <5.0 | <5.0 | 0.1-5.0 |
| Selenium (ppm) | NA | <5.0 | <5.0 | <5.0 | 0.1-5.0 |

### Example 22

Samples of mixotrophically cultured Chlorella whole cells were analyzed for amino acid content. The results of the sample analysis and extrapolated ranges are shown in Table 18.

TABLE 18

| Analyte | % in Biomass | Range (%) |
|---|---|---|
| Aspartic Acid | 3.88 | 2.0-5.0 |
| Threonine | 1.59 | 0.1-3.0 |
| Serine | 2.3 | 0.1-4.0 |
| Glutamic Acid | 6.01 | 4.0-8.0 |
| Proline | 2.73 | 0.1-5.0 |
| Glycine | 2.45 | 0.1-4.0 |
| Alanine | 3.34 | 1.0-5.0 |
| Cysteine | 0.56 | 0.1-2.0 |
| Valine | 1.99 | 0.1-4.0 |
| Methionine | 0.85 | 0.1-2.0 |
| Isoleucine | 1.39 | 0.1-3.0 |
| Leucine | 3.13 | 1.0-5.0 |
| Tyrosine | 1.50 | 0.1-3.0 |
| Phenylalanine | 1.77 | 0.1-4.0 |
| Lysine | 1.87 | 0.1-3.0 |
| Histidine | 0.96 | 0.1-2.0 |
| Arginine | 4.42 | 2.0-6.0 |
| Tryptophan | 0.95 | 0.1-2.0 |
| Total | 41.69 | 11.3-70 |

### Example 23

Samples of mixotrophically cultured Chlorella whole cells were analyzed for carbohydrate content. The results of the sample analysis and extrapolated ranges are shown in Tables 19-20.

TABLE 19

| | % in | % in | Range (% in |
|---|---|---|---|
| Analyte | Carbohydrates | Biomass | biomass) |
| Polysaccharide | 81.61 | 32.6 | 20-40 |
| Raffinose | 1.47 | 0.6 | 0.1-2.0 |
| Cellobiose | 1.89 | 0.8 | 0.1-2.0 |
| Maltose | 5.18 | 2.1 | 0.1-4.0 |
| Glucose | 5 | 2 | 0.1-4.0 |
| Xylose | 0.7 | 0.3 | 0.1-1.0 |
| Galactose | 1.21 | 0.5 | 0.1-1.0 |
| Mannose | 0.86 | 0.3 | 0.1-1.0 |
| Fructose | 0.41 | 0.2 | 0.1-1.0 |
| Glucuronic acid | 1.67 | 0.7 | 0.1-2.0 |
| Total | 100 | 40.1 | 20.9-58.0 |

TABLE 20

| | % in | % in | Range (% in |
|---|---|---|---|
| Analyte | Carbohydrates | Biomass | Biomass) |
| Glucose | 54.5 | 21.8 | 10-30 |
| Xylose | 4.5 | 1.8 | 0.1-4 |
| Galactose | 16.5 | 6.6 | 4.0-8.0 |
| Arabinose | 5.2 | 2.1 | 0.1-4.0 |
| Mannose | 5.6 | 2.2 | 0.1-4.0 |
| Fructose | 2.7 | 1.1 | 0.1-2.0 |
| Glucuronic acid | 10 | 4 | 2.0-6.0 |
| Total | 99 | 39.6 | 16.4-58.0 |

### Example 24

An experiment was performed to determine the effects of a composition comprising Chlorella with additional nutrients on Anaheim Pepper and Petunia plants. The experiment tested several formulations as shown in Table 21, as compared to a negative control composition with N:P:K values of 12:4:8 and a positive control with N:P:K values of 20:20:20. The formulations in Table 21 will also include EDTA and citric acid as chelating agents.

TABLE 21

| | | % Active | | | | | |
|---|---|---|---|---|---|---|---|
| | Chlorella | | Phosphorus | Potassium | | | |
| Formulation | (g/L) | Nitrogen | (P₂O₅) | (K₂O) | Iron | Zinc | Manganese |
| 1-10(312) | 10 | 3 | 1 | 2 | 0.25 | 0.0125 | 0.0125 |
| 2-00(312) | 100 | 3 | 1 | 2 | 0.25 | 0.0125 | 0.0125 |
| 3-10(1248) | 10 | 12 | 4 | 8 | 1 | 0.05 | 0.05 |
| 4-20(1248) | 20 | 12 | 4 | 8 | 1 | 0.05 | 0.05 |
| 5-50(1248) | 50 | 12 | 4 | 8 | 1 | 0.05 | 0.05 |
| 6-100(1248) | 100 | 12 | 4 | 8 | 1 | 0.05 | 0.05 |

The six formulations and two control treatments were applied at application rates of 500, 1,000, and 2,000 mL per 1,000 square feet. In a first application protocol the treatments were first applied after the two leaf stage and then subsequently every 14 days until completion. In a second application protocol the treatments were first applied after the two leaf stage and then subsequently every 21 days until completion. In a third application protocol the treatments were first applied after the two leaf stage and then subsequently every 28 days until completion. The plants were grown in a greenhouse and receive a normal watering regiment.

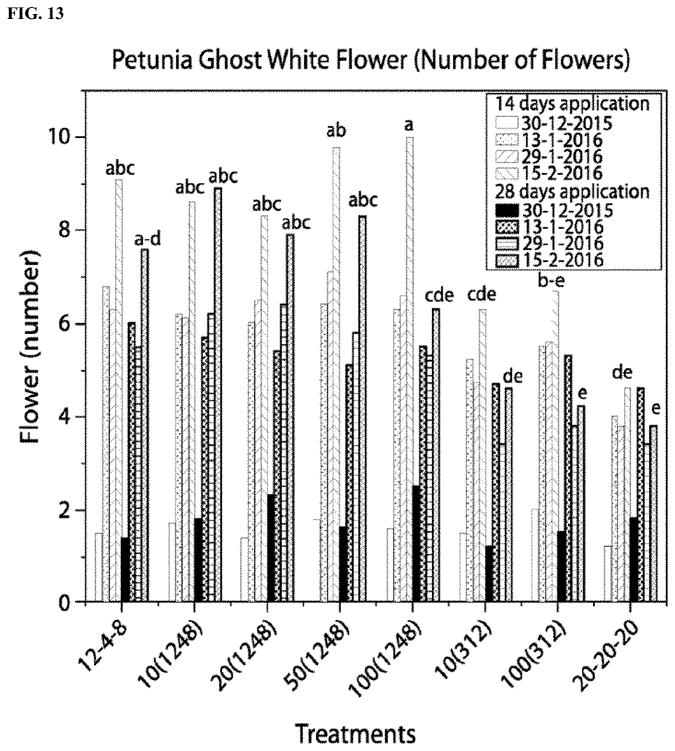

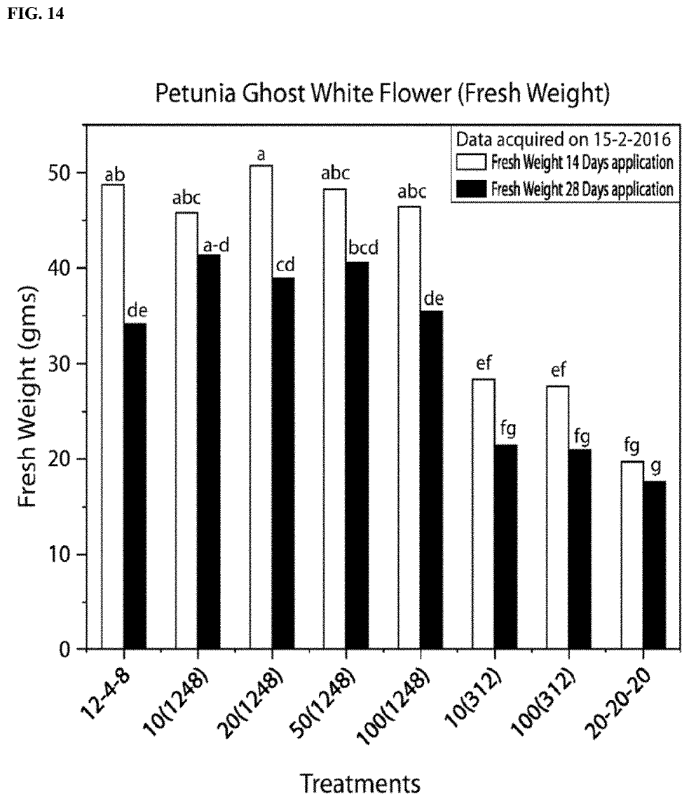

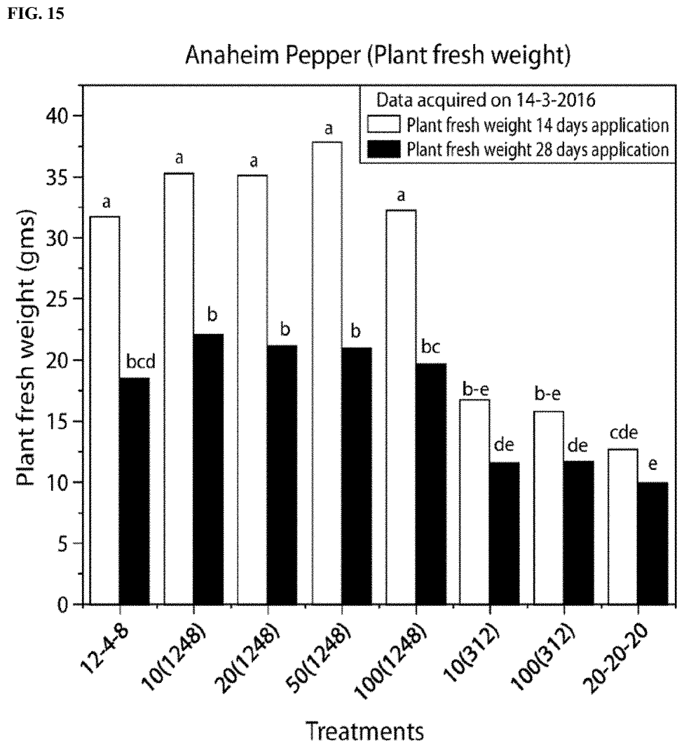

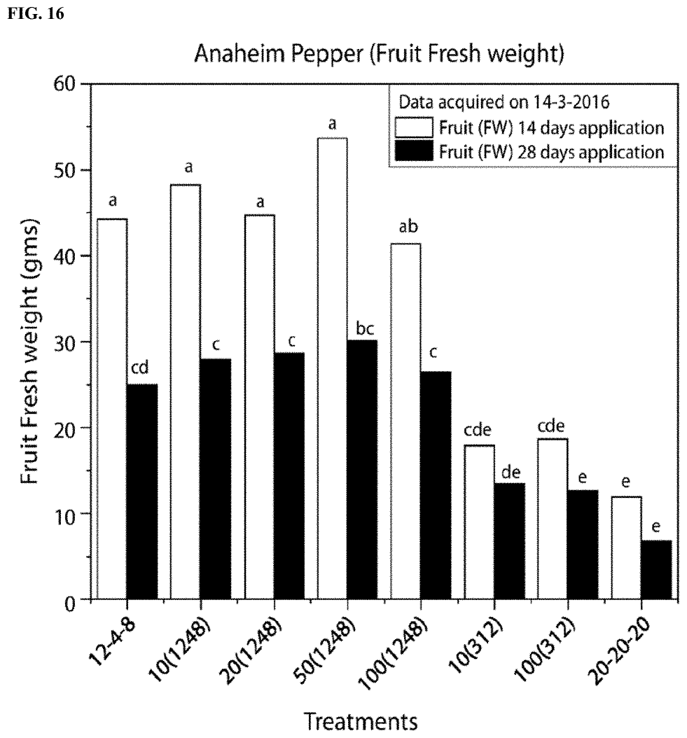

Measurements of the plants were taken to determine the effects of the treatments. For the Anaheim Peppers, the measurements included: yield (i.e., the number and weight of peppers at a defined time of harvest), plant height at monthly intervals, the time to flower, and the above ground biomass wet weight at the time of harvesting the peppers. For the Petunias, the measurements included: yield (i.e., the number of flowers per plant counted at a defined time, plant health (i.e., the observation of any yellowing or phytotoxic effects), length of the longest shoots, number of shoots, time to flower, and above ground biomass wet weight after final flower count. Results are shown in FIG. 13-16.

### Example 25

Experiments can be conducted to determine the effects of a composition comprising Chlorella on Anaheim Pepper and Petunia plant. The experiments can follow the same protocol as in Example 5, except for the application protocol.

In a first application protocol the treatments can be first applied after the six leaf stage and then subsequently every 14 days until completion. In a second application protocol the treatments can be first applied after the six leaf stage and then subsequently every 21 days until completion. In a third application protocol the treatments can be first applied after the six leaf stage and then subsequently every 28 days until completion. The plants can be grown in a greenhouse and receive a normal watering regiment.

### Example 26

Azospirillum brasilense are free-living nitrogen fixing bacteria that produce several phytohormones including auxins, cytokinins, and gibberellins. Bradyrhizobium japonicum have relatively large genomes encoding genes that allow them to synthesize various phytohormones including cytokinin. Actual production of phytohormones varies according to the environment in which the bacteria are living (e.g., in soil or inside a plant).

Field trials were conducted in clay soil with soybeans. All soybean seeds were coated with Azospirillum brasilense at 0.13 pt/acre and Bradyrhizobium japonicum at a rate of 0.25 pt/acre. PHYCOTERRA® (pasteurized Chlorella) was applied at planting at various rates (see Table 22). Plants receiving the combination of PHYCOTERRA® (pasteurized Chlorella) with both types of bacteria were compared to those receiving only the two types of bacteria (“Untreated Control” or “Grower Standard”).

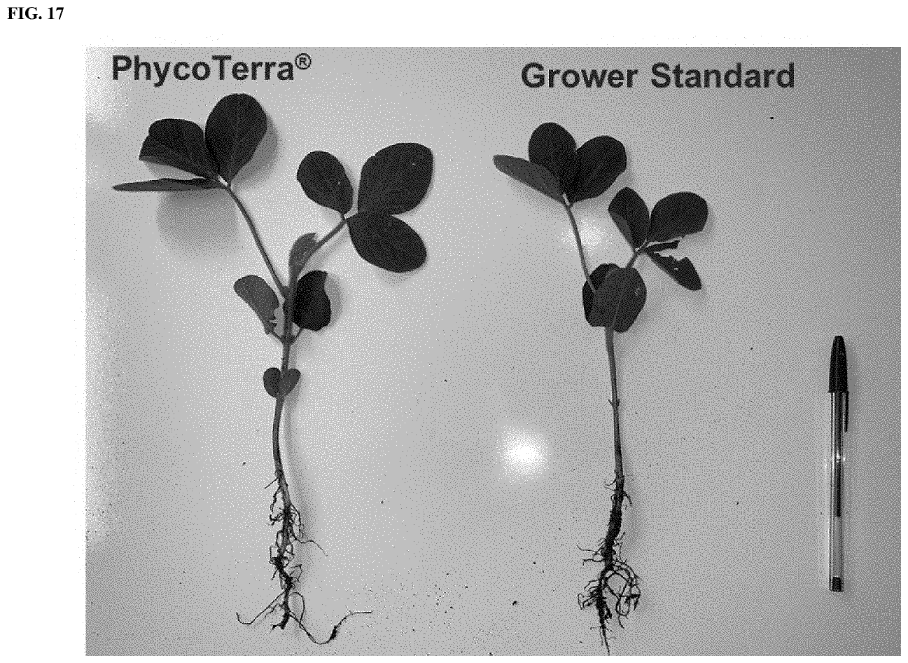

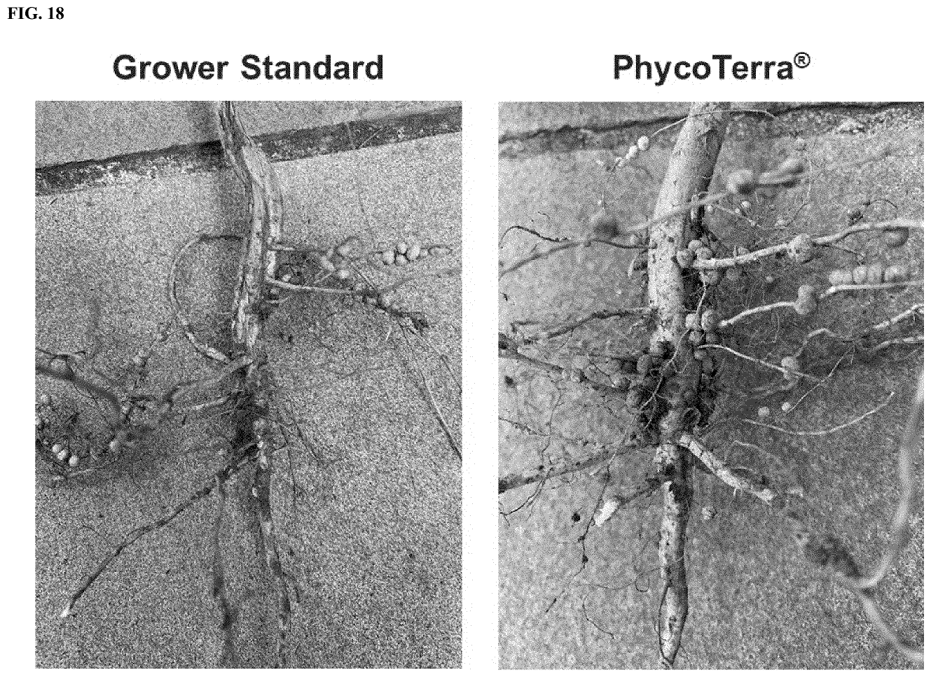

Soybean plants receiving the combination treatment showed increased growth (see FIG. 17) and enhanced root nodulation (see FIG. 18) compared to the Grower Standard. The increase in average nodules per plant with the combination treatment was between 4% and 6% greater than that of the Grower Standard. In addition, the combination treatment produced an increase in average yield of between 5% and 11% over that observed with the Grower Standard (see Table 22).

TABLE 22
Average soybean root nodules/plant and yields.

| | Appli- | Root | | Yield | |
|---|---|---|---|---|---|
| | cation | Nodules/ | % | (bu/ | % |
| Algal Composition(s) | Rate(s) | Plant | Change | acre) | Change |
| Untreated Control | — | 19.02 | — | 63.62 | — |
| (“Grower Standard”) | | | | | |
| PHYCOTERRA ® | 0.5 qt/acre | 20.22 | +6% | 67.05 | +5% |
| PHYCOTERRA ® | 1 qt/acre | 20.08 | +6% | 70.41 | +11% |
| PHYCOTERRA ® | 2 qt/acre | 19.72 | +4% | 68.68 | +8% |

### Example 27

Greenhouse experiments were conducted with alfalfa plants exposed to Sinorhizobium meliloti alone (“Untreated”) or Sinorhizobium meliloti combined with PHYCOTERRA® ORGANIC (pasteurized Chlorella) applied at concentrations of 0.5%, 1%, 2.5%, 5%, or 10%. Plants received fertilizer with 0 ppm nitrogen to force nodulation. The plants were harvested 55 days after treatment with PHYCOTERRA® ORGANIC (pasteurized Chlorella), and the average nodulation rates were determined.

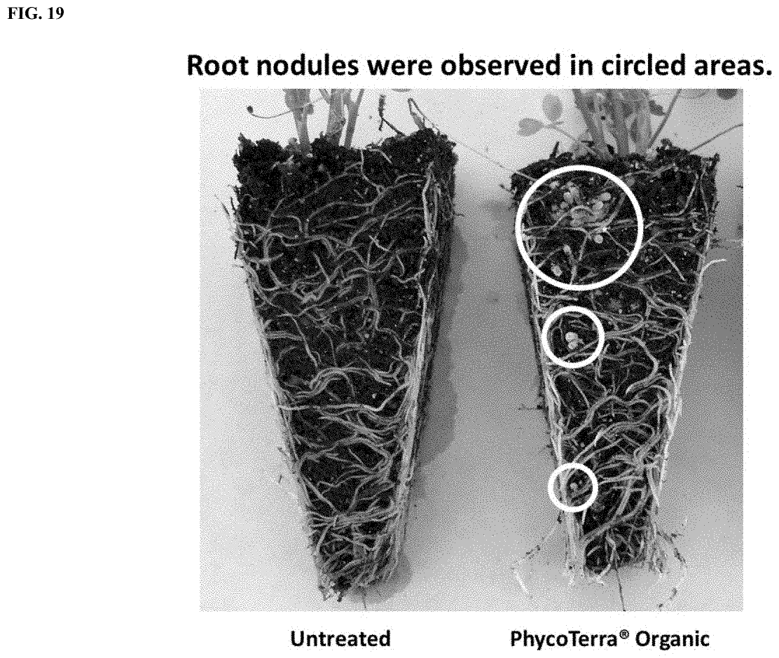

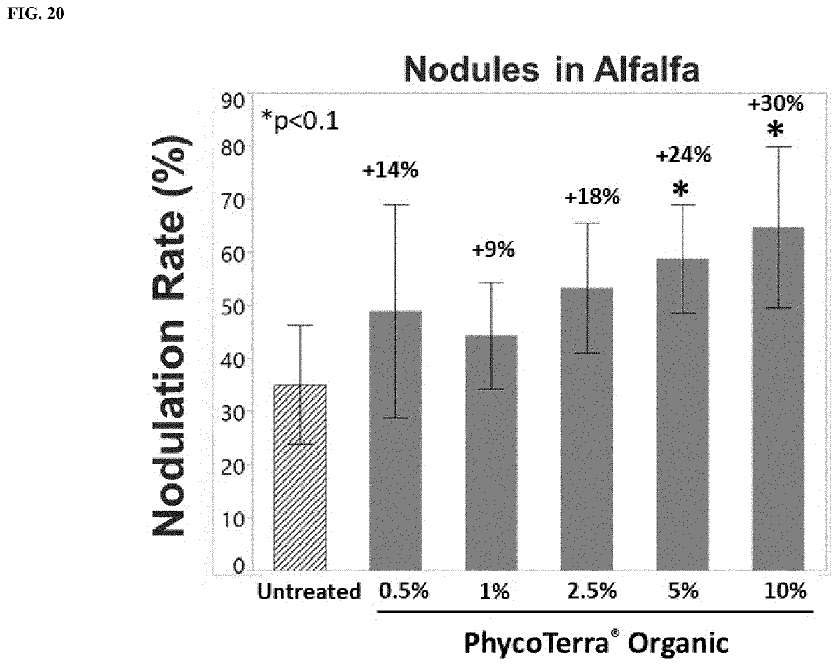

Application of PHYCOTERRA® ORGANIC (pasteurized Chlorella) significantly enhanced root nodulation in the alfalfa plants (see FIG. 19). Quantification of the nodulation rates demonstrated increases at every application rate of PHYCOTERRA® ORGANIC (pasteurized Chlorella) with the greatest increases in nodulation rate observed with concentrations of 5% and 10% (see FIG. 20).

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

We claim:

1. A method of increasing root nodule formation in a plant, the method comprising administering to a plant, seedling, or seed a composition comprising 0.001-30% by volume of microalgae cells in combination with free living nitrogen fixing bacteria, cytokinin producing bacteria, or a combination of both.

2. The method of claim 1, wherein the microalgae cells are Chlorella cells.

3. The method of claim 2, wherein the Chlorella cells are whole cells, lysed cells, dried cells, or cells that have been subjected to an extraction process.

4. The method of claim 2, wherein the Chlorella cells are pasteurized.

5. The method of claim 1, wherein the cytokinin producing bacteria comprise Methylotrophs, Methylobacterium sp., Xanthobacter sp., Paracoccus sp., Rhizobium sp., Sinorhizobium sp., or Methyloversatilis.

6. The method of claim 5, wherein the cytokinin producing bacteria comprise Rhizobium sp.

7. The method of claim 5, wherein the cytokinin producing bacteria comprise Sinorhizobium sp.

8. The method of claim 1, wherein the plant belongs to the Fabaceae family and is selected from the group consisting of soybeans, beans, green beans, peas, chickpeas, alfalfa, peanuts, sweet peas, carob, and liquorice.

9. The method of claim 8, wherein the plant is soybeans.

10. The method of claim 1, wherein the administrating is selected from: treating a seed with the composition prior to planting; administering the composition to a solid growth medium prior to or after the planting of a seed, seedling, or plant; and administering the composition to the foliage of a seedling or plant.

11. The method of claim 10, wherein the solid growth medium comprises at least one from the group consisting of: soil, potting mix, compost, or inert hydroponic material.

12. A method of increasing root nodule formation in a plant, the method comprising administering to a plant, seedling, or seed a composition comprising 0.001-30% by volume of Chlorella cells in combination with cytokinin producing bacteria selected from the group consisting of Methylotrophs, Methylobacterium sp., Xanthobacter sp., Paracoccus sp., Rhizobium sp., Sinorhizobium sp., and Methyloversatilis.

13. The method of claim 12, wherein the Chlorella cells are whole cells, lysed cells, dried cells, or cells that have been subjected to an extraction process.

14. The method of claim 12, wherein the Chlorella cells are pasteurized.

15. The method of claim 12, wherein the composition further comprises bacteria that produce a siderophore or indole acetic acid (IAA).

16. The method of claim 12, wherein the plant belongs to the Fabaceae family and is selected from the group consisting of soybeans, beans, green beans, peas, chickpeas, alfalfa, peanuts, sweet peas, carob, and liquorice.

17. The method of claim 12, wherein the administrating is selected from: treating a seed with the composition prior to planting; administering the composition to a solid growth medium prior to or after the planting of a seed, seedling, or plant; and administering the composition to the foliage of a seedling or plant.

18. The method of claim 17, wherein the solid growth medium comprises at least one from the group consisting of: soil, potting mix, compost, or inert hydroponic material.

19. A method of increasing root nodule formation in a plant, the method comprising administering to a plant, seedling, or seed a composition comprising 0.001-30% by volume of Chlorella cells in combination with Sinorhizobium sp.

20. The method of claim 19, wherein the plant belongs to the Fabaceae family and is selected from the group consisting of soybeans, beans, green beans, peas, chickpeas, alfalfa, peanuts, sweet peas, carob, and liquorice.
